(19) United States
(12) Patent Application Publication
(10) Pub. No.: US 2002/0043651 A1
(43) Pub. Date: Apr. 18, 2002

(54) Fluorescent lifetime assays for non-invasive quantification of analytes such as glucose

(76) Inventors: Christopher B. Darrow, Pleasanton, CA (US); Joe H. Satcher JR., Patterson, CA (US); Stephen M. Lane, Oakland, CA (US); Jennifer Harder Gable, Livermore, CA (US)

Correspondence Address: GATES & COOPER LLP, Howard Hughes Center, 6701 Center Drive West, Suite 1050, Los Angeles, CA, 90045, US

(21) Appl. No.: 09/826,745

(22) Filed: Apr. 4, 2001

Related U.S. Application Data
(60) Provisional application No. 60/194,571, filed on Apr. 4, 2000.

(51) Int. Cl. G01N 31/00

(52) U.S. Cl. 252/408.1

(57) ABSTRACT

The invention disclosed herein provides fluorescence based methods for the determination of polyhydroxylated analyte concentrations as well as optical polyhydroxylate analyte sensors and sensor systems. In particular, the invention provides methods of quantifying the abundances or concentrations of polyhydroxylate analyte by measuring changes in the fluorescence lifetimes. The methods of the invention are based on the observation that fluorescent sensor molecules capable of binding a polyhydroxylated analyte such as glucose have distinct fluorescent lifetimes depending upon whether they are in a form that is either bound to analyte or a form that is not bound to the analyte. The distinct and measurable differences in the fluorescence lifetimes of the different fluorescent sensor species can be used to determine the relative abundance of the bound and unbound fluorescent sensor species, a parameter which can then be correlated to the concentration of the analyte.

This application is a non-provisional application claiming priority under Section 119(e) to United States provisional patent application, Ser. No. 60/194,571 filed on Apr. 4, 2000. The entire contents of this provisional patent application is incorporated herein by reference.

This application is related to the following co-pending and commonly assigned patent applications:

U.S. patent application Ser. No. 09/663,567 “GLUCOSE SENSING MOLECULES HAVING SELECTED FLUORESCENT PROPERTIES” by Joe H. Satcher, Jr., et al., filed Sep. 15, 2000 which is a non-provisional application claiming priority under Section 119(e) to provisional application No.60/154,103, filed Sep. 15, 1999; and

U.S. patent application Ser. No. 09/461,627 “DETECTION OF BIOLOGICAL MOLECULES USING BORONATE BASED CHEMICAL AMPLIFICATION AND OPTICAL SENSORS”, by William Van Antwerp et al., filed on Dec. 14, 1999, which is a Continuation of U.S. patent application Ser. No. 08/749,366, now U.S. Pat. No. 6,002,954, which claims the benefit of U.S. Provisional Patent Application Ser. No. 60/007,515, filed Nov. 22, 1995; and

U.S. patent application Ser. No. 09/078,392 “DETECTION OF BIOLOGICAL MOLECULES USING BORONATE BASED CHEMICAL AMPLIFICATION AND OPTICAL SENSORS”, by William Van Antwerp et al., filed on Nov. 21, 1999, which is a Continuation of U.S. patent application Ser. No. 08/752,945, now U.S. Pat. No. 6,002,954, which claims the benefit of U.S. Provisional Patent Application Ser. No. 60/007,515, filed Nov. 22, 1995, and is related to U.S. Ser. No. 08/721,262, filed Sep. 26, 1996, now U.S. Pat. No. 5,777,060, which is a Continuation-in-Part of U.S. Ser. No. 08/410,775, filed Mar. 27, 1995, now abandoned.

The complete disclosure of each of these related applications is incorporated herein by reference in their entirety.

The United States Government has rights in this invention pursuant to Contract No. W-7405-ENG-48 between the United States Department of Energy and the University of California for the operation of Lawrence Livermore National Laboratory.

### FIELD OF THE INVENTION

This invention relates to methods for quantifying the presence of analytes, particularly polyhydroxylated analytes such as glucose, based on the fluorescent lifetimes of fluorescent sensor molecules in the presence of analyte, as well fluorescent analyte sensors which utilize fluorescent lifetime data to determine analyte concentrations.

### BACKGROUND OF THE INVENTION

Diabetes is a chronic disease that affects 14 million people in the U.S. and more than 110 million people worldwide. This chronic disease is progressively debilitating, even when treated with conventional therapies, and frequently results in severe complications during the life of the diabetic individual. As a result, diabetes costs the U.S. healthcare system about $100 billion annually.

Conventional therapies for the most severe form of diabetes, insulin-dependent diabetes mellitus (IDDM or Type I), requires self-determination of blood glucose levels and self-injections of insulin. In practice, near normal blood glucose levels are impossible to maintain with these conventional therapies with blood glucose levels in the diabetic patient are on average 50-100% higher than normal. As a consequence, the typical diabetic patient is at high risk for long-term microvascular complications, such as stroke, kidney failure and blindness, as well as other serious health conditions.

Related to the long term health risks associated with diabetes, the NIDDK (National Institute of Diabetes and Digestion and Kidney Diseases) has released the results of a large clinical trial called the Diabetes Control and Complications Trial (DCCT). The DCCT showed conclusively that improved blood glucose control greatly reduces the risks of the long term complications of diabetes.

An essential tool for the controlling blood glucose level in the diabetic patient would be a glucose monitor that can accurately and continuously determine the levels of glucose in a minimally invasive fashion. Such a tool would be of great benefit to the diabetic patient by permitting more frequent and convenient monitoring of glucose, thus allowing for better control over the long term, deleterious effects of abnormal glucose levels.

To date, numerous attempts have been made to devise a minimally invasive and continuous glucose monitor. Some of these glucose monitors are based on fluorescent systems which result in optical detection of the polyhydroxylate. However, these optical sensors utilize changes in fluorescent intensity in the presence of an analyte as a correlate to the abundance, or concentration, of the polyhydtoxylate analyte. As such, these systems generally cannot provide the level of precision to accurately determine the concentration of the polyhydtoxylate analyte, especially when these methods and systems are provided in-vivo. This imprecision is due, in part, to the presence of a variable and significant scattering component of spurious fluorescence signal inherent in intensity-based measurements of fluorescence.

Therefore, there is an need in the art for additional quantification methods and systems that are capable of yielding more accurate determinations of physiological analytes, such as glucose, particularly in-vivo. These more accurate quantification methods can be incorporated into an appropriate polyhydroxylate sensor and system to yield more reliable determinations of analytes such as glucose.

### SUMMARY OF THE DISCLOSURE

The invention disclosed herein provides fluorescence based methods for the determination of polyhydroxylated analyte concentrations as well as optical polyhydroxylate analyte sensors and sensor systems. In particular, the invention provides methods of quantifying the concentrations of polyhydroxylate analytes by measuring changes in the fluorescence lifetimes of fluorescent sensor molecules that are capable of binding these analytes. The methods of the invention are based on the observation that certain fluorescent sensor molecules capable of binding a polyhydroxylated analyte such as glucose have distinct fluorescent lifetimes depending upon whether the fluorescent sensor molecules are bound to analyte or not bound to analyte. Because fluorescent sensor molecules which are bound to an analyte have a fluorescence lifetime that is distinct from the fluorescence lifetime of fluorescent sensor molecules which are not bound to the analyte, optical analyte sensors and systems can be used to quantify a distinct and measurable difference in the fluorescence lifetimes of these different species. The distinct and measurable differences in the fluorescence lifetimes of the bound and unbound fluorescent sensor species can be used to determine the relative abundance of these fluorescent sensor species, a parameter which can then be correlated to the concentration of the analyte.

The methods, sensors and sensor systems of the invention comprise a number of embodiments. One typical embodiment of the invention consists of a method of using a population of fluorescent sensor molecules (FS) to measure the concentration of a polyhydroxylate analyte (A) in a solution, wherein the population of fluorescent sensor molecules are present in species that are not bound to the polyhydroxylate analyte (FS) and species that are bound to the polyhydtoxylate analyte (FSA). In this method, the concentration of a polyhydroxylate analyte is measured by determining the relative fluorescence contribution that the FS and the FSA species make to the total fluorescence of the solution, then using the relative fluorescence contribution values of FS and FSA so determined to calculate the relative abundances of FS and FSA in the solution; and then correlating the relative abundances of FS and FSA in the solution so calculated with the concentration of the polyhydroxylate analyte.

A related embodiment of the invention consists of a method of optically sensing the presence of a polyhydroxylate analyte in a sample by placing a fluorescent sensor molecule (FS) in contact with the sample, wherein the fluorescent sensor molecule reversibly binds to the polyhydroxylate analyte and has a first fluorescence lifetime corresponding to the fluorescent sensor molecule bound to the polyhydroxylate analyte (FSA) and a second fluorescence lifetime corresponding to the fluorescent sensor molecule not bound to the polyhydroxylate analyte, and wherein the fluorescence lifetimes of FSA and FS contribute relatively to a detectable fluorescence lifetime for the sample. This method consists of exposing a population of the fluorescent sensor molecules to the sample, exciting the fluorescent sensor molecules in the sample with radiation, detecting a resulting emission beam emanating from the fluorescent sensor molecules in the sample, wherein the emission beam varies with the concentration of the polyhydroxylate analyte and then correlating the resulting emission beam to the presence of the polyhydroxylate analyte in the sample, so that the concentration of the polyhydroxylate in the sample is determined. In such methods, the relative contribution of FS and FSA to the total fluorescence typically approximately equals unity. In one embodiment of this method, the fluorescent sensor molecule has more than one fluorescence lifetime in the absence of the polyhydroxylate analyte and at least one lifetime of the fluorescent sensor molecule corresponds to a population of fluorescent sensor molecules undergoing photo-induced electron transfer. A specific embodiment of this method consists of detecting the relative contribution of FS or FSA to the total fluorescence and then calculating the relative contribution to the total fluorescence of the species that is not directly detected. In preferred methods of the invention, the fluorescent lifetimes of the species are calculated using a method selected from the group consisting of time-resolved fluorometry and phase-modulation fluorometry.

In addition to the methods of determining the concentration of an analyte via fluorescent lifetime measurements, the invention disclosed herein provides fluorescent sensors and sensor systems. In highly preferred embodiments of the invention, the fluorescent sensor comprises an arylboronic compound of the formula:

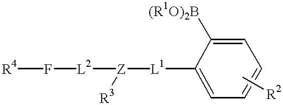

wherein:

F is a fluorophore with selected molecular properties;

R¹ is selected from the group consisting of hydrogen, lower aliphatic and aromatic functional groups;

R² and R⁴ are optional functional groups selected from the group consisting of hydrogen, lower aliphatic and aromatic functional groups and groups that form covalent bonds to a biocompatible matrix;

L¹ and L² are optional linking groups having from zero to four atoms selected from the group consisting of nitrogen, carbon, oxygen, sulfur and phosphorous;

Z is a heteroatom selected from the group consisting of nitrogen, phosphorous, sulfur, and oxygen;

R³ is an optional group selected from the group consisting of hydrogen, lower aliphatic and aromatic functional groups and groups that form covalent bonds to a biocompatible matrix; and

wherein F and Z are involved in a photo-induced electron transfer process that quenches the intrinsic fluorescence of F in the absence of the polyhydroxylate analyte. Typically, the arylboronic fluorescent sensor molecules comprise an amine moiety with a pKa of less than about 7.4 and preferably about 2.0 to about 7.0. In preferred embodiments of the invention, F is selected from the group consisting of courmanins, oxazines, xanthenes, cyanines, metal complexes and polyaromatic hydrocarbons. In highly preferred embodiments of the invention, the arylboronic fluorescent sensor molecule has an excitation wavelength of greater than about 400 nm, and preferably between about 400 nm to about 600 nm. In other preferred embodiments of the invention, the arylboronic fluorescent sensor molecules have an emission wavelength of greater than about 500 nm, preferably between about 500 nm to about 800 nm.

Other features and advantages of the invention will become apparent from the following detailed description, taken in conjunction with the accompanying drawings which illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 shows a schematic illustration of the overall design of the prototypical fluorescent molecules of the invention; in the figure three moieties are illustrated which possess three functionalities, namely a fluorophore (1), a switch (2) and a receptor (3).

FIG. 2 shows a schematic illustration of a fiber optic embodiment of the polyhydroxylate analyte sensors of the invention.

FIG. 3 shows a schematic illustration of an implanted embodiment of the polyhydroxylate analyte sensors of the invention.

FIGS. 4A-4C provide three examples of implantable sensor systems for immobilization of fluorescent sensor molecules of the invention.

FIG. 5 show a graph of the transmission of light through the skin at the web of the hand at a thickness of 2.5 mm.

FIG. 6 depicts examples of fluorescent sensor molecules of the invention comprising a transition metal-ligand fluorophores.

FIG. 7 depicts examples of fluorescent sensor molecules of the invention comprising an oxazine fluorophores.

FIG. 8 depicts examples of fluorescent sensor molecules of the invention comprising anthracene and other aromatic fluorophores.

FIG. 9 shows two examples of fluorophores used to elucidate properties of the prototypical model system of the invention; FIG. 9A shows naphthalimide boronate (NIB) and FIG. 9B show 6-chloro-10methyl-5Hbenzo[a]phenoxazin-5-one (COB).

FIG. 10 illustrates the prototypical fluorescent sensor molecule of the invention with polyhydroxylate analyte bound or unbound to the receptor/recognition moiety; the figure further illustrates a preferred mechanism involved in the polyhydroxylate analyte sensing process, namely photo-induced electron transfer (PET).

FIG. 11 shows generalized schematic of the an embodiment of the optical polyhydroxylate analyte sensor system of the invention.

FIG. 12 illustrates a schematic of the fiber optic architecture of a group of embodiments of the polyhydroxylate sensor systems of the invention.

FIG. 13 illustrates a schematic of another group of embodiments of the implantable architecture of the polyhydroxylate sensor systems of the invention which uses a subcutaneous light source and detector.

FIG. 14 illustrates a schematic of still another group of embodiments of the implantable architecture of the polyhydroxylate sensor systems which uses a subcutaneous light source and detector to provide a complete subdermal sensing system.

FIG. 15 illustrates a schematic of another group of embodiments of the implantable architecture of the polyhydroxylate sensor systems of the invention which uses a subcutaneous light source and detector which is coupled to a medicament pump (e.g. an insulin pump) to provide a “closed loop” monitoring and supplementing system.

FIG. 16 depicts anthracene boronate, a prototypical fluorescent sensor molecule of the invention, bound to glucose through the boronic acid receptor/recognition moiety; the figure also illustrates the N->B dative bond that effectively eliminates quenching of the anthracene fluorophore by photo-induced electron transfer.

FIG. 17A depicts a Jablonski diagram illustrating the decay processes which take excited molecules back to the ground state; FIG. 17B depicts a modified Jablonski diagram illustrating the effects of the two major decay processes, i.e., decay back to the ground state through fluorescence (k) and decay back to the ground state via non-radiative decay processes.

FIG. 18 shows the phase-modulation results of five frequency scans taken on anthracene botonate (AB) in methanol and phosphate buffered saline (PBS) in a 1:1 ratio by volume.

FIG. 19 shows the fluorescence lifetime data for anthracene boronate (AB) in methanol/phosphate buffered saline (PBS) (1:1 by volume); as shown in the figure, the addition of glucose causes an increase in phase shift and a decrease in amplitude modulation for a given excitation frequency.

FIG. 20 shows the fluorescence lifetime measurements of 10⁻⁵ M anthracene boronate (AB) in 1:1:x aqueous, methanol:phosphate buffered saline:glucose solutions as a function of glucose concentrations.

FIG. 21 depict experimental results for anthracene botonate (AB); the graph shows the measured component fractions as a function of glucose concentrations (circles and squares) and the fit to the model (lines).

FIG. 22 depict experimental results for chlotooxizine botonate (COB); the graph shows the measured component fractions as a function of glucose concentration (circles and squares) and the fit to the model (lines).

FIGS. 23A and 23B depict experimental results for napthylimide botonate (NIB); the graphs show the measured component fractions as a function of various glucose concentrations (circles and squares) (23A: lower glucose concentrations; 23B: higher glucose concentrations) and the fit to the model (lines).

FIG. 24 depicts determinations of phase shift as a function of glucose concentration at 25 MHz excitation modulation frequency, shown from left to right, for AB, COB and NIB.

FIG. 25 depicts the phase lag for anthracene botonate (AB) showing the phase lag between the fluorescence and excitation as a function of glucose.

FIG. 26 shows a profile of the physiological glucose range and the phase difference expected at 17 MHz modulation frequency.

FIG. 27 shows the phase accuracy needed to obtain accurate glucose measurements within +/−5% accuracy.

FIG. 28 depicts a fluorometer used in elucidating the features and properties of the novel quantification methods, polyhydroxylate sensors and sensor systems of the invention.

FIG. 29 is a graphical representation of amplitude versus time showing that the fluorescence is phase shifted, (Φ, from the excitation light; theory predicts that both amplitude demodulation and phase shift can be correlated with the lifetime of a particular fluorophore.

FIG. 30 show the three fluorescence lifetimes values and error for anthracene boronate without linking trials.

FIG. 31 show the three fractional contributions and error for anthracene boronate without linking trials.

FIG. 32 shows a comparison of fractional contributions and errors for anthracene boronate determined with (dashed lines) and without (solid lines) linking trials.

FIG. 33 show a comparison of fluorescence lifetime values and errors for anthracene boronate determined with (dashed lines) and without (solid lines) linking trials.

FIG. 34 depicts phase-modulation data for anthracene boronate in methanol:phosphate buffered saline (PBS) (1:1 by volume).

FIGS. 35A-35D outline illustrative synthesis schemes that can be used in the generation of fluorescent compounds such as those shown in FIG. 8 following methods know in the art (see, e.g. Castle et al., Collect. Czech. Commun. Vol. 56, (1991), pp 2269-2277).

FIGS. 36A-36E depict the deviation of phase (circles) and modulation (triangles) for trials #1-#5, respectively, with fitting the data to a triple exponential decay.

FIG. 37A-37M show chi-squared plots for data taken for anthracene boronate; FIG. 37A shows the chi-squared plot for the first lifetime (τ₁), where the value of τ₁ ranges from 10.813 to 11.612 ns; FIG. 37B shows the chi-squared plot for the second lifetime (τ₂), where the value of τ₂ ranges from 2.876 to 3.673 ns; FIG. 37C shows the chi-squared plot for the third lifetime (τ₃), where the value of τ₃ ranges from 0.221 to 1.152 ns; FIG. 37D shows the chi-squared plot for the fractional contribution of the first lifetime (f₁) in trial #1, where the value of f₁ ranges from 0.518 to 0.585; FIG. 37E shows the chi-squared plot for the fractional contribution of the second lifetime (f₂) in trial #1, where the value of f₂ ranges from 0.386 to 0434; FIG. 37F shows the chi-squared plot for the fractional contribution of the first lifetime (f₁) in trial #2, where the value of f₁ ranges from 0.518 to 0.589; FIG. 37G shows the chi-squared plot for the fractional contribution of the second lifetime (f₂) in trial #2, where the value of f₂ ranges from 0.38 to 0431; FIG. 37H shows the chi-squared plot for the fractional contribution of the first lifetime (f₁) in trial #3, where the value of f₁ ranges from 0.514 to 0.584; FIG. 37I shows the chi-squared plot for the fractional contribution of the second lifetime (f₂) in trial #3, where the value of f₂ ranges from 0.380 to 0.440; FIG. 37J shows the chi-squared plot for the fractional contribution of the first lifetime (f₁) in trial #4, where the value of f₁ ranges from 0.509 to 0.586; FIG. 37K shows the chi-squared plot for the fractional contribution of the second lifetime (f₂) in trial #4, where the value of f₂ ranges from 0.380 to 0.441; FIG. 37L shows the chi-squared plot for the fractional contribution of the first lifetime (f₁) in trial #5, where the value of f₁ ranges from 0.522 to 0.590; FIG. 37M shows the chi-squared plot for the fractional contribution of the second lifetime (f₂) in trial #5, where the value of f₁ ranges from 0.364 to 0.423.

FIG. 38 depicts fluorescence lifetime measurements for anthracene boronate in methanol and pH buffer (1:1 by volume); as shown in the figure, the curves shift to the right with increasing pH, indicating that the average lifetime is decreasing.

FIG. 39 depicts fluorescence lifetimes as a function of pH in methanol and pH buffer (1:1 by volume).

FIG. 40 depicts pre-exponential factors for fluorescence lifetimes of anthracene boronate as a function of pH; the lifetimes values are τ₁=11.1 ns, τ₂=3.2 ns and τ₃=0.34 ns.

FIG. 41 shows the graphic analysis for the calculation of pKₐ for anthracene boronate from α₁ to α₂.

FIG. 42 shows the graphic analysis for the calculation of pK_{b} for anthracene boronate from α₂ to α₃.

FIG. 43 depicts the relative fluorescence intensity of anthracene boronate in phosphate buffered solutions (PBS) with 33, 50 and 67% methanol; for each methanol/buffer solution various glucose concentrations were added which produced an increase in the fractional intensity.

### DETAILED DESCRIPTION OF THE PREFERRED EMBODIMENTS

The invention disclosed herein provides fluorescence based methods for the determination of polyhydroxylate analyte concentrations as well as optical polyhydroxylate analyte sensors and sensor systems. In particular, the invention provides methods of quantifying the abundances or concentrations of polyhydroxylate analyte by measuring changes in the fluorescence lifetimes. These quantification methods are more accurate than traditional methods such as those that employ steady-state measurements of changes in fluorescence intensities.

The methods of the invention are based on the observation that certain fluorescent sensor molecules capable of binding a polyhydroxylated analyte such as glucose have distinct fluorescent lifetimes depending upon whether the fluorescent sensor molecules are bound to analyte or not bound to analyte. Because fluorescent sensor molecules which are bound to an analyte have a fluorescence lifetime that is distinct from the fluorescence lifetime of fluorescent sensor molecules which are not bound to the analyte, optical analyte sensors and systems can be used to quantify a distinct and measurable difference in the fluorescence lifetimes of these different species. The distinct and measurable differences in the fluorescence lifetimes of the different species can be used to determine the relative abundance of the bound and unbound species, a parameter which can then be correlated to the concentration of the analyte.

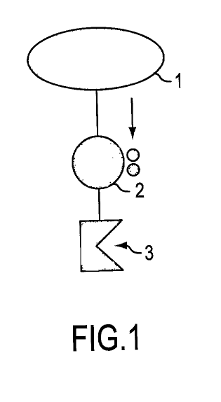

In preferred embodiments of the invention, the polyhydroxylate analyte is glucose and the fluorescent sensor molecule comprises a multifunctional arylboronic moiety that serves as both a glucose recognition/binding moiety and a fluorescent signal transducer that produces fluorescence emission signal upon glucose binding. The arylboronic moiety is capable of specifically, and reversibly, binding to glucose in fluids and the signal that is generated upon glucose binding is correlated to the abundance or concentration of this analyte. The molecular configuration of preferred fluorescent sensor molecules of the invention is shown in FIG. 1. The preferred fluorescent sensor molecules of the invention generally comprise three major functionalities: 1) a fluorophore (electron acceptor), 2) a switch (electron donor), and 3) a polyhydroxylate analyte receptor, or recognition moiety. Although the preferred embodiments of the fluorescent sensor molecule comprise three separable moieties that yield the three desired functionalities, alternative embodiments of the fluorescent sensor molecule may actually comprise less than three moieties to yield the desired functionalities.

While the arylboronic moiety is particularly suitable for glucose sensing in-vivo, as discussed below, the methods of the invention have applications in a variety of contexts. In all applications of the invention, the binding of the polyhydroxylate analyte to the arylboronic moiety serves to transduce the fluorescence of the fluorophore by controlling electron donation at the switch moiety. Methods based on the measurement of fluorescence lifetimes as well as sensor molecules and systems ate described in detail below.

I. Quantification of Polyhydroxylate Analytes Using Fluorescence Lifetimes

The invention provides methods of quantifying the presence of polyhydroxylate analytes, particularly glucose, by measuring the fluorescence lifetimes of a fluorescent sensor molecule that can exist in forms that are both unbound to the analyte and bound to the analyte. Using such lifetime-based quantification methods, polyhydtoxylate analyte sensor and sensor systems are provided. These quantification methods, sensors and sensor systems possess greater accuracy than methods, sensors and sensor systems traditionally used in the art such as those based on fluorescence intensity measurements.

i. Methods for Determining Fluorescence Lifetimes

The fluorescence lifetime of a fluorescent sensor molecule is typically the average time the molecule remains in the excited state prior to its return to the ground state. Lifetime data, as it is related to decay rates from the excited state to the ground state, can reveal a number of different types of information, for example, the frequency of collisional encounters with a quenching agent, the rate of energy transfer, and the rate of excited state reactions, such as photo-induced electron transfer. The precise nature of these fluorescence decays in a polyhydroxylate analyte sensor system can further reveal details about the interaction of the fluorescent sensor molecule with its environment. For example, multiple decay constants can be a result of the fluorescent sensor molecule being in several distinct environments, such as the molecule being bound of being free, and/or a result of excited state processes, such as photo-induced electron transfer.

Exemplary methods for the measurement of fluorescence lifetimes are the pulse method (also known as time-resolved fluorometry) and the harmonic or phase-modulation method. In the pulse method, the sample is excited with a brief pulse of light and the time-dependent decay of fluorescence intensity is measured. In the harmonic method, the sample is excited with sinusoidally modulated light. In this method, the phase shift and demodulation of the emission, relative to the incident light, is used to calculate the lifetimes. The methods of the invention can employ procedure known in the art for measuring the fluorescence lifetimes of the fluorescent sensor molecule in the presence and/or absence of a polyhydroxylate analyte to be quantified.

Exemplary fluorescent sensor analyte systems in the invention include any sensor system where the presence and absence of the polyhydroxylate analyte desired to be quantified can be detected and/or measured, and calculations of the relevant fluorescence lifetimes can be derived from the detection and/or measurement and correlated with the abundance, or concentration, of the polyhydroxylate analyte. In the invention, detecting and/or measuring the fluorescence lifetimes includes any means of sampling an emission beam, using either time-resolved fluorometry or phase modulation fluorometry, or any other suitable method, such that the sampling results in a determination the fluorescence lifetimes of the fluorophores of interest.

ii. Fluorescent-Based Model Systems Using an Arylboronic Sensing Moiety and Lifetime Measurements of Quantification

1. Exemplary Model Systems of the Invention

The present invention provides methods to accurately quantify the presence of polyhydroxylate analytes in fluids, particularly, physiological fluids. The invention further provides polyhydroxylate analyte sensors and systems which utilize the methods to detect and quantify the levels of polyhydroxylate analyte in fluids. Thus the method of the invention encompass measurements which quantify the presence of polyhydroxylate analyte in fluids in-vitro, in-vivo and in-situ.

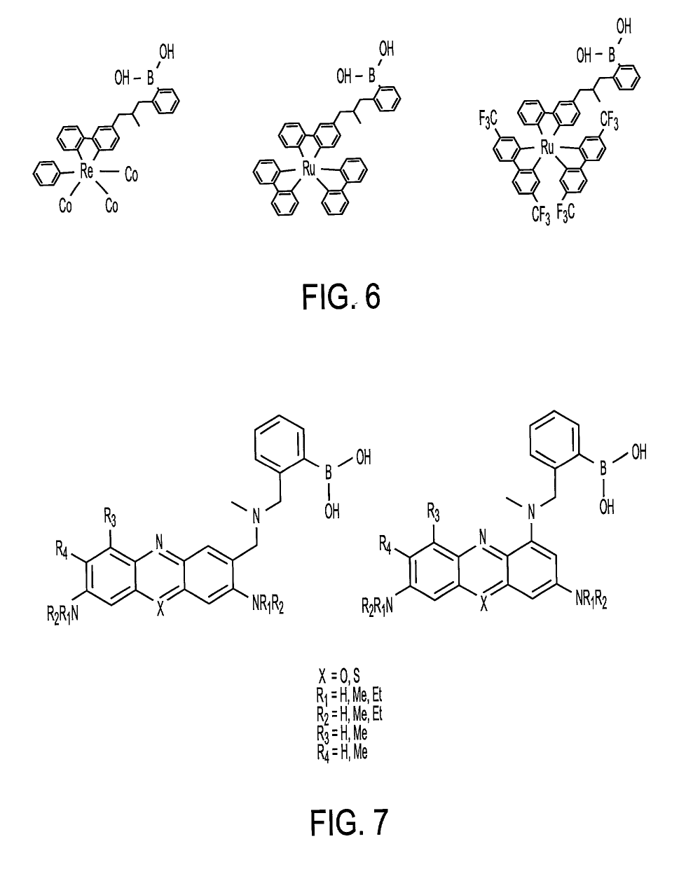

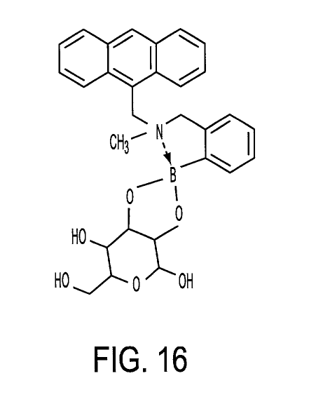

The fluorescent sensor molecules used in the invention typically comprise moieties capable of producing a fluorescence emission signal, or emission beam, following the absorption of light. Generally, fluorophores in the invention comprise arylboronic moieties in extended aromatic, or conjugated, systems and/or metal complexes, such as transition metal complexes. The fluorophore may also comprise alternative macromolecular structures known in the art such as proteins. Representative fluorophores suitable for use in the invention are shown in FIGS. 6-9. FIG. 16 shows the prototypical fluorescent sensor molecule bound to a polyhydroxylate analyte of interest, namely glucose. In FIG. 16, the model fluorophore comprises an anthracene moiety. This specific fluorescent sensor molecule is referred to herein as anthracene boronate, or AB.

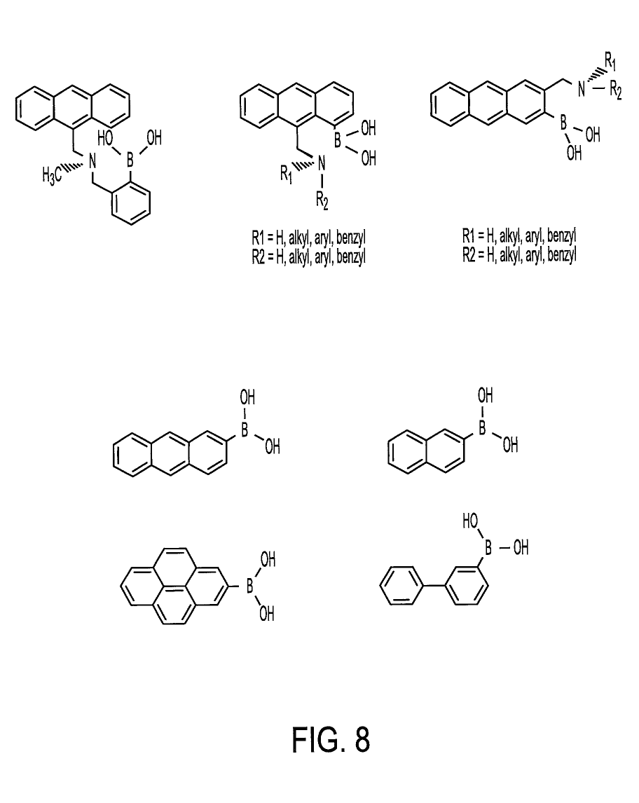

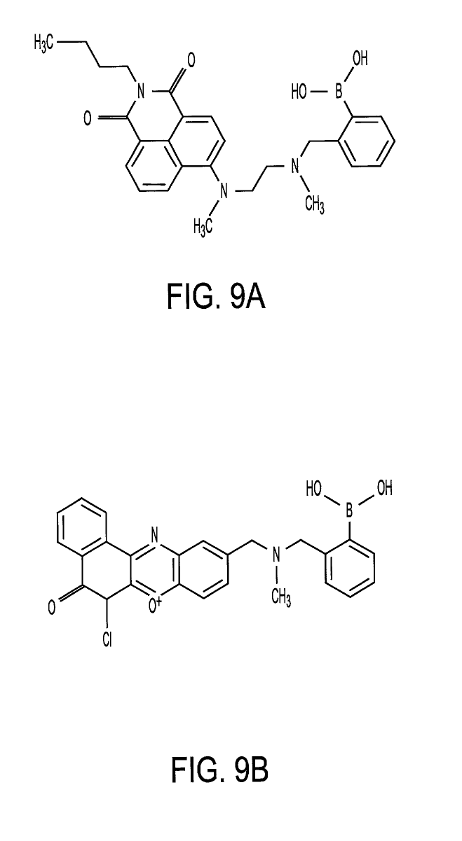

In FIG. 8 and FIG. 9, two fluorescent sensor molecules similar to the prototypical fluorescent molecule, AB, are shown. The fluorescent sensor molecules shown in FIG. 8-9 respectively comprise a COB fluorophore and a NIB fluorophore, built upon the prototypical framework of the model system. These two fluorophores, and derivatives thereof, are representative of the class of longer wavelength fluorophores suitable for use in the invention. These longer wavelength fluorophores are useful to elucidate general principles of fluorescence polyhydroxylate sensing, as well as the novel methods, sensors and sensor systems of the invention.

As illustrated by the prototypical fluorescent sensor molecule, embodiments of fluorescent sensor molecules of the invention comprises a receptor, or recognition, moiety which can sense the presence of the polyhydroxylate analyte. In such sensor molecules, the presence of the polyhydroxylate analyte generally results in a reversible binding reaction between the receptor or recognition moiety and the polyhydroxylate analyte. In the preferred embodiments of the invention, the receptor moiety comprises an arylboronic moiety. The boronic acid element of the arylboronic moiety specifically binds polyhydroxylate analytes, particularly glucose, as shown in FIG. 16. Additionally, as disclosed herein, sensing the presence of polyhydroxylate analytes by the fluorescent sensor molecule may involve a switching mechanism that allows the fluorescence of the fluorophore moiety to be essentially “turned on” by the binding of the polyhydroxylate analyte, or conversely, “turned off” in the absence of polyhydroxylate analyte.

In preferred embodiments of the invention, the switch comprises an element that is capable of donating electrons to the fluorophore in its excited state. In this scenario, the excited state fluorophore is an electron acceptor and the switch is an electron donor. Thus, the switch typically comprises an element that is electron rich. For example, the switch may comprise an element that contain electron-rich atoms, such as nitrogen, sulfur, oxygen or phosphorous, or electron rich chemical entities, such as conjugated systems containing π-electrons In FIG. 16, the prototypical switch comprises a nitrogen atom. The switch also may be an electron deficient element, such as a boronic acid group of the prototypical fluorescent sensor molecule.

2. Lifetime Fluorometry

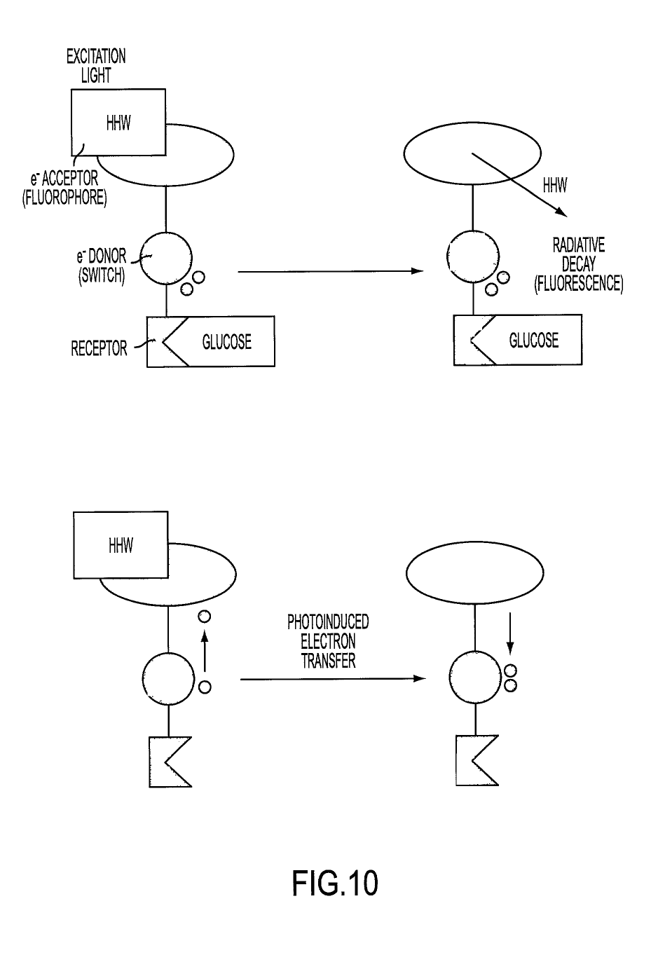

FIG. 10 illustrates the typical steps involving the process of “fluorescence sensing” by an illustrative fluorescent sensor. As illustrated in FIG. 10, in the presence of polyhydroxylate analyte, the analyte is bound to the receptor or recognition moiety. In a first step in the fluorescence sensing process, the binding of polyhydroxylate analyte serves to modulate the fluorescence sensing process. In a second step in the fluorescence sensing process, the fluorophore moiety absorbs light to produce an excited state fluorophore. Following the absorption of light, the fluorophore typically relaxes back to its ground state by a radiative decay process. A third step of the fluorescence sensing process involves the measurement of an emission signal, i.e., light that is produced form this radiative decay process.

Further illustrated in FIG. 10 are the steps involved in the fluorescence sensing process in a group of embodiments of the invention. In the absence of the polyhydroxylate analyte, the fluorophore can be excited by light to produce an excited state fluorophore. In this excited state, an electron is elevated from its ground state orbital position to an excited state orbital position. With the fluorophore in its excited state, the electron-rich element of the switch moiety can transfer an electron to the excited state fluorophore. This non-radiative decay process is called “photo-induced electron transfer.” In a second step of this non-radiative decay process, the electron is retained back to the electron-rich, switch element. These processes result in the quenching of the intrinsic fluorescence of the fluorophore.

In a model system illustrated in FIG. 10, in the absence of polyhydroxylate analyte, the fluorescent sensor molecule generally does not fluoresce, i.e., produce a beam of light, because the excited state transitions to the ground state by the electron transfer process. In this context, the binding of polyhydroxylate analyte to the fluorescent sensor molecule modulates of the fluorescence of the fluorescent sensor molecule. Specifically, when the polyhydroxylate analyte is bound to the receptor or recognition moiety, the photo-induced electron transfer process is inhibited, thus allowing the excited fluorophore to transition to the ground state by the emission of light, i.e., by fluorescence.

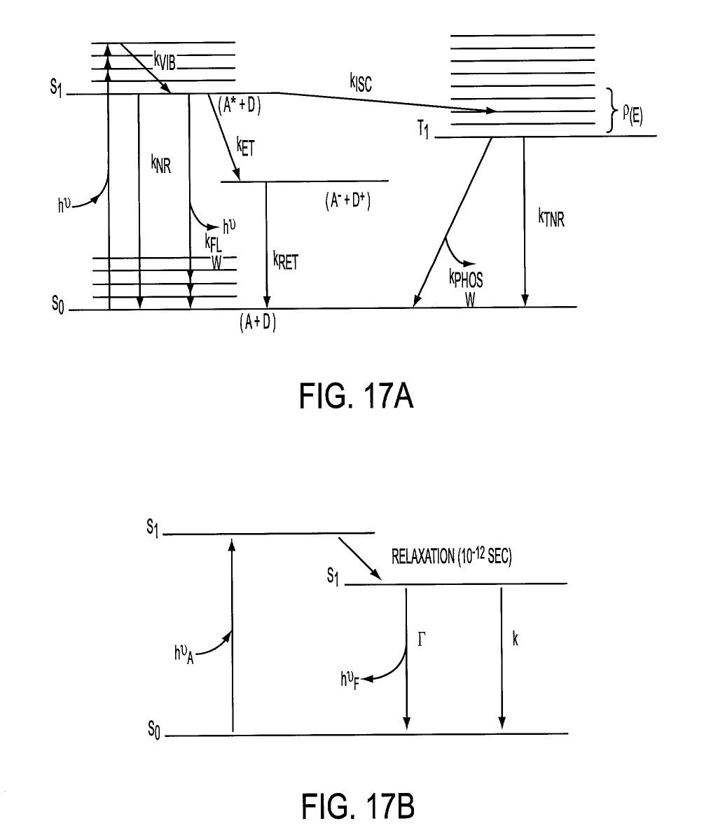

FIG. 17 illustrates the decay processes involved in fluorescence quenching of the fluorescent sensor molecules of the invention. The first step in the Jablonski diagram, shown in FIG. 17a, is the absorption of a photon (hv) by the fluorescent sensor molecule. In the Jablonski diagram, k_{NR} is the non-radiative decay rate, k_{FL} is the fluorescent decay rate, k_{ET} is the rate of decay from photoinduced electron transfer, and k_{ISC} is the rate of decay due to intersystem crossing from the first singlet state to the first (or in some rare cases, second or higher) triplet state (T₁). k_{RET} is the rate of return from the charge transfer (A⁻+D⁺) state to the ground (S₀) state, k_{PHOS} is the rate of phosphorescence from the triplet (T₁) state, and K_{TNR} is the rate of non-radiative decay from the triplet state. Thus, as illustrated in the diagram, non-radiative decay processes leads to quenching of the intrinsic fluorescence of the fluorescent sensor molecule of the invention.

As noted above, the present invention relies on the measurement of fluorescence lifetimes of the fluorescent sensor molecule in the presence and absence of polyhydroxylate analyte. The fluorescence lifetime, or a related parameter referred to as quantum yield, of the fluorescent sensor molecule are best illustrated by reference to the modified Jablonski diagram shown in FIG. 17b. In this diagram, all decay processes that lead to a return to the ground state are grouped into two general processes, the emissive rate of the fluorophore (Γ) and the rate of non-radiative decay to Sₒ (k).

The fluorescence quantum yield is the ratio of the number of photons emitted to the number absorbed. The rate constants Γ and k both depopulate the excited state. The fraction of fluorophores which decay through emission, and hence the quantum yield, is given by

$$Q = \frac{Γ}{Γ + k}$$

Thus, the quantum yield can be close to unity if the non-radiative rate of decay is much smaller than the rate of radiative decay via fluorescence.

Generally, the lifetime of the excited state is defined by the average time the fluorescent molecule spends in the excited state prior to return to the ground state. For a fluorophore illustrated by FIG. 17b, the lifetime is

$$τ = \frac{1}{Γ + k}$$

The lifetime of the fluorophore in the absence of non-radiative decay processes is called the intrinsic lifetime of the fluorophore, and is given by

$${τ}_{o} = \frac{1}{Γ}$$

This leads to the familiar relationship between the quantum yield and the lifetime of a fluorophore

$$Q = \frac{τ}{{τ}_{o}}$$

The quantum yield and lifetime can be modified by any factors which affect either of the rate constants.

The methods of the invention acquire fluorescence lifetime data in the form of decay rates in the presence and absence of polyhydroxylate analyte, via a pulse method or a harmonic or phase-modulation method, so that the fluorescence lifetime, or lifetimes, of a fluorophore of interest is determined. Both the pulse method and the harmonic or phase-modulation method involve exciting the fluorophore of interest with light so that a resulting emission beam is detected. Depending on the method used the resulting emission data can be used to calculate the fluorescence lifetime. Moreover, from the precise nature of the fluorescence decay, which is related to the fluorescence lifetime of the fluorescent sensor molecule, various interactions of the fluorophore with its environment can be discerned.

Thus, in the invention, a change in the average fluorescence lifetime of a fluid is observed as a function of polyhydroxylate analyte concentrations. This fluorescence lifetime change can then be correlated to particular concentrations of the polyhydroxylate analyte in the measured fluid.

3. Frequency Domain Fluorometry

To measure the fluorescence lifetime, the phase (Φ) and demodulation (m) are measured while the modulation frequency is varied. For a single exponential decay, the equations relating the fluorescence lifetime to the phase and modulation are straightforward.

tan φ=ωτ

$$m ≡ \frac{B / A}{b / a} = \frac{1}{\sqrt{1 + {ω}^{2} {τ}^{2}}}$$

However, for a multiexponential decay, the equations are more complex.

tan φ=N/D

$$m ≡ \frac{B / A}{b / a} = \sqrt{{N}^{2} + {D}^{2}}$$

where N and D are

$$N = {\sum }_{i = 1}^{n} {f}_{i} sin {φ}_{i} cos {φ}_{i}$$

$$D = {\sum }_{i = 1}^{n} {f}_{i} {cos}^{2} {φ}_{i}$$

The total number of exponential components is n, fᵢ is the fractional intensity of the ith component, and σᵢ is the phase shift from the ith component. Extracting the components of a multiexponential decay from the phase and modulation data is made manageable with computational curve fitting algorithms. These algorithms are described in detail in Example 6.

4. Analysis of the Phase-Modulation Lifetime Data

Analysis described in the Examples below is performed on the phase-modulation data using Globals Unlimited (Beechem, J. M.; Gratton, E. Globals Unlimited, Technical Reference Manual, Revision 3. Board E.; Wolfbeis, O. Fiber Optic Chemical Sensors and Biosensors, Vol. I, CRC press, 1991), an algorithm based program known in the art which uses a nonlinear minimization technique. Although this algorithm is preferred for use in the invention, other similar algorithms capable of data analysis can be used. One skilled in the art can assess the suitability of such similar algorithms.

Experimental data points (dataᵢ) are compared to values from the exponential fits (fitᵢ). The chi-square function (χ²) is a measure of the agreement between data and the fit. A more detailed treatment of the error analysis given here is provided in Example 5.

$${χ}^{2} = {\sum }_{i = 1}^{n} \frac{( {data}_{i} - {fit}_{i} )}{{σ}_{i}^{2} ( n - m - 1 )}$$

where σᵢ is the standard deviation for each data point measured, n is the total number of data points, and m is number of fitting parameters. To extract the fluorescence lifetimes and pre-exponential coefficients fitting parameters are adjusted to minimize χ². A value of χ² much higher or lower than unity indicates that the data either does not fit the theoretical exponential equations or the standard deviations (errors in individual measurements) are incorrect.

The Globals Unlimited program allows for multiple experiments to be linked together, thereby placing constraints on the lifetime values or other parameters. For all data points described here at least two, and typically five, trials were performed in succession. With the temperature held constant, the lifetime values of the samples are not expected to, and do not, change. Therefore, the lifetime values for each sample were linked together for all of the trials. Error analysis was performed on the data using the standard deviation of the values obtained for measurements on each sample without linking trials. Example 6 gives detailed, step by step examples of the error analysis for the AB model system.

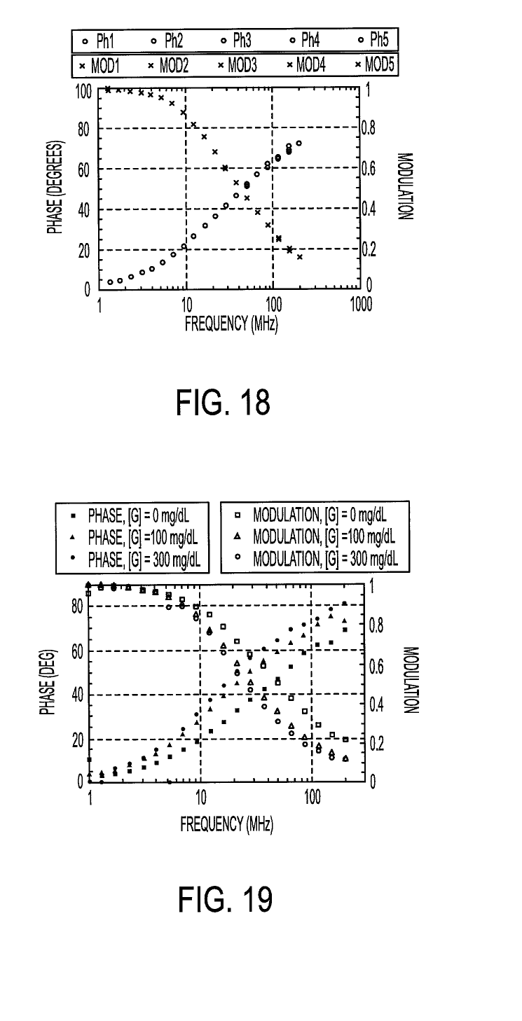

An example of the analysis of fluorescence lifetime measurements using AB in 50% methanol and 50% PBS solution (pH=7.4) is shown in FIG. 18. Five successive trials were performed on the same sample held at 25° C.

5. Application of Fluorescence Lifetime Quantification Methods to Determine Polyhydroxylated Analyte Concentrations

a) Fluorescence Lifetime Data

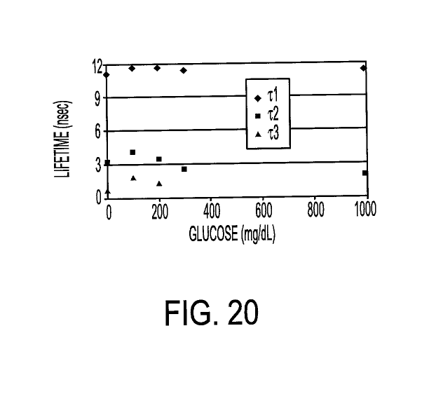

As disclosed herein Globals Unlimited software was used to analyze the data, linking the lifetime values together. The results of the minimization show 2 major lifetime components for AB (τ₁=11.159 ns, f₁=0.561; τ₂3.192 ns, f₂=0.397) and a minor component (τ₃=0.680 ns, f₃=0.042 with a χ² value of 0.975. A detailed treatment of the data is shown in FIG. 19 and FIG. 20.

FIG. 19 shows phase and modulation measurements as a function of excitation frequency for solutions of AB in PBS:MeOH:glucose (1:1:x where x corresponds to glucose concentrations of 0, 100, and 300 mg/dl). Increasing glucose concentration results in larger phase shifts for a given frequency. FIG. 20 shows the measured lifetimes of the three observed components in an 10⁻⁵ M AB solution of 1:1:x aq. PBS:MeOH:glucose. The dominant lifetimes (τ1 and τ2) are approximately constant over the glucose concentration range of interest. In these experiments the minor lifetime (τ3 which represents only a few percent of the fluorescent light emitted) is not observable at glucose concentrations higher than 200 mg/dl. As discussed below, the phase shift is primarily due to a changes in the relative populations of molecules having long or short lifetimes and not due to changes of the lifetimes themselves.

Although it has been reported that AB yields fluorescence intensity changes as a function of glucose concentrations, these measurements are not as accurate as the methods of the invention, where changes in fluorescence lifetimes are measured as a function of glucose concentrations. Further, given that fluorescence intensity changes as a function of glucose concentration gives no indication that the fluorescence lifetime also changes with glucose concentration. Thus, the observed fluorescence lifetime changes as a function of polyhydroxylate analyte concentrations, namely glucose, are unexpected, especially since there is no direct interaction between the fluorophore and the polyhydroxylate analyte.

As discussed above, fluorescence lifetimes are defined by the average time a fluorophore spends in the excited state before emitting a photon. Another unexpected result is that measurements of AB and ABG reveal two different and unique fluorescence lifetimes, τ_{AB} or τ_{ABG} respectively. The fluorescence lifetime of ABG is longer than that of AB because the fluorescence of AB is quenched by PET. However, a small fraction of AB molecules displays the same, unquenched, lifetime as ABG. The dual fluorescence of prototypical fluorescent sensor molecules of the invention in the presence and absence of polyhydroxylate analyte is taken into account in an equilibrium binding model, disclosed in detail below.

The total fluorescence as a function of time (F(t)) is a combination of fluorescence from both lifetime components. The fractional contribution (α_{AB} or α_{ABG}) of each fluorescence lifetime component (τ_{AB} or τ_{ABG}) is proportional to the concentration of each species ([AB] or [ABG]), as displayed in the following equations.

F(t)=(α_{AB})e^{-t/τ}^{_{AB}}+(α_{ABG})e^{-t/τ}^{_{ABG}}

$$\frac{{α}_{AB}}{{α}_{ABG}} = \frac{[ AB ]}{[ ABG ]}$$

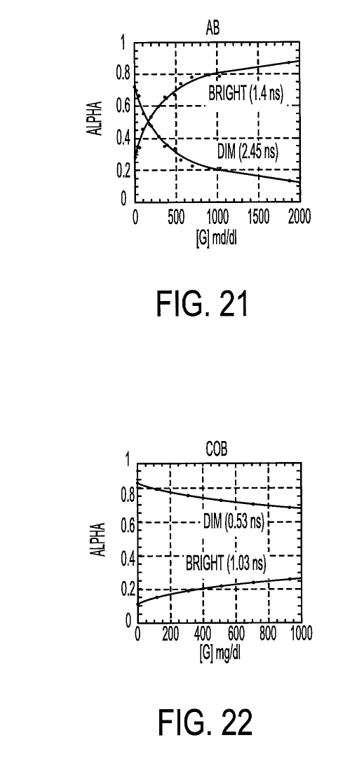

The polyhydroxylate optical sensor and sensor systems disclosed in the invention are based on measuring the change in the average fluorescence lifetime of AB in the presence of varying glucose concentrations. Once collected, this data can be used to calculate either the fractional component that corresponds to the longer lifetime, which is seen to increase with increasing glucose concentration, or the fractional component that corresponds to the shorter lifetime component, which is seen to decrease with increasing glucose concentrations (see, e.g., FIGS. 21, 22 and 23).

Additionally, both fractional components can be calculated. Moreover, given that the prototypical fluorescent sensor molecules of the invention have at least two fluorescence lifetimes, this feature can provide an internal method of calibrating or verifying the accuracy of the quantification methods of the invention. Specifically, the presence of two fluorescence lifetimes which show a measurable response to varying glucose concentrations yields a system that possesses internal calibration in that the decrease of the shorter lifetime component should equal, or nearly equal, the increase in the longer lifetime component. This internal calibration yields quantification methods and optical polyhydroxylate sensors with greater accuracy and reliability than prior art methods and sensors.

b) Equilibrium Binding Model Based On Fluorescence Lifetime Analyses

Experimental observations on the representative molecule AB can be explained by a simple model that assumes that there are only two fluorescent states, a dim low quantum yield state and a bright high quantum yield state corresponding to the short and long lifetimes, respectively. This assumption is consistent with the observation that the three model fluorescent sensor molecules, AB, COB and NIB, have two major fluorescent lifetimes which are roughly constant over the glucose range of interest (0-1000 mg/dl). The model assumes that a portion of the molecules, referred to as “normal”, are converted from dim to bright upon binding with glucose. And finally the model assumes that there are also molecules that are permanently in either the bright or dim states. These molecules remain either dim or bright despite binding to glucose. The model can be described by three adjustable parameters: the glucose binding constant K_{g}, the ratio of permanently dim to normal molecules K_{dim}, and the ratio of permanently bright to normal molecules K_{bright}. The reaction network is shown below

| | |
|---|---|
| 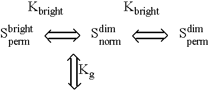 | not bound to glucose |
| 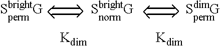 | bound to glucose |

Here fluorescent sensor molecules, i.e., transducer molecules,

$${S}_{norm}^{dim}$$

which are in the dim state are in equilibrium with molecules that are permanently in the dim state

$${S}_{perm}^{dim}$$

as well molecules permanently in the bright state

$${S}_{perm}^{bright} .$$

Molecules permanently in bright or dim states are also expected to bind to glucose G but do not change their fluorescent whereas normal molecules are converted from dim to bright upon binding. The equilibrium constants that are the adjustable parameters in the model are shown below.

$${K}_{g} = \frac{[ {S}_{norm}^{bright} G ]}{[ {S}_{norm}^{dim} ] [ G ]}$$

$${K}_{bright} = \frac{[ {S}_{perm}^{bright} ]}{[ {S}_{norm}^{dim} ]} = \frac{[ {S}_{perm}^{bright} G ]}{[ {S}_{norm}^{bright} G ]}$$

$${K}_{dim} = \frac{[ {S}_{perm}^{dim} ]}{[ {S}_{norm}^{dim} ]} = \frac{[ {S}_{perm}^{dim} G ]}{[ {S}_{norm}^{bright} G ]}$$

The fraction of each component (bright or dim) as a function of glucose concentration can be determined using the above equilibrium constants and conservation of mass.

$${[ G ]}_{0} = [ G ] + [ {S}_{norm}^{bright} G ] + [ {S}_{perm}^{bright} G ] + [ {S}_{perm}^{dim} G ]$$

$$\begin{matrix}[ {S}_{0} ] = [ {S}_{norm}^{dim} ] + [ {S}_{perm}^{dim} ] + [ {S}_{perm}^{bright} ] + [ {S}_{norm}^{bright} G ] + \\ [ {S}_{perm}^{bright} G ] + [ {S}_{perm}^{dim} G ]\end{matrix}$$

Here [G]₀ and [S]₀ are the initial unreacted concentrations of glucose and transducer, respectively. These equations can be solved to give the concentration of each species as a function of [G]₀. In particular the equilibrium glucose and transducer concentrations are given by the following equations.

$$\underline{[ {S}_{norm}^{dim} ] = \frac{{[ S ]}_{0}}{( 1 + {K}_{bright} + {K}_{dim} ) ( 1 + {K}_{g} [ G ] )}} \\ [ G ] = \frac{- B + \sqrt{D}}{2 A}$$

where

A=K_{g}

B=1+K_{g}([S]₀−[G]₀)

C=−[G]₀

D=B²−4AC

Concentrations of the other components can be then determined from the equilibrium constants. To compare with experiment the fractional amounts of each component (α_{dim} and α_{bright}) must be computed using

$${α}_{dim} = \frac{[ {S}_{norm}^{dim} ] + [ {S}_{perm}^{dim} ] + [ {S}_{perm}^{dim} G ]}{\begin{matrix}[ {S}_{norm}^{dim} ] + [ {S}_{perm}^{dim} ] + [ {S}_{perm}^{dim} G ] + [ {S}_{norm}^{bright} G ] + \\ [ {S}_{perm}^{bright} ] + [ {S}_{perm}^{bright} G ]\end{matrix}}$$

$${α}_{bright} = \frac{[ {S}_{norm}^{bright} G ] + [ {S}_{perm}^{bright} ] + [ {S}_{perm}^{bright} G ]}{\begin{matrix}[ {S}_{norm}^{dim} ] + [ {S}_{perm}^{dim} ] + [ {S}_{perm}^{dim} G ] + [ {S}_{norm}^{bright} G ] + \\ [ {S}_{perm}^{bright} ] + [ {S}_{perm}^{bright} G ]\end{matrix}}$$

c) Integration of Fluorescence Lifetime Data and Equilibrium Binding Model

A summary of the results of fitting these equations to experimental data for AB, COB, and NIB is shown in the table below.

TABLE 1
Summary of the data from three fluorophores AB, COB and NIB.

| | K_{g} | K_{dim} | K_{bright} | P_{long}/Pₛₕₒᵣₜ |
|---|---|---|---|---|
| AB | 53.14 | 0.02 | 0.38 | 4.74 |
| COB | 24.11 | 2.15 | 0.43 | 1.94 |
| NIB | 7.39 | 0.40 | 2.19 | 6.30 |

There are several things to note in the data provided in this table. AB has a glucose binding constant K_{g} which is within a factor of 2 of the optimum value of ˜100. AB also has essentially no molecules that are permanently dim, and there are a substantial but not untenable number of molecules that ate permanently bright. In contrast, COB has a glucose binding constant that is a factor of 2 lower than AB, COB has a large fraction of molecules that are permanently dim, and about the same number that are permanently bright. Finally NIB is seen to have a lower glucose binding constant, a moderate number of permanently dim molecules, and a large fraction of permanently bright molecules. These differences, which are function of the particular fluorophore used in the prototypical model system, provide numerous opportunities to generate different model systems by manipulating the fluorophore, or receptor moiety, to more aptly suit the precise conditions of detection of the polyhydroxylate analyte of interest.

The fits to the experimental data from which these constants were determined ate shown below are shown below. Measurements were made with fluorescent sensor molecules dissolved in 1:1 solutions of PBS and methanol.

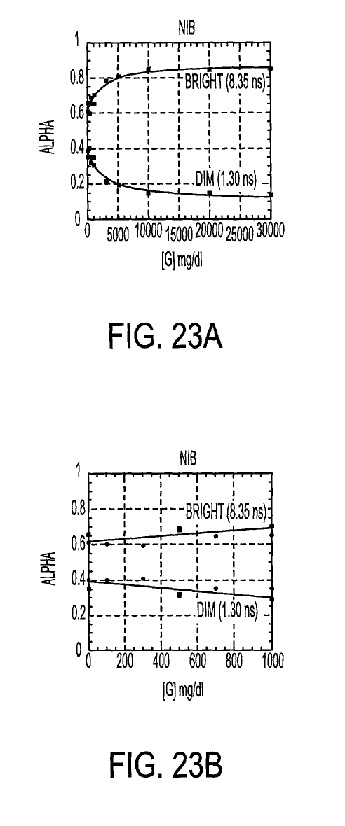

In the invention, glucose concentration is related to the relative populations of bright and dim molecules (α_{dim} and α_{bright}) for three fluorescent sensor molecules, namely AB, COB, and NIB, based on the prototypical model system. The results of these experiments are shown in FIG. 21, FIG. 22, and FIG. 23, for AB, COB and NIB, respectively.

The equation below shows how these populations are related to the phase angle.

$$tan φ = \frac{[ \frac{{α}_{dim} {ωτ}_{dim}^{2}}{1 + {ω}^{2} {τ}_{dim}^{2}} + \frac{{α}_{bright} {ωτ}_{bright}^{2}}{1 + {ω}^{2} {τ}_{bright}^{2}} ]}{[ \frac{{α}_{dim} {τ}_{dim}}{1 + {ω}^{2} {τ}_{dim}^{2}} + \frac{{α}_{bright} {τ}_{bright}}{1 + {ω}^{2} {τ}_{bright}^{2}} ]}$$

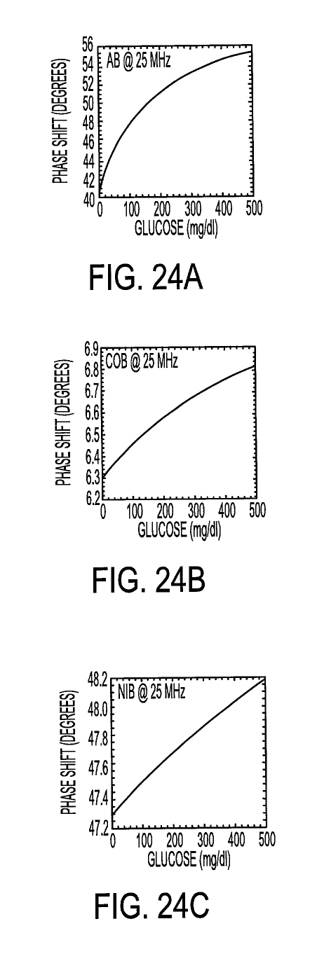

Using this equation and the equations for the relative populations, the relationship between the measured phase angle is determined. FIG. 24 illustrates how these equations are used to generate plots that show the phase shift as a function of glucose at an excitation modulation frequency of 25 MHz. Moreover, this excitation frequency can readily be achieved with simple LED light sources, for example.

To obtain 10% accuracy at 100 mg/dl phase measurements must be made to within approximately ±0.45, ±0.02, ±0.02 degrees for AB, COB, and NIB, respectively. With sufficient signal-to-noise even the smallest of these phase shifts is achievable in the present invention.

In terms of elucidating general principles of the prototypical model system, the three fluorescent sensor molecules behave in essentially the same manner: each has only two dominant fluorescent states, bright and dim; these states are associated with the two fluorescent lifetimes that are observed; glucose transduction occurs by converting dim state molecules to bright state upon binding; and the molecules are seen to have sub-populations that are permanently bright or dim.

d) Calibration of Lifetime Measurements

The polyhydroxylate sensors of the invention can be calibrated in any milieu of interest such as one that simulates the environmental conditions where the ultimate measurement are made. For in-vitro polyhydroxylate sensor calibration, the sensors are stabilized in the fluorescence spectrometer at PBS₀ (PBS refers to phosphate buffered saline) and the lifetime components for the fluorescent sensor molecules are extracted from the phase (φ) and demodulation (m) of the fluorescent signal. From the treatment of the data, two major lifetime components (τ₁ and τ₂), and one minor component (τ₃) are extracted. The lifetime components τ₁ and τ₂ are used to extract the active/dim (short lifetime) component of the fluorescent sensor molecules acid signal (FS_{act}). Upon the addition of glucose, the short lifetime component changes proportionally and can be used to calibrate the sensor versus concentration of glucose. The glucose concentration is raised to 100 mg/dL and the lifetime measurements and subsequent population calculations carried out. This procedure can be repeated for glucose concentrations of 200, 300 & 400 mg/dL etc. The calibration of each individual sensor is conducted multiple times using the same regimen. The data for all calibration runs ate compared; the slope and offset calculated for the best-fit curves.

To simulate the in-vivo milieu of the body fluids of a person, the identical in-vitro experiment as described above is conducted using human plasma (lyophilized, Sigma Chemical). The human plasma is first reconstituted in sterile water and treated with antibiotic antimycotic solution (10 μl/mi, Sigma Chemical 100X). The human plasma test solutions are then adjusted to the proper glucose levels by the controlled addition of glucose standards in sterile water. The solution concentrations ate verified using a YSI glucometer Model 2700-S, Yellow Springs Instrument Company, Yellow Springs, Colo.). Calibration curves are generated for each test specimen a total of 10 times. The data are fit using PRISM or MLAB and the analyses are compared to those from the PBS solutions.

In-vivo, small animal calibration studies of the polyhydroxylate analyte sensor are also performed and a comparison of in-vivo and in-vitro calibration data is made. Hyper and hypoglycemic clamp data are analyzed by applying various retrospective calibration methods against plasma glucose. These include linear regression analyses in which an offset and calibration factor are applied, as well as the method whereby a one-point calibration is used versus an arbitrary offset with a defined calibration factor at a basal measurement point, and a two-point calibration based upon two measurement points at different glucose levels (i.e. yielding offset and calibration data). Through the application of different calibration methods, the absolute error is determined by regressing the sensor's (glucose) output against plasma glucose values.

e) Fluorescence Lifetimes Measurement in Membranes

Using a carbon chain attached to both the methyl group of the amine and a monomer before polymerization, AB has been successfully incorporated into a PHEMA (poly hydroxy ethyl methacrylate) membrane. PHEMA is a biocompatible hydrogel that is non-toxic and does not elicit an immune response in vivo, thereby discouraging encapsulation when implanted. Because it is a hydrogel, it has a high water content to support efficient diffusion of interstitial fluid, including glucose, through the membrane. Typical diffusion coefficients for glucose across the PHEMA membrane are 1˜5×10⁻⁶ cm²/sec (for sucrose in H₂O, D=5.23×10⁻⁶ cm²/sec). The pore size in the PHEMA can be determined by the number of cross-linkers (ethylene glycol dimethacrylate) added during synthesis. The cross-linkers act like rungs in a ladder, connecting the hydrogel monomers together.

Two lifetimes were measured on AB in a polymer membrane. Without glucose, the two lifetimes are approximately 14.2 nsec and 1.4 nsec. With 1000 mg/dL glucose the lifetimes increase slightly to 17.3 nsec and 3.1 nsec. Alpha values for the longer lifetime increase from 0.43 nsec to 0.46 nsec with the addition of 1000 mg/dL glucose.

f) Sensor Accuracy and Sensor Potential

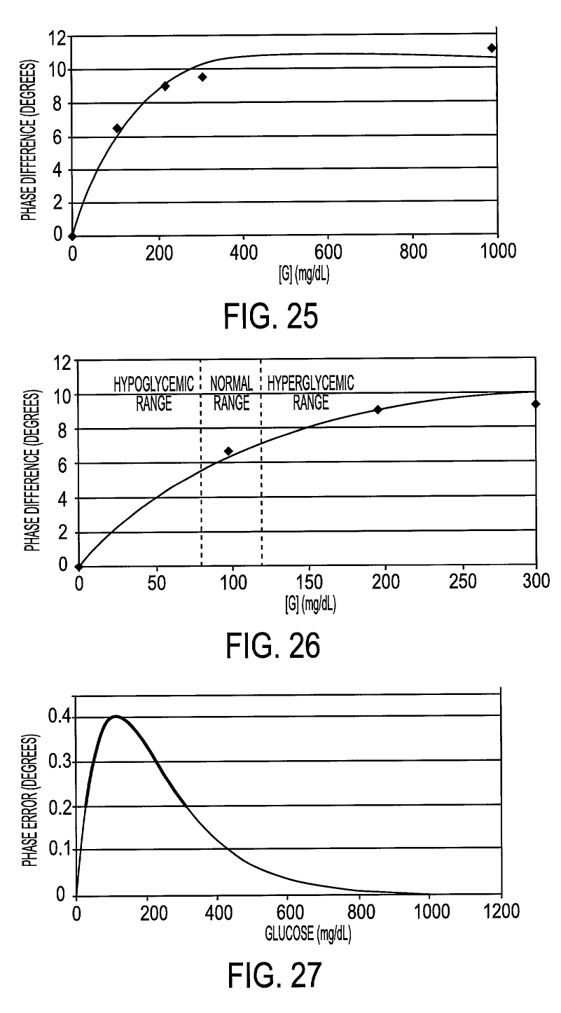

For prototypical fluorescent molecules of the invention to yield reliable polyhydroxylate sensors, accurate measurements of the phase shift or amplitude modulation must be made as a function of glucose at the modulation frequency of the incident light. The maximum phase shift with glucose is detected at 17 MHz. Using light modulated at 17 MHz, the phase difference between the incident light and the fluorescence is a simple function of glucose. FIG. 25 depicts the phase lag between the fluorescence and excitation as a function of glucose concentration.

The phase difference in depicted in FIG. 25 was determined by first calculating the average lifetime from the two or three lifetime values measured, and then using the simple relationship between phase and lifetime given by

tan φ=ωτ

In the equation below, ω is the frequency of modulation, fᵢ is the fractional contribution of species i to the fluorescence, and τᵢ is the lifetime of species i.

$$φ = {tan}^{- 1} ( \frac{1}{ω} {\sum }_{i} {f}_{i} {τ}_{i} )$$

For AB this becomes

$$Δφ = {tan}^{- 1} [ \frac{1}{ω} ( {f}_{ABG} {τ}_{ABG} + {f}_{AB} {τ}_{AB} ) ] - {tan}^{- 1} [ \frac{1}{ω} ( {f}_{AB} {τ}_{AB} ) ]$$

From this equation it is apparent that the phase difference can be increased by increasing the lifetime of ABG, decreasing the lifetime of AB, or uniformly increasing both lifetimes. Moreover, theoretical consideration suggest that a long lifetime should increase the phase difference, allowing for greater accuracy of polyhydroxylate analyte measurements, particularly glucose, at lower modulation frequencies.

An equation for the curve, given below, was found using a least squares fit of the data, letting the constant (10.85) and the exponential factor (0.0087) vary.

Δφ=10.85 1−e^{-[G]0.0087}

Observing the glucose range of physiological interest, it is noticeable that the largest change in phase is at the lower end of the range (FIG. 25). This is advantageous for accurate measurements in the hypoglycemic range.

FIG. 26 shows the physiological glucose range and the phase difference expected at 17 MHz. Small (120×60×30 mm), portable fluorescence lifetime sensors have been built using only one frequency of modulation. The typical accuracy of the phase measurements is 0.2 degrees, with 0.1 degree possible. To obtain measurements within 5% of the actual glucose value, the required phase accuracy varies with glucose concentration, as shown in FIG. 27. In FIG. 27, phase difference was determined using the above equation to predict the change in phase with glucose concentrations ranging ±5% of the true values. FIG. 27 shows a 0.4 degree error is needed to accurately measure a glucose concentration of 110 mg/dl. With an error of 0.2 degrees, 95% accuracy can be achieved for glucose concentrations ranging from approximately 27 mg/dL to 300 mg/dL. These concentrations covet the range of interest for a diabetic: the hypoglycemic range below 80 mg/dL, as well as the hyperglycemic range above 120 mg/dL.

The methods disclosed herein can be employed in a variety of fluorescence-based polyhydroxylate analyte sensors. Illustrative embodiments of such sensors and sensor systems are discussed below.

II. Exemplary Fluorescence-Based Polyhydroxylate Analyte Sensors

The method and polyhydroxylate analyte sensors and systems of the invention can be used to determine the presence of polyhydroxylate analyte in-vitro, in-situ or in-vivo. Preferred optical polyhydroxylate analyte sensors of the invention possess the following characteristics making theses sensors and sensor systems particularly suitable for in-vivo determinations of polyhydroxylate analyte abundances or concentrations in the body fluids of a person.

i. Polyhydroxylate Analyte Sensor Architecture

The polyhydroxylate analyte sensor and sensor systems of the invention can be embodied in a variety of design architectures which facilitate in-vivo determinations of the presence of polyhydroxylate analyte. Preferred polyhydroxylate sensor architectures facilitate in-vivo determinations of analyte abundances or concentrations. Sensor architecture also includes an optical system that supports both excitation of, and detection of emission from, the fluorescent sensor molecule. Embodiments of the optical system also may include one of more filters or discriminators, which filter the incident and/or emitted beams of light so as to obtain the appropriate wavelengths for excitation and emission of the fluorophore.

The optical sensors and system designs to be utilized in the invention are disclosed in U.S. Pat. Nos. 6,002,954 and 6,011,984, which have been incorporated by reference in their entireties above. A number of other methods and sensor compositions which employ glucose sensing molecules are known in the art. For example U.S. Pat. No. 5,628,310 to Rao et al., which is incorporated herein by reference, describes an apparatus and method to enable minimally invasive transdermal measurements of the fluorescence lifetime of an implanted element without reagent consumption and not requiring painful blood sampling. U.S. Pat. No. 5,476,094 to Allen et al., which is incorporated herein by reference, disclosed membranes which are useful in the fabrication of biosensors, e.g., a glucose sensor, intended for in vivo use. U.S. Pat. No. 6,040,194 to Chick et al., which is incorporated herein by reference, discloses in vivo methods and apparatuses for detecting an analyte such as glucose in an individual. U.S. Pat. No. 5,246,867 to Lakowicz et al., which is incorporated herein by reference, discloses method for measuring the concentration of a saccharide, conjugated saccharide or polysaccharide of interest using luminescent lifetimes and energy transfer in which an energy transfer donor-acceptor pair is added to a sample to be analyzed, the donor of the donor-acceptor pair being photoluminescent. U.S. Pat. No. 6,011,984 to Van Antwerp et al., which is incorporated herein by reference, discloses methods for the determination of the concentration of biological levels of polyhydroxylated compounds, particularly glucose. These methods utilize an amplification system that is an analyte transducer immobilized in a polymeric matrix, where the system is implantable and biocompatible. Upon interrogation by an optical system, the amplification system produces a signal capable of detection external to the skin of the patient. Quantitation of the analyte of interest is achieved by measurement of the emitted signal.

As discussed above, the invention provided herein is directed to novel analyte detection systems based on more robust, small molecule transducers. These molecules can be used in a number of contexts including subcutaneously implantable membranes that provide a fluorescent response to, for example, increasing glucose concentrations. Once implanted, the membranes can remain in place for long periods in time, with glucose measured through the skin by optical excitation and detection. A number of similar systems have been published previously, largely from Shinkai's group and primarily involving detection by colorimetry and circular dichroism spectroscopy (see e.g. James et al., Angew Chem Int Ed 1996, 35, 1911-1922; Ward et al., Chem Commun 2000, 229-230 and Lewis et al. Org Lett 2000, 2, 589-592). A smaller set of compounds make use of fluorescence detection (see e.g. Kukrer et al., Tetrahedron Lett 1999, 40, 9125-9128; Kijima et al., Chem Commun 1999, 2011-2012 and Yoon et al., J Amer Chem Soc 1992, 114, 5874-5875;. James et al., J Amer Chem Soc 1995, 117, 8982-8987). As disclosed in these articles and patents, illumination of the fluorescent sensor molecule, as well as detection, can be performed transdermally and/or subdermally.

Numerous light sources and detectors can be utilized in the invention. These light sources include laser diodes, LEDs, an incandescent light source, an electroluminescent lamp, an ion laser, a dye laser and/or a fluorescent light source. Detectors for use in the invention include photodiodes, CCD detectors and/or photomultiplier tubes.

1. Fiber Optic Polyhydroxylate Analyte Sensor

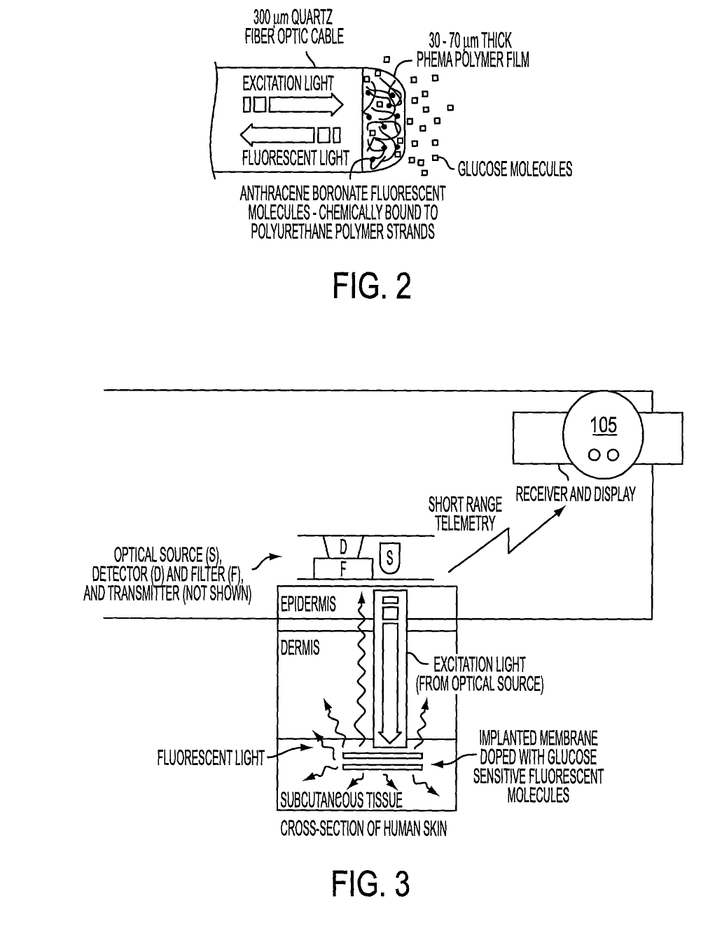

A schematic illustration of an embodiment of a fiber optic polyhydroxylate analyte sensor is shown in FIG. 2. This minimally invasive polyhydroxylate sensor architecture of the invention provides a fiber optic cable, preferably with a biocompatible polymer matrix or membrane attached to one end, or terminus. This matrix may be attached to the fiber by various means, such as dip coating onto to the fiber or by other physical and/or chemical methods. In preferred embodiments, the fluorescent sensor molecule is either covalently or physically linked to, or entrapped within, the biocompatible polymer matrix so as to immobilize the fluorescent sensor molecule and prevent its diffusion from the site of localization of the fiber optical system. Alternative embodiments can include fiber optic sensors comprising the fluorescent sensor molecule directly attached to the fiber without the utilization of a polymer matrix.

In practice, the fiber is inserted a few millimeters into the skin, preferably 1-4 mm. Insertion can be accomplished by a variety of means known in the art. For example, the insertion can be performed using a hollow needle to create a small incision needed for insertion. In this method, the needle is then removed, leaving the sensor in the subcutaneous tissue where interstitial fluids containing polyhydroxylate analyte, particularly glucose, can diffuse into the matrix and bind to the fluorescent sensor molecule. As described in further detail below, this binding interaction is the triggering event leading to fluorescence signal transduction.

Excitation light is delivered via the fiber from one or more of the light sources enumerated above. The fluorescent light emitted by the fluorescent sensor molecule is collected using the fiber. In certain embodiments, the emitted light can be passed through a filter, for example, a high pass filter, to remove any excitation light collected with the fluorescent signal. This sensor architecture can remain in place for several days with minimal threat of infection at the insertion site.

Other embodiments include the possibility of using multiple fibers that could be excited by the same source, thus yielding multiple measurements of polyhydroxylate analyte concentration. This design could add to the accuracy and robustness of the optical polyhydroxylate sensors and sensor systems of the invention.

2. Implantable Polyhydroxylate Analyte Sensor

Another minimally invasive sensor of the invention requires implantation in the subcutaneous tissue, preferably at a depth of 1-2 mm. This sensor design has the capability of remaining implanted for several years or more, thus providing for long-term polyhydroxylate analyte sensing. In the implantable sensor, the fluorescent sensor molecule is attached to a biocompatible polymer matrix or membrane. In a preferred embodiment, the fluorescent sensor molecule is covalently attached to the matrix. Thus, it is the matrix or membrane comprising the fluorescent sensor molecule that is implanted below the skin.

In an embodiment of the invention illustrated in FIG. 3, on top of the skin and above the sensor matrix or membrane, lies an optical system which comprises a light source, a light detector, optional filters to reject source light incident on the detector, and a radio transmitter to relay the detector signal to a remote device. The fluorophores of the fluorescent sensor molecules that are bound to the matrix are excited transdermally by the light source at the surface of the skin.

The emitted fluorescent signal from the transduced fluorescent sensor molecules bound to the matrix is measured by the detector in the optical system located on the skin's surface. A signal proportional to the detected fluorescence can be transmitted to a receiver that can be worn as a wristwatch, for example. This signal can be converted, or correlated, to a polyhydroxylate analyte measurement, such as the concentration of glucose in the interstitial fluids, and the result is displayed.

Another embodiment for the polyhydroxylate analyte sensor of the invention is similar to the fiber optic architecture, except that the entire device is implanted. This sensor design eliminates the problems associated with transdermal excitation and detection. Other embodiments include the possibility of using multiple implants that could be excited by the same source, thus yielding multiple measurements of polyhydroxylate analyte concentration. This design could add to the accuracy and robustness of the optical polyhydroxylate sensors and sensor systems of the invention.

Utilization of the fully implanted polyhydroxylate sensor would require insertion via minor surgery, as well as a long life battery or transdermal electromagnetic power delivery to a rechargeable system. As with the other implantable sensor architectures described, an injectable polyhydroxylate analyte sensor can be attached to a biocompatible matrix comprising fluorescent sensor molecules, thus allowing for permeability of polyhydroxylate analyte into the injected sensor. In the case of the injectable form of the polyhydroxylate analyte sensor, however, this matrix may or may not be biodegradable. Materials that can be utilized with the injectable sensor of the invention include, but are not limited to, poly(hydroxyethyl methacrylate), alginate, collagen, caprolactone, and temperature sensitive polymers, such as N,N-isopropyl acrylamide. A generalized injectable sensor is described in U.S. Pat. No. 6,163,714, and this patent is incorporated by reference herein in its entirety.

This sensor architecture allows for the constituents of the polyhydroxylated analyte sensor to be either broken down under the skin into harmless substances that are easily cleared from the body through natural pathways or removal of the sensor can be performed by aspiration of the sensor constituents through a syringe. Thus, the injectable polyhydroxylate analyte sensor could be periodically reinjected or could be more robust and last indefinitely.

In an alternative embodiment of the injectable sensor, fluorescent sensor molecules, either attached or unattached to a polymer matrix, are injected into a biocompatible, dialysis-like, i.e., permeable, and optically transparent pouch. In this embodiment, the pouch is first implanted under the skin at an appropriate and externally accessible location, for example, the arm, abdomen, or back of the ear. Following implantation of the pouch, an external access means, such as a syringe, is provided for injection of and/or retrieval of the sensor from the pouch.

As with the other sensor architectures disclosed, the optical system, including a light source and a detector, can be located outside the body and/or injected subdermally, including only some of the components of the optical system being injected, along with the injectable sensor.

ii. Immobilization of the Fluorescent Sensor Molecule in a Polymer Matrix

In order to use the fluorescent sensor molecules for polyhydroxylate analyte sensing in vivo, the fluorescent sensor molecules are preferably immobilized in a polymer matrix that can be implanted or inserted subdermally. This matrix should be permeable to the polyhydroxylate of interest and be stable within the body. The matrix should be prepared from biocompatible materials, or alternatively, coated with a biocompatible polymer. As used herein, the term “biocompatible” refers to a property of materials or matrix which produce no detectable adverse conditions upon implantation into an animal. While some inflammation may occur upon initial introduction of the implantable amplification system into a subject, the inflammation will not persist and the implant will not be rendered inoperable by encapsulation (e.g., scar tissue).

The biocompatible matrix can include either a liquid substrate (e.g., a coated dialysis tube) or a solid substrate (e.g., polyurethanes/polyureas, silicon-containing polymers, hydrogels, solgels and the like). Additionally, the matrix can include a biocompatible shell prepared from, for example, dialysis fibers, teflon cloth, resorbable polymers or islet encapsulation materials. The matrix can be in the form of a disk, cylinder, patch, microspheres or a refillable sack and, as noted, can further incorporate a biocompatible mesh that allows for full tissue ingrowth with vascularization. While subdermal implantation is preferred for long-term analyte sensing, i.e., longer than 2-3 days, one skilled in the art would realize other implementation methods could be used. Of course, the matrix must be permeable to the polyhydroxylate analytes and any other reactants necessary for transduction of a signal. For example, a matrix used to sense the presence of glucose must be permeable to glucose. Finally, the implant or insertion should be optically transparent to the light from the optical source used for illuminating the polyhydroxylate sensor.

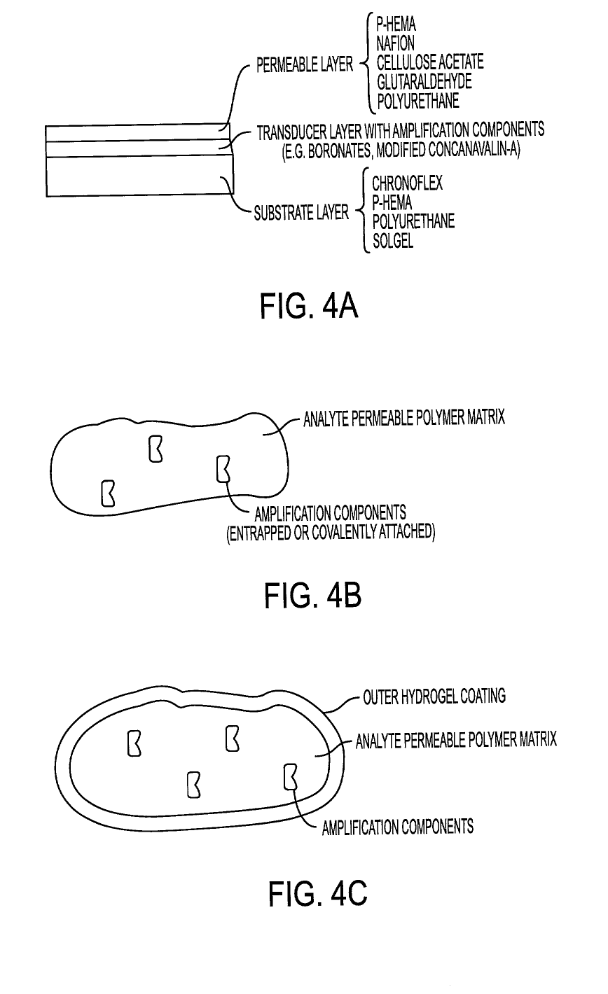

FIG. 4 provides an illustration of several embodiments. As seen in FIG. 4A, a fluorescent sensor system of the invention may include other layers, such as a substrate layer, a transducer layer containing the fluorescent sensor molecules, and a layer which is permeable to the analyte of interest. The substrate layer may be prepared from a polymer such as a polyurethane, silicone, silicon-containing polymer, chronoflex, P-HEMA or sol-gel. The substrate layer can be permeable to the analyte of interest, or it can be impermeable. For those embodiments in which the substrate layer is impermeable, the fluorescent sensor molecules will be coated on the exterior of the substrate layer and further coated with a permeable layer (see FIG. 4A).

In some embodiments, the fluorescent sensor molecules will be entrapped, or encased via covalent attachment, within a matrix which is itself permeable to the analyte of interest and biocompatible (see FIG. 4B). In these embodiments, a second permeable layer is unnecessary. Nevertheless, the use of a permeable layer such as a hydrogel which further facilitates tissue implantation is preferred (see FIG. 4C).

1. Biocompatible Matrix

For those embodiments in which a polymer matrix is to be placed in contact with a tissue or fluid, the polymer matrix will preferably be a biocompatible matrix. In addition to being biocompatible, the outermost layer of an any optical polyhydroxylate analyte sensor of the invention, i.e., fiber optic, implantable and injectable sensors, should be permeable to the analyte of interest. A number of biocompatible polymers are known, including some recently described silicon-containing polymers (see, e.g. U.S. Pat. No. 5,770,060 which is incorporated herein by reference) and hydrogels (see e.g. U.S. Pat. No. 5,786,439 which is incorporated herein by reference).

Silicone-containing polyurethane can be used for the immobilization of most of the polyhydroxylate analyte sensor systems of the invention. Other polymers such as silicone rubbers (NuSil 4550), biostable polyurethanes (Biomer, Tecothane, Tecoflex, Pellethane and others), PEEK (polyether ether ketone) acrylics or combinations are also suitable.

a. Silicon-Containing Polymers

In one group of embodiments, the fluorescent sensor molecules are either entrapped in, or covalently attached to, a silicone-containing polymer. This polymer is a homogeneous matrix prepared from biologically acceptable polymers whose hydrophobic/hydrophilic balance can be varied over a wide range to control the rate of polyhydroxylated analyte diffusion to the amplification components. The matrix can be prepared by conventional methods by the polymerization of diisocyanates, hydrophilic diols or diamines, silicone polymers and optionally, chain extenders. The resulting polymers are soluble in solvents such as acetone or ethanol and may be formed as a matrix from solution by dip, spray or spin coating. Preparation of biocompatible matrices for glucose sensing have been described (see, e.g. U.S. Pat. Nos. 5,770,060 and 5,786,439 which are incorporated herein by reference).

The diisocyanates which are useful for the construction of a biocompatible matrix are those which are typically those which are used in the preparation of biocompatible polyurethanes. Such diisocyanates are described in detail in Szycher, SEMINAR ON ADVANCES IN MEDICAL GRADE POLYURETHANES, Technomic Publishing, (1995) and include both aromatic and aliphatic diisocyanates. Examples of suitable aromatic diisocyanates include toluene diisocyanate, 4,4′-diphenylmethane diisocyanate, 3,3′-dimethyl-4,4′-biphenyl diisocyanate, naphthalene diisocyanate and paraphenylene diisocyanate. Suitable aliphatic diisocyanates include, for example, 1,6-hexamethylene diisocyanate (HDI), trimethylhexamethylene diisocyanate (TMDI), trans-1,4-cyclohexane diisocyanate (CHDI), 1,4-cyclohexane bis(methylene isocyanate) (BDI), 1,3-cyclohexane bis(methylene isocyanate) (H₆XDI), isophorone diisocyanate (IPDI) and 4,4′-methylenebis(cyclohexyl isocyanate) (H₁₂MDI). In preferred embodiments, the diisocyanate is isophorone diisocyanate, 1,6-hexamethylene diisocyanate, or 4,4′-methylenebis(cyclohexyl isocyanate). A number of these diisocyanates are available from commercial sources such as Aldrich Chemical Company (Milwaukee, Wis., USA) or can be readily prepared by standard synthetic methods using literature procedures.

The quantity of diisocyanate used in the reaction mixture for the present compositions is typically about 50 mol % relative to the combination of the remaining reactants. More particularly, the quantity of diisocyanate employed in the preparation of the present compositions will be sufficient to provide at least about ¹⁰⁰% of the —NCO groups necessary to react with the hydroxyl or amino groups of the remaining reactants. For example, a polymer which is prepared using x moles of diisocyanate, will use “a” moles of a hydrophilic polymer (diol, diamine or combination), “b” moles of a silicone polymer having functionalized termini, and c moles of a chain extender, such that x=a+b+c, with the understanding that “c” can be zero.

A second reactant that can be used in the preparation of the biocompatible matrix of the invention is a hydrophilic polymer. The hydrophilic polymer can be a hydrophilic diol, a hydrophilic diamine or a combination thereof. The hydrophilic diol can be a poly(alkylene)glycol, a polyester-based polyol, or a polycarbonate polyol. As used herein, the term “poly(alkylene)glycol” refers to polymers of lower alkylene glycols such as poly(ethylene)glycol, poly(propylene)glycol and polytetramethylene ether glycol (PTMEG). The term “polycarbonate polyol” refers those polymers having hydroxyl functionality at the chain termini and ether and carbonate functionality within the polymer chain. The alkyl portion of the polymer will typically be composed of C2 to C4 aliphatic radicals, or in some embodiments, longer chain aliphatic radicals, cycloaliphatic radicals or aromatic radicals. The term “hydrophilic diamines” refers to any of the above hydrophilic diols in which the terminal hydroxyl groups have been replaced by reactive amine groups or in which the terminal hydroxyl groups have been derivatized to produce an extended chain having terminal amine groups. For example, a preferred hydrophilic diamine is a “diamino poly(oxyalkylene)” which is poly(alkylene)glycol in which the terminal hydroxyl groups are replaced with amino groups. The term “diamino poly(oxyalkylene” also refers to poly(alkylene)glycols which have aminoalkyl ether groups at the chain termini. One example of a suitable diamino poly(oxyalkylene) is polypropylene glycol)bis(2-aminopropyl ether). A number of the above disclosed polymers can be obtained from Aldrich Chemical Company. Alternatively, literature methods can be employed for their synthesis.

The amount of hydrophilic polymer which is used in the present compositions will typically be about 10% to about 80% by mole relative to the diisocyanate which is used. Preferably, the amount is from about 20% to about 60% by mole relative to the diisocyanate. When lower amounts of hydrophilic polymer are used, it is preferable to include a chain extender (see below).

Silicone polymers which are useful for the determination of polyhydroxylated analytes (e.g., glucose) are typically linear. For polymers useful in glucose monitoring, excellent oxygen permeability and low glucose permeability is preferred. A particularly useful silicone polymer is a polydimethylsiloxane having two reactive functional groups (i.e., a functionality of 2). The functional groups can be, for example, hydroxyl groups, amino groups or carboxylic acid groups, but are preferably hydroxyl or amino groups. In some embodiments, combinations of silicone polymers can be used in which a first portion comprises hydroxyl groups and a second portion comprises amino groups. Preferably, the functional groups are positioned at the chain termini of the silicone polymer. A number of suitable silicone polymers are commercially available from such sources as Dow Chemical Company (Nidland, Mich., USA) and General Electric Company (Silicones Division, Schenectady, N.Y., USA). Still others can be prepared by general synthetic methods known to those skilled in the art, beginning with commercially available siloxanes (United Chemical Technologies, Bristol, Pa., USA). For use in the present invention, the silicone polymers will preferably be those having a molecular weight of from about 400 to about 10,000, more preferably those having a molecular weight of from about 2000 to about 4000. The amount of silicone polymer which is incorporated into the reaction mixture will depend on the desired characteristics of the resulting polymer from which the biocompatible membrane are formed. For those compositions in which a lower analyte penetration is desired, a larger amount of silicone polymer can be employed. Alternatively, for compositions in which a higher analyte penetration is desired, smaller amounts of silicone polymer can be employed. Typically, for a glucose sensor, the amount of siloxane polymer will be from 10% to 90% by mole relative to the diisocyanate. Preferably, the amount is from about 20% to 60% by mole relative to the diisocyanate.

In one group of embodiments, the reaction mixture for the preparation of biocompatible membranes will also contain a chain extender which is an aliphatic or aromatic diol, an aliphatic or aromatic diamine, alkanolamine, or combinations thereof. Examples of suitable aliphatic chain extenders include ethylene glycol, propylene glycol, 1,4-butanediol, 1,6-hexanediol, ethanolamine, ethylene diamine, butane diamine, 1,4-cyclohexanedimethanol. Aromatic chain extenders include, for example, para-di(2-hydroxyethoxy)benzene, meta-di(2-hydroxyethoxy)benzene, Ethacure 100® (a mixture of two isomers of 2,4-diamino-3,5-diethyltoluene), Ethacure 300® (2,4-diamino-3,5-di(methylthio)toluene), 3,3′-dichloro-4,4′diaminodiphenylmethane, Polacure® 740 M (trimethylene glycol bis(para-aminobenzoate)ester), and methylenedianiline. Incorporation of one or more of the above chain extenders typically provides the resulting biocompatible membrane with additional physical strength, but does not substantially increase the glucose permeability of the polymer. Preferably, a chain extender is used when lower (i.e., 10-40 mol %) amounts of hydrophilic polymers are used. In particularly preferred compositions, the chain extender is diethylene glycol which is present in from about 40% to 60% by mole relative to the diisocyanate.

b. Hydrogels

In some embodiments, the polymer matrix containing the fluorescent sensor molecules can be further coated with a permeable layer such as a hydrogel, cellulose acetate, P-HEMA, nafion, or glutaraldehyde. A number of hydrogels are useful in the present invention. For those embodiments in which glucose sensing is to be conducted, the preferred hydrogels ate those described in U.S. Pat. No. 5,786,439 which is incorporated herein by reference. Alternatively, hydrogels can be used as the polymer matrix which encase or entrap the amplification components. In still other embodiments, the fluorescent sensor molecules can be covalently attached to a hydrogel.

Suitable hydrogels can be prepared from the reaction of a diisocyanate and a hydrophilic polymer, and optionally, a chain extender. The hydrogels are extremely hydrophilic and will have a water pickup of from about 120% to about 400% by weight, more preferably from about 150% to about 400%. The diisocyanates, hydrophilic polymers and chain extenders which are used in this aspect of the invention are those which are described above. The quantity of diisocyanate used in the reaction mixture for the present compositions is typically about 50 mol % relative to the combination of the remaining reactants. More particularly, the quantity of diisocyanate employed in the preparation of the present compositions will be sufficient to provide at least about 100% of the —NCO groups necessary to react with the hydroxyl or amino groups of the remaining reactants. For example, a polymer which is prepared using x moles of diisocyanate, will use “a” moles of a hydrophilic polymer (diol, diamine or combination), and “b” moles of a chain extender, such that x=a+b, with the understanding that “b” can be zero. Preferably, the hydrophilic diamine is a “diamino poly(oxyalkylene)” which is poly(alkylene)glycol in which the terminal hydroxyl groups are replaced with amino groups. The term “diamino poly(oxyalkylene” also refers to poly(alkylene)glycols which have aminoalkyl ether groups at the chain termini. One example of a suitable diamino poly(oxyalkylene) is polypropylene glycol) bis(2-aminopropyl ether). A number of diamino poly(oxyalkylenes) are available having different average molecular weights and are sold as Jeffamines® (for example, Jeffamine 230, Jeffamine 600, Jeffamine 900 and Jeffamine 2000). These polymers can be obtained from Aldrich Chemical Company. Alternatively, literature methods can be employed for their synthesis.

The amount of hydrophilic polymer which is used in the present compositions will typically be about 10% to about 100% by mole relative to the diisocyanate which is used. Preferably, the amount is from about 50% to about 90% by mole relative to the diisocyanate. When amounts less than 100% of hydrophilic polymer are used, the remaining percentage (to bring the total to 100%) will be a chain extender.

Polymerization of the substrate layer components or the hydrogel components can be carried out by bulk polymerization or solution polymerization. Use of a catalyst is preferred, though not required. Suitable catalysts include dibutyltin bis(2-ethylhexanoate), dibutyltin diacetate, triethylamine and combinations thereof. Preferably dibutyltin bis(2-ethylhexanoate is used as the catalyst. Bulk polymerization is typically carried out at an initial temperature of about 25° C. (ambient temperature) to about 50° C., in order to insure adequate mixing of the reactants. Upon mixing of the reactants, an exotherm is typically observed, with the temperature rising to about 90-120° C. After the initial exotherm, the reaction flask can be heated at from about 75° C. to 125° C., with about 90° C. to 100° C. being a preferred temperature range. Heating is typically carried out for one to two hours.

Solution polymerization can be carried out in a similar manner. Solvents which are suitable for solution polymerization include, tetrahydrofuran, dimethylformamide, dimethyl sulfoxide, dimethylacetamide, halogenated solvents such as 1,2,3-trichloropropane, and ketones such as 4-methyl-2-pentanone. Preferably, THF is used as the solvent. When polymerization is carried out in a solvent, heating of the reaction mixture is typically carried out for at least three to four hours, and preferably at least 10-20 hours. At the end of this time period, the solution polymer is typically cooled to room temperature and poured into deionized water. The precipitated polymer is collected, dried, washed with hot deionized water to remove solvent and unreacted monomers, then re-dried.

2. Immobilization Methods

Immobilization of the fluorescent sensor molecules into a polymer matrix described above can be accomplished by incorporating the components into the polymerization mixture during formation of the matrix. If the components are prepared having suitable available functional groups the components will become covalently attached to the polymer during formation. Alternatively, the fluorescent sensor molecules, as well as any other molecular components, can be entrapped within the matrix during formation. An amine-terminated block copolymer, polypropylene glycol)-block-poly(ethylene glycol)-block-poly(propylene glycol)bis(2-aminopropyl ether), can be reacted with a diisocyanate to form a biocompatible hydrophilic polyurea. In any case, the goal of immobilization is to incorporate the fluorescent sensor molecules into a matrix in such a way as to retain the molecular system's desired optical and chemical activity.

In some embodiments, the fluorescent sensor molecules are not be substituted with suitable functional groups for covalent attachment to a polymer during formation. In this instance, the reagents are simply entrapped. The amount of fluorescent sensor molecules used for either the covalent or entrapped methods will typically be on the order of about 0.5% to about 10% by weight, relative to the total weight of the biocompatible matrix. One of skill in the art will understand that the amounts can be further adjusted upward or downward depending on the intensity of the signal produced as well as the sensitivity of the detector.

In the preferred, fluorescent sensor molecules of the invention (shown in FIG. 1), a linker suitable for covalent attachment to a polymer can be located on any moiety, i.e., the fluorophore, the switch and/or the binding moiety. In embodiments where the switch comprises an amine element and the binding moiety comprises an arylboronic moiety, a linker suitable for covalent attachment is preferably located on the amine element. In these embodiments, the preferred linker comprises an aliphatic group with greater than 3 carbons, and most preferably, the linker comprises an aliphatic group with about 4-10 carbons. In addition to the aliphatic portion, a preferred linker also includes an appropriate functional group for covalent attachment, preferably an alcohol or amine.

iii. Longer Excitation and Emission Wavelength Fluorophores

In particular embodiments of the invention, an optical polyhydroxylate sensor and system are designed to be placed several millimeters beneath the surface of the skin. In the interstitial fluid located under the skin, polyhydroxylate analyte, particularly glucose, is able to diffuse into the sensor via a permeable, polymer matrix. The permeability of the matrix permits the polyhydroxylate analyte to come into contact with the fluorescent sensor molecules which are preferably attached to a polymer matrix.

In certain embodiments of the invention, polyhydroxylate analyte measurements are made using transdermal illumination and fluorescence detection, thus requiring the wavelengths of excitation and emission of the fluorophore to pass through the skin without significant loss of signal going in and coming out.

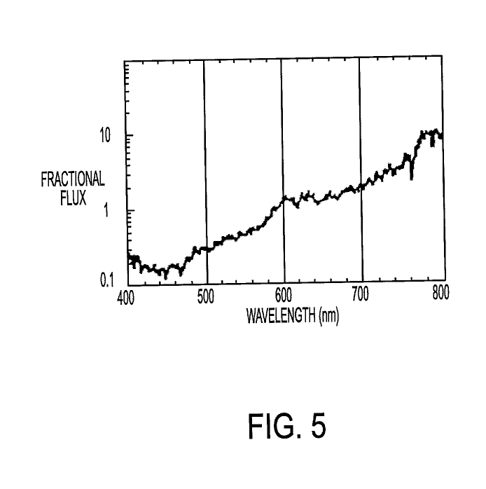

The transmission of light through 2.5 mm of skin has been measured. A graph of light transmission as a function of the wavelength of visible light is shown is FIG. 5. The graph depicts light transmission through the skin at the web of the hand between the thumb and forefinger. Although skin color and thickness affect the measurement, FIG. 5 shows that light transmission increases at longer wavelengths. This increase in light transmission is due to a decrease in light scattering by the tissue.

Thus, in the invention, it is preferred to utilize fluorophores with an excitation and emission wavelengths greater than 500 nm, and most preferably between about 600 nm and about 800 nm. These longer wavelength fluorophores allow for good transmission of excitation and emission light beams through the skin. Further, the longer excitation wavelengths allow for the use of cost effective and commercially available LEDs in the invention.

FIG. 6, FIG. 7, FIG. 9 and FIG. 9 depict some examples of representative longer wavelength fluorophores that can be used in the present invention. As shown in the figures, these longer wavelength fluorophores may comprise metal complexes, preferably transition metal complexes with coordinated to conjugated ligands, and extended conjugated and/or aromatic systems.

A detailed description of fluorophores that have the properties of longer wavelengths of excitation and emission are disclosed in co-pending application, U.S. Ser. No. 09/663,567 which is incorporated by reference herein in its entirety. The fluorophores disclosed in this co-pending application, as well as the fluorophores shown in FIG. 6, FIG. 7, FIG. 8 and FIG. 9 are suitable for use in the fluorescent sensor molecules of the present invention.

iv. Transduction of Recognition/Binding Event and Production of a Fluorescence Emission Signal

The preferred fluorescent sensor molecules of the invention generally comprise three functionalities which are provided in at least two moieties of the fluorescent sensor molecule. In this scenario, each moiety contributes one or more functionality that leads to the production of a fluorescence emission signal. In the generalized scheme depicted in FIG. 10, the receptor/recognition moiety (1) selectively and reversibly binds polyhydroxylate analyte. The switch moiety (2), which in the absence of the bound polyhydroxylate analyte serves to “turn off” a fluorescence signal by the fluorophore, now responds to the bound polyhydroxylate analyte by “turning on” the “inherent” fluorescent properties of the fluorophore (3). In this manner, the switch provides for signal transduction, i.e., the switch moiety can electronically and/or chemically respond to the recognition/binding of the polyhydroxylate analyte so that a fluorescence signal is produced by the fluorophore.

In the prototypical fluorescent sensor molecule of the invention, the switching function is provided mechanistically by photo-induced electron transfer (PET). Generally, this fluorescence quenching mechanism involves the transfer of an electron from the switch moiety (electron donor) to the fluorophore moiety (electron acceptor). As further illustrated in FIG. 10 for a generalized prototypical fluorescent sensor molecule of the invention, when polyhydroxylate analyte, for example glucose, is bound to the arylboronic moiety (receptor), the electrons of the switch moiety are “prevented” from being transferred to the fluorophore by “interactions” between the switch moiety and the boron of the receptor moiety. Thus, the polyhydroxylate analyte binding event effectively “turns off” the PET mechanism. However, when the polyhydroxylate analyte is not bound to the arylboronic moiety, an electron from the switch is “free” to be transferred to the excited state fluorophore via intramolecular PET, thereby quenching the fluorescence of the fluorophore.

The general mechanism where one moiety is capable of transmuting a binding event, or lack thereof, to another moiety capable of producing a signal is referred to herein as “transduction.” Further, any mechanism of signal transduction that follows the general mechanism disclosed is suitable for use in the present invention.

v. Optical Polyhydroxylate Sensor Systems

The polyhydroxylate sensors disclosed also comprise an optical system for interrogating a population of fluorescent sensor molecules, and detecting the signal thus produced by these sensor molecules. As referred to herein, the term “interrogating” generally means illumination of the population of fluorescent sensor molecules and subsequent detection of the emitted light.

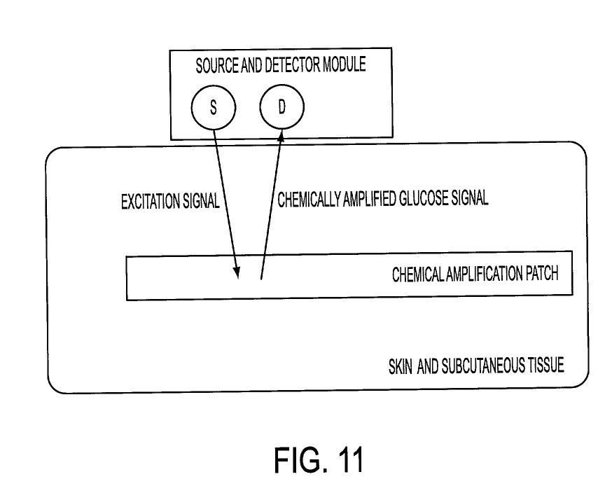

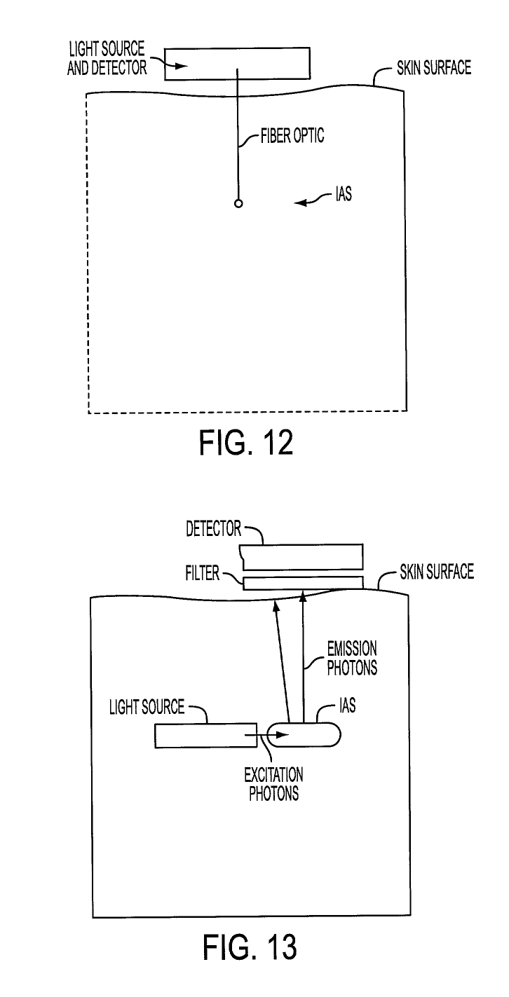

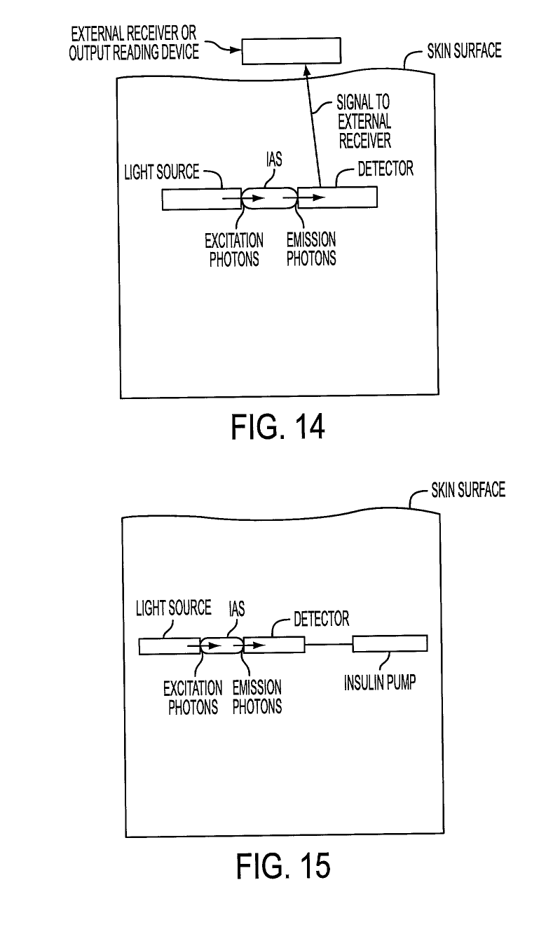

One embodiment illustrating a transdermal optical system is shown in FIG. 11, where the light source (S) shines through the skin, and a detector D) detects the fluorescence transmitted through the skin. FIGS. 12-15 show embodiments where there is no transmission through the skin, as the light source is implanted or the light travels via a fiber optic to the fluorescent sensor molecules positioned at the end of the fiber, for example.

FIG. 11 shows a schematic of the subdermally implanted optical glucose monitoring system. The light source (S) is any light source suitable for use in detecting fluorescence lifetimes, such as a lamp, an LED, or a laser diode (pulsed or modulated). The detector (D) can be a photodiode, CCD detector or photomultiplier tube. Optionally, filters are used to filter the incident and/or emitted beams of light to obtain desired wavelengths. The source and detector are shown in FIG. 11 as positioned outside the body, although the source and/or the detector can be implanted as shown in FIGS. 12-15. The biocompatible material (e.g., silicone, polyurethane or other polymer) with the immobilized fluorescent sensor molecules can be implanted under the skin. The light source is used to illuminate the implanted system, and the detector detects the intensity of the emitted fluorescent light.

In the quantification method of the invention based on the fluorescence lifetimes of the fluorophore, the ratio of the intensity of excitation and emission can be further utilized in the quantification method. In a preferred embodiment, the ratio of fluorescence from the fluorescence sensor molecules to the fluorescence of a calibration fluorophore is also measured. These two method eliminates errors due to registration and variations of light transport through the skin (e.g., caused by different skin tones).

Thus, in certain preferred embodiments, the implanted optical sensor system will further comprise a calibration fluorophore which provides a signal not interfering with the signal from the fluorescent sensor molecules. In preferred embodiments, fluorescent sensor molecules comprises a boronate based sugar binding moiety and a calibration fluorophore. Suitable calibration fluorophores are those fluorescent dyes such as fluoresceins, coumarins, oxazines, xanthenes, cyanines, metal complexes and polyaromatic hydrocarbons which produce a fluorescent signal.

1. Correlation of a Detected Signal to the Concentration of Polyhydroxylate Analyte

In the invention, an emission signal is detected by a detector. This detected signal is then correlated with a particular concentration of polyhydroxylate analyte. In general, a correlator in the present invention comprises a means for calibration of the lifetime data and/or a means for analyzing the lifetime data.

The correlator of the invention may comprise a computer, comprising software that enables the detected signal to be translated into a concentration for the polyhydroxylate analyte. This software may contain calibration curves which contain known relationships between a particular detected emission signal and the concentration of polyhydroxylate analyte in a similar environment as the environment wherein the optical polyhydroxylate sensor is placed. Also, the correlator may comprise an analyzer that performs one or more error analyses on the data to yield polyhydroxylate analyte concentrations with increased accuracy and reliability.

In the development of the invention, Excel programs were devised which were used in the calibrations for acquisition of fluorescence lifetime data. Also in the analysis of the fluorescence lifetime data, Global Unlimited software was used as described in more detail below. These program, as well as any other programs capable of calibrating and/or analyzing the data from the detector, are suitable for use in the present invention.

The skilled artisan understands that such models can be used with any fluorescent molecule which has been characterized, for example by calibration curves which establish the relationship between the concentration of polyhydroxylate analyte and a particular detected emission signal (see, e.g. the characterization of AB, COB and NIB as described herein).

vi. Quantification of Polyhydroxylate Analyte

In the prior art, quantification of the presence of polyhydroxylate analyte is typically made by observing changes in fluorescence intensity. Fluorescence intensity measurements, however, can be inherently inaccurate and/or imprecise due to certain optical phenomena. These light-based sources of inaccuracies of fluorescence intensity measurements include photobleaching, light scattering off tissue and a high absorbance by blood. Thus, measurements of fluorescence intensity are generally not practical for making reliable determinations of polyhydroxylated analyte concentrations, especially for measurements made in-vivo.

In the present invention, quantification of the presence of polyhydroxylate analyte is made based of changes in the fluorescence lifetimes of the fluorescent sensor molecule as a function of polyhydroxylate analyte concentrations. The novel quantification method does not possess the inherent inaccuracies or imprecision of fluorescence intensity measurements, and therefore, yields a more accurate and robust polyhydroxylate analyte sensor.

Although the methods disclosed herein are of primary interest for biomedical applications, the present sensor/transducer scheme is useful more generally for the measurement of other cis-diols. For example, the present methods have utility in the measurement of ethylene glycol contamination in boiler waters, where ethylene gycol contamination is an indication of heat exchanger tube degradation as well as other uses in similar contexts (see e.g. U.S. Pat. No. 5,958,192). In addition, these methods are useful in industrial fermentation processes (e.g. beer and wine), or in any number of process points in the production of high fructose corn syrup such as enzyme reactors and the like (see e.g. U.S. Pat. Nos. 5,593,868; 4,025,389; Ko et al., Biotechnol. Bioeng. 57(4): 430-437 (1998) and Mou et al., Biotechnol. Bioeng. 18(10): 1371-1392 (1976)). In this context, a number of the specific sensor molecules described herein exhibit characteristics which them particularly suited for uses such as the monitoring of industrial fermentation processes.

By using methods known in the art for evaluating the characteristics and activities of different fluorescent molecules in the presence of varying concentrations of analyte, the skilled artisan can readily identify fluorescent sensing molecules that can be used in the methods of the invention. For example, compounds described herein exhibit varying degrees of sensitivity to concentrations of analytes, properties which are advantageous for use in the context of monitoring solutions of industrial fermentation processes where such solutions have analyte concentrations that significantly exceed those observed, for example, in vivo. In addition, a number of the fluorescent sensor compounds described herein function in a wide pH range and in the presence of high concentrations of alcohols such as methanol, properties which are advantageous in the context of monitoring fermentation processes.

vii.) Synthesis of Typical Fluorescent Compounds

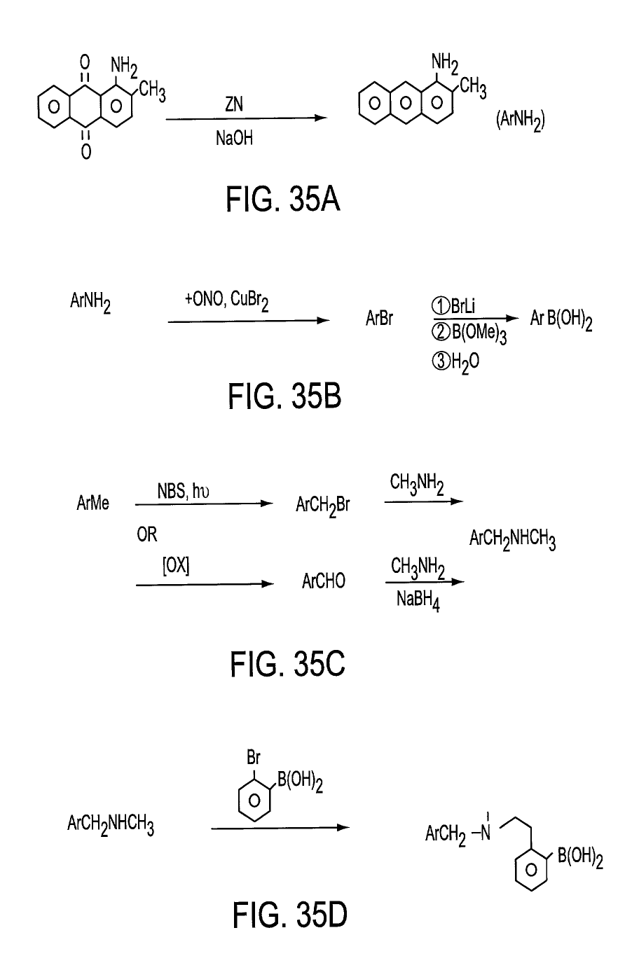

As described herein, synthesis schemes for generating molecules such as those having the specific formula shown in FIG. 1, have been known in the art for some time (see e.g. James et al., J. Am. Chem. Soc. 1995, 117, 8982 and Sandanayake et al., “Molecular Fluorescence Sensor for Saccharides Based on Amino Coumarin”, Chemistry Letters 139-140 (1995); Czarnik Acc. Chem. Res. 27, 302-308 (1994); Mohler et al., J. Am. Chem. Soc. 115, 7037-7038 (1993) and Deetz & Smith Tetrahedron Letters 1998, 39, 6841-44). Moreover, as shown below, Applicants provide descriptions for the synthesis of a variety of specific compounds of the invention including conjugated organic heterocyclic ring system compounds that are thiazines, oxazines, oxazine-ones, or oxazones and anthracene fluorophores. Such synthesis are described in U.S. patent application Ser. No. 09/663,567 which corresponds to the international application that was published on Mar. 22, 2001 under International Publication No. WO 01/20334, the contents of which are incorporated herein by reference. Skilled artisans understand that typical methods known in the art allow the generation of a wide variety of different fluorescent compounds that can be used in the methods and compositions of the invention. FIG. 35 outlines such typical synthesis schemes that can be used in the generation of fluorescent compounds such as those shown in FIG. 8 following methods know in the art (see, e.g. Castle et al., Collect. Czech. Commun. Vol. 56, (1991), pp 2269-2277).

1. Typical Synthesis of Transition Metal Compounds

For the synthesis of transition metal fluorophores, all reactions can be performed under an atmosphere of N₂, followed by work-up in air. Protected boronate esters can be stored under vacuum to prevent hydrolysis over long periods of time. Toluene and THF can be distilled from sodium/benzophenone under N₂; dichloromethane and acetonitrile can be distilled from calcium hydride under N₂. 4,4′-Dimethyl-2,2′-bipyridine (bpyMe) can be purchased from Aldrich or GFS Chernicals. The compounds 4-(bromomethyl)-4′-methyl-2,2′-bipyridine (bpyCH₂Br), 2,2-dimethylpropane-1,3-diyl[o-(bromomethyl)phenyl]boronate (3), 4-(diethylaminomethyl)-4′-methyl-2,2′-bipyridine (bpyCH₂NEt₂), [(bpyCH₂NEt₂)Re(CO)₃(py)](OTf) (py=pyridine, OTf=trifluorosulfonyl), 5,5′-bis(trifluoromethyl)-2,2′-bipyridine (bpyF), and Ru(bipyF)₂Cl₂ can be prepared by literature methods (see Hamachi et al., Inorg Chem 1998, 37, 4380-4388; Strouse et al., Chem 1995, 34, 473-487; Imperiali et al., J Org Chem 1993, 58, 1613-1616; Shen, Y. Ph.D., University of Wyoming, Laramie, Wyo.,1996 and Furue et al., Inorg Chem 1992, 31, 3792-3795).

Samples for FT IR spectroscopy can be prepared as solutions in CHCl₃, and only the C═O stretches are reported. Unless otherwise stated, all NMR spectra can be recorded at 500 MHz for ¹H and 125 MHz for ¹³C at 20-25° C. using CDCl₃ as the solvent. Unless stated otherwise, mass spectra can be obtained using electrosptay ionization (50 V) with a 50/50 methanol/water solvent mixture with 1% acetic acid added. Cyclic voltammetry can be conducted using a glassy carbon working electrode, platinum counter electrode, and Ag/AgCl reference electrode and carried out in a 0.1 M solution of NBu₄ClO₄ in acetonitrile.

Bipytidine Ligand Synthesis. Typical compounds of the invention include the new boronate and benzyl bipyridine ligands which can be synthesized by the routes known in the art. The common intermediate to both sets of transition metal complexes prepared in this work is the bipyridyl boronate ligand bpyNB. Previous work by Meyer (see e.g. Meyer, T. J. Account Chem Res 1989, 22, 163-170) and others has shown that compound bpyCH₂Br provides the simplest entry into a variety of functionalized bipyridine compounds. While the preparation of bpyCH₂Br can only be carried out in moderate yields, the final two alkylation steps generally occur in 70-80% yield, allowing multigram batches of bpyN or bpyNB to be conveniently prepared.

Rhenium Complex Synthesis. The rhenium complexes [(bpyX)Re(CO)₃Cl] and [(bpyX)Re(CO)₃(py)](OTf) (bpyX=bpyMe, bpyN, and bpyNB) can be prepared as shown in FIG. 18 using the bipyridyl ligands bpyMe, bpyN, and bpyNB. These reactions are analogous to previous reports and can be carried out in high yield (see e.g. Li et al., Chem Phys Lipids 1999, 99, 1-9). The three ligand derivatives can be prepared for both rhenium and ruthenium in order to aid in the interpretation of the fluorescence and electrochemical data discussed below. The ¹H and ¹³C{¹H} NMR spectra and MS data clearly confirm the identity of the compounds. IR spectra of the three chloro complexes, [(bpyX)Re(CO)₃Cl] (bpyX=bpyMe, bpyN, and bpyNB), each exhibit carbonyl stretches at 2022, 1917, at 1895 cm⁻¹; CO resonances are observed at 2034 and 1931 cm⁻¹ for each of the pyridium complexes [(bpyX)Re(CO)₃(py)](OTf). These data are in exact accord with the reported values for [(bpyCH₂NEt₂)Re(CO)₃Cl](OTf) (2021, 1917, at 1895 cm⁻¹) and [(bpyCH₂NEt₂)Re(CO)₃(py)](OTf) (2034 and 1931 cm^{31 1}). It is worth noting that the carbonyl stretching frequencies don't vary among the set of chloro compounds or among the set of pytidinium complexes. This suggests that the substituent changes on the periphery of the bipyridyl ligands do not substantially alter the electron density at the metal center.

Ruthenium Complex Synthesis. The syntheses of ruthenium bipyridine derivatives [(bpyX)Ru(bpyF)₂]Cl₂ (bpyX=bpyMe, bpyN, and bpyNB) can be carried out following a procedure analogous to that of Furue et al, which involves the direct combination of RuCl₂(bpyF)₂ with excess bipyridine ligand in refluxing methanol. The NMR and mass spectra clearly indicate the synthesis of the desired products. Attempts to carry out the reaction by the more common procedure of chloride abstraction with silver triflate followed by addition of the bipyridine derivative failed to yield the desired products (Gould et al., Inorg Chem 1991, 30, 2942-2949). This is presumably due to unwanted side reactions involving fluoride abstraction by Ag⁺from the trifluoromethylated bipyridyl ligands of RuCl₂(bpyF)₂.

Summarized Synthesis of Ru(N-methyl benzyl boronate)

1. Ligand Synthesis

(a) 4-carbaldehyde-4′-methyl-2, 2′-bipyridine: 4,4′-dimethylbipyridine can be refluxed overnight with one equivalent of SeO₂ in 1,4-dioxane. The solution can be filtered while still hot, and cooled to room temperature for an hour. The cream-colored precipitate can be removed by filtration and the solvent pumped dry. The crude solid can be extracted with ethyl acetate, can beheld with sodium carbonate solution, and then extracted with sodium bisulfite. The pH of this solution can be adjusted to 9 with sodium carbonate, and the solution extracted with dichloromethane. The combined organic extracts can be dried with magnesium sulfate and the solution pumped dry to a pure white powder. Yields 30%. ¹H NMR spectra are consistent with structure.

(b) 4-hydroxymethyl-4′-methyl-2,2′-bipyridine: A slurry of lithium aluminum hydride in THF can be added dropwise in slight excess to a solution of 4-carbaldehyde-4′-methyl-2,2′-bipyridine in THF at −40° C. Stirring can be continued for about an hour, until the temperature rose to about −20° C. The solution can be then cooled again to about −40° C. and quenched with 10% aqueous THF. The reaction can be warmed to room temperature, filtered, and pumped dry to a yellow powder. Yields 75%. ¹H NMR spectra are consistent with structure.

(c) 4-bromomethyl-4′-methyl-2,2′-bipyridine: To a solution of crude 4-hydroxymethyl-4′-methyl-2,2′-bipyridine in methylene chloride at 0° C. can be added a slight excess of both PPh₃ and N-bromosuccinimide to immediately give a brown-orange solution. The mixture can be stirred for 1 h, warmed to room temperature, and concentrated to a thick brown oil. Chromatography on silica with 1:1 hexanes:diethyl ether as eluent gave the product as a white powder. Yields 50%. ¹H NMR spectra are consistent with structure.

(d) 4-methylaminomethyl-4′-methyl-2,2′-bipyridine: Methylamine can be bubbled slowly through a solution of 4-bromomethyl-4′-methyl-2,2′-bipyridine in THF for 10 min at 0° C. to give a white precipitate and a colorless solution. After bubbling, the solution can be stirred for another hour at room temperature. The reaction can be pumped dry to a pale off-white wax. The wax can be extracted with diethyl ether and pumped dry to a pale yellow oil. Yields 80%. ¹H NMR spectra are consistent with structure.

(e) Neopentylglycol protected o-bromomethylphenylboronic acid. Prepared by a method described in the literature: Hawkins, et al., J. Am. Chem. Soc. 82:3863 (1960) and James, et al., J. Am. Chem. Soc. 117:8982 (1995).

(f) 4-[N-o-methylphenylboronic neopentylglycol ester]methylaminomethyl-4′-methyl-2,2′-bipyridine: A solution of 4-methylaminomethyl-4′-methyl-2,2′-bipyridine in acetonitrile can be added dropwise over 10 min to an equimolar solution of neopentylglycol protected o-bromomethylphenylboronic acid and triethylamine in acetonitrile to give a pale yellow solution that can be stirred for 1h at room temperature. The solution can be pumped dry to an off-white waxy solid. A colorless solution can be extracted from a cream-colored powder with diethyl ether, and pumped dry to a cream-colored waxy solid. Yields 75%. ¹H NMR spectrum is consistent with structure.

2. Ruthenium Complex Synthesis

(a) 5,5′-bistrifluoromethyl-2,2′-bipyridine (bipy^{f}) can be synthesized for the preparation of ruthenium complexes using a literature procedure. The substituted bipyridine ligands are used to shift metal complex redox potential so that PET becomes viable.

(b) The parent compound, Ru(5,5′-bistrifluoromethyl-2,2′-bipyridine)₂Cl₂, can be made by refluxing RuCl₃ with 5,5′-bistrifluoromethyl-2,2′-bipyridine in DMF. This can be used to prepare the bis(bipy^{F}) ruthenium complexes.

(c) (4-[N-o-methylphenylboronic neopentylglycol ester]methylaminomethyl-4′-methyl-2,2′-bipyridine)Ru(5,5′-bistrifluoromethyl-2,2′-bipyridine)₂Cl₂: A mixture of Ru(5,5′-bistrifluoromethyl-2,2′-bipyridine)₂Cl₂ and 4-[N-o-methylphenylboronic neopentylglycol ester]methylaminomethyl-4′-methyl-2,2′-bipyridine (1:2 molar ratio) in methanol can be refluxed for 2 days to give a dark orange-brown solution. This can be pumped dry to a dark brown solid. Chromatography can be carried out by gradient elution using acetonitrile:methanol. The blue and pink-purple bands can be discarded and the third orange band collected. It can be pumped dry to a dark orange-brown powder. Yield 90%. Identity of products verified by 1H and ¹³C NMR spectra and GC-MS.

2. Typical Synthesis of a Benzophenoxazinone Boronate

As an illustrative molecular assembly of another typical compound for use in glucose recognition, the synthesis of 6-chloro-5H-benzo[a]phenoxazin-5-one boronate is shown below. This strategy involves the synergistic integration of three main components: a fluorophore, a selective glucose binding unit, and a transducer. The benzo[a]phenoxazin-5-one ring system can be incorporated as the fluorophore because it possess many desirable characteristics including high quantum yields, excitation maxima accessible to simple light sources, chemical and photochemical stability. For the glucose binding unit, an aromatic boronic acid group can be employed since it has been shown that they have selective recognition for saccharides. These two main components are attached via a methylene amine tether. In this case, the amine serves not only as a linker but is an integral part of the glucose sensing design. The target sensor molecule, 6-chloro-5H-benzo[a]phenoxazin-5-one boronate, is based on fluorescent signaling via photoinduced electron transfer. The PET process in this unique system is modulated by interaction of boronic acid and amine.

Synthesis Summary

The target molecule for glucose recognition is abbreviated as COB (Chloro-Oxazine Boronate) and is shown below as benzophenoxazinone. COB can be constructed by coupling benzophenoxazinone with phenyl boronate in a methylene amine linkage. Benzophenoxazinone can be synthesized by condensation of 3-amino-4-hydroxybenzyl alcohol with 2,3-dichloro-1,4-napthoquinone. The preparation of amino alcohol requires successive reductions from commercially available 4-hydroxy-3-nitrobenzoic acid. Reduction of benzoic acid with borane-THF complex in tetrahydrofuran gives 4-hydroxy-3-nitrobenzyl alcohol in 90% yield. Subsequent reduction of nitro-alcohol with sodium borohydride and 10% Pd/C catalyst in water provided 3-amino-4-hydroxybenzyl alcohol in 97% yield. The reductions can be followed by ring forming condensation of 3-amino-4-hydroxybenzyl alcohol with 2,3-dichloro-1,4-naphthoquinone. The reaction can be performed in a methanol/benzene solvent mixture using potassium acetate at room temperature. The condensation requires dropwise addition of a suspension of amino alcohol and potassium acetate in methanol to a slurry of quinone in benzene resulting in 6-chloro-10-(hydroxymethyl)-5H-benzo[a]phenoxazin-5-one 5 in 30% yield. Initially, the condensation can be investigated using methanol and potassium hydroxide. After ring condensation, benzophenoxazinone can be then converted to the benzophenoxazinone bromide using phosphorous tribromide in an ether/toluene solvent mixture at room temperature.

The preparation of the benzophenoxazinone coupling partner, aminophenyl boronate requires protection of o-tolylboronic acid with neopentyl glycol to give the corresponding o-tolylboronic ester in 99% yield. Boronic ester can be functionalized by free radical bromination using N-bromosuccinimide in carbon tetrachloride and AIBN as the initiator. The reaction conditions required heating, as well as, irradiation with a light source to give bromomethylphenyl boronate in 97% yield. Subsequently, amino boronate derivative can be synthesized by bubbling methylamine through a etheral solution of phenyl boronate. Methylaminophenyl boronate can be isolated cleanly in 99% yield.

For completion of the COB synthesis, coupling of the aminophenyl boronate and benzophenoxazine can be preformed in refluxing tetrahydrofuran using potassium carbonate for four days. The target benzophenoxazine can be purified by chromatography and isolated as solid in 61% yield.

3. Typical Synthesis of Naphthalimide Fluorophores

The Naphthalimide derivatives studied in this project can be prepared by the routes known in the art. These procedures are analogous to those previously reported for Naphthalimide dye molecules, with some distinctions (see e.g. Alexiou et al., J. Chem. Soc., Perkin Trans. 1990, 837; de Silva et al., Angew. Chem. Int. Ed. Engl. 1995, 34, 1728; Kavarnos, G. J. Fundamentals of Photoinduced Electron Transfer, VCH: New York, 1993; pp 37-40. and Daffy et al. Chem. Eur. J. 1998, 4, 1810). The naphthalimide framework has been shown to exhibit a wide range of spectral properties, depending on the alkyl groups appended to the imide nitrogen and the 4-position. Most work to date has used an n-butyl group off the imide nitrogen (e.g. 1ax)., generally giving rise to high quantum yields than shorter or unsaturated side chains. In order to covalently link these molecules to polymer matrices, we have also prepared derivatives based on a 5-pentanol linker starting with the preparation of 1bx. To enable further functionalization of these dye molecules, it can be necessary to protect the pendant alcohol as the tetrahydropyranyl (THP) ether.

Substitution of the 4-chloro group by either N-methylethylene diamine or N,N′-ditnethylethylene diamine gave the desired compounds 2ay, 2cy, 2az, and 2cz in good yields. The reaction involving the unsymmetric N-methylethylene diamine gave exclusively substitution at the primary amine end of the ethylenediamine species. It has been shown that the quantum yields for dyes based on secondary naphthylamines are substantially higher that those observed for tertiary amines; however, it can be believed that further functionalization might be simplified on the tertiary compounds. Thus, both sets of compounds can be prepared for examination by fluorescence spectroscopy.

Work by de Silva has shown the utility of similar compounds as fluorescent transducers for pH. Based on our previous work, and that of Shinkai (see e.g. James et al., J. Am. Chem. Soc. 1995, 117, 8982), we have appended a benzyl boronate group from the terminal amine group to give compounds 3ay, 3cy, 3az, and 3cz in good yields. The spectroscopy of these compounds is discussed below. In order to enable the attachment of this system to polymers, deprotection of the pendant THP ether gave the free alcohol, which is suitable for conversion to a number of other functional groups. Preparation of the amine derivative is in progress.

Summarized Syntheses

As the syntheses are described as a series of analogous compounds with general procedures are given below. Cyclic voltammetry can be conducted using a glassy carbon working electrode, platinum counter electrode, and Ag/AgCl reference electrode and carried out in a 0.1 M solution of NBᵤ₄ClO₄ in acetonitrile. Samples for fluorescence can be prepared as 1.00 mM stock solutions in MeOH. A 30.0 μL aliquot of solution can be then added to 3.000 mL of the appropriate solvent mixture (a combination of methanol and phosphate buffered saline-PBS). Relative quantum yields can be determined by the relative output of equimolar solutions of two compounds using 3ay as a reference. Glucose additions can be performed by the addition of a concentrated solution of glucose in PBS to a stirred solution of the fluorescent molecule in methanol/PBS.

1ax, 1bx. A equimolar mixture of 4-chloro-1,8-naphthalic anhydride and either n-butylamine or 5-aminopentanol in ethanol can be heated at reflux for 20 hours. The dark brown solution can be filtered and cooled to −10° C. A pure, tan powder can be collected by filtration (90% yield). The identities of the pure products can be confirmed by ¹H and ¹³C{¹H} NMR spectroscopy, as well as ESI/MS (electrospray ionization mass spectrometry).

1cx. A mixture of 1bx and catalytic (10 mol %) poly(4-vinylpyridinium hydrochloride) can be heated at reflux in neat 3,4-dihydro-2H-pyran for over 16 hours. The reaction can be cooled and the polymer removed by filtration. Removal of solvent under vacuum gave the product as an orange colored oil, which can be purified by chromatography on silica gel with chloroform as eluent. The product can be collected as a pure orange oil in quantitative yield. The identity of the pure product can be confirmed by ¹H and ¹³C{¹H} NMR spectroscopy, as well as ESI/MS.

2ay, 2cy, 2az, 2cz. Excess N,N′-dimethylethylenediamine or N′-methylethylenediamine can be added to a solution of either 1ax or 1cx, followed by the addition of one equivalent of triethylamine. This solution can be heated at reflux for 4 hours in 2-methoxyethanol to give a dark brown-orange solution. The reaction can be cooled, water added, and the product extracted with dichloromethane. Drying with magnesium sulfate, followed by solvent removal, gave the crude product as an orange oil. Purification of 2az can be achieved by recrystallization from hot methanol; the other compounds can be purified by chromatography on silica with a methanol/chloroform gradient. The products can be obtained as yellow powders or orange oils in 60-70% yield. The identities of the pure products can be confirmed by ¹H and ¹³C{¹H} NMR spectroscopy, as well as ESI/MS.

2ay, 2cy, 2az, 2cz. Excess N,N′-dimethylethylenediamine or N′-methylethylenediamine can be added to a solution of either 1ax or 1cx, followed by the addition of one equivalent of triethylamine. This solution can be heated at reflux for 4 hours in 2-methoxyethanol to give a dark brown-orange solution. The reaction can be cooled, water added, and the product extracted with dichloromethane. Drying with magnesium sulfate, followed by solvent removal, gave the crude product as an orange oil. Purification of 2az can be achieved by recrystallization from hot methanol; the other compounds can be purified by chromatography on silica with a methanol/chloroform gradient. The products can be obtained as yellow powders or orange oils in 60-70% yield. The identities of the pure products can be confirmed by 1H and ¹³C{¹H} NMR spectroscopy, as well as ESI/MS. 3ay, 3cy, 3az, 3cz. One equivalent of 2,2-dimethylpropane-1,3-diyl[o-(bromomethyl)phenyl]boronate in THF can be added dropwise to an equimolar solution of 2ay, 2cy, 2az, or 2cz and triethylamine in THF. After stirring 2 hours, the solvent can be removed and the crude oil purified by chromatography on silica with a methanol/ammonium hydroxide gradient. The products can be collected in 60-80% yield as yellow powders. The identities of the pure products can be confirmed by ¹H and ¹³C{¹H} NMR spectroscopy, as well as ESI/MS.

III. Illustrative Embodiments of the Invention

As disclosed herein, the methods, sensors and sensor systems of the invention comprise a number of embodiments. A number of exemplary embodiments are discussed below. The skilled artisan understands that a number of the specific embodiments discussed in the context of one or more methods, sensors and sensor systems of the invention also apply to related methods, sensors and sensor systems of the invention and that it is unnecessarily redundant to repeat every specific embodiment when describing various methods, sensors and sensor systems of the invention.

One typical embodiment of the invention consists of a method of using a population of fluorescent sensor molecules (FS) to measure the concentration of a polyhydroxylate analyte (A) in a solution, wherein the population of arylboronic fluorescent sensor molecules are present in species that are not bound to the polyhydroxylate analyte (FS) and species that are bound to the polyhydroxylate analyte (FSA). In this method, the concentration of a polyhydroxylate analyte is measured by determining the relative fluorescence contribution that the FS and the FSA species make to the total fluorescence of the solution, then using the relative fluorescence contribution values of AFS and AFSA so determined to calculate the relative abundances of FS and FSA in the solution; and then correlating the relative abundances of FS and FSA in the solution so calculated with the concentration of the polyhydroxylate analyte.

In specific embodiments of these methods of the invention, the total fluorescence of the solution is determined by the measuring the average fluorescent lifetime of the population of arylboronic fluorescent sensor molecules in the solution in the presence and absence of the polyhydroxylate analyte. In preferred methods of the invention, the fluorescent lifetimes of the species are calculated using a method selected from the group consisting of time-resolved fluorometry and phase-modulation fluorometry. Typically, the relative fluorescent contribution of the FS species and the FSA species is a function of the quantum yield of each species, the fluorescent lifetime of each species and/or decay rate for each species. In preferred embodiments of the invention, the relative contribution of the AFS species to the total fluorescence corresponds to the population of arylboronic fluorescent sensor molecules undergoing intramolecular photo-induced electron transfer.

In preferred embodiments of the invention, the fluorescent sensor molecule comprises a COB fluorophore or derivatives thereof, a NIB fluorophore or derivatives thereof or a compound of the formula:

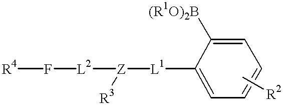

wherein:

F is a fluorophore with selected molecular properties;

R¹ is selected from the group consisting of hydrogen, lower aliphatic and aromatic functional groups;

R² and R⁴ are optional functional groups selected from the group consisting of hydrogen, lower aliphatic and aromatic functional groups and groups that form covalent bonds to a biocompatible matrix;

L¹ and L² are optional linking groups having from zero to four atoms selected from the group consisting of nitrogen, carbon, oxygen, sulfur and phosphorous;

Z is a heteroatom selected from the group consisting of nitrogen, phosphorous, sulfur, and oxygen;

R³ is an optional group selected from the group consisting of hydrogen, lower aliphatic and aromatic functional groups and groups that form covalent bonds to a biocompatible matrix; and

wherein F and Z are involved in a photo-induced electron transfer process that quenches the intrinsic fluorescence of F in the absence of the polyhydroxylate analyte.

Typically, the arylboronic fluorescent sensor molecules comprise an amine moiety with a pKa of less than about 7.4 and preferably about 2.0 to about 7.0. In preferred embodiments of the invention, F is selected from the group consisting of coumarins, oxazines, xanthenes, cyanines, metal complexes and polyaromatic hydrocarbons. In highly preferred embodiments of the invention, the arylboronic fluorescent sensor molecule has an excitation wavelength of greater than about 400 nm, and preferably between about 400 nm to about 600 nim. In other preferred embodiments of the invention, the arylboronic fluorescent sensor molecule has an emission wavelength of greater than about 500 nm, preferably between about 500 nm to about 800 nm.

Another embodiment of the invention consists of a method of optically sensing the presence of a polyhydroxylate analyte in a sample by placing a fluorescent sensor molecule (FS) in contact with the sample, wherein the fluorescent sensor molecule reversibly binds to the polyhydroxylate analyte and has a first fluorescence lifetime corresponding to the fluorescent sensor molecule bound to the polyhydroxylate analyte FSA) and a second fluorescence lifetime corresponding to the fluorescent sensor molecule not bound to the polyhydroxylate analyte, and wherein the fluorescence lifetimes of FSA and FS contribute relatively to a detectable fluorescence lifetime for the sample. This method consists of exposing a population of the fluorescent sensor molecules to the sample, exciting the fluorescent sensor molecules in the sample with radiation, detecting a resulting emission beam emanating from the fluorescent sensor molecules in the sample, wherein the emission beam varies with the concentration of the polyhydroxylate analyte; and then correlating the resulting emission beam to the presence of the polyhydroxylate analyte in the sample, so that the concentration of the polyhydroxylate in the sample is determined. In such methods, the relative contribution of FS and FSA to the total fluorescence typically approximately equals unity. In one embodiment of this method, the fluorescent sensor molecule has more than one fluorescence lifetime in the absence of the polyhydroxylate analyte and at least one lifetime of the fluorescent sensor molecule corresponds to a population of fluorescent sensor molecules undergoing photo-induced electron transfer. A specific embodiment of this method consists of detecting the relative contribution of FS or FSA to the total fluorescence and then calculating the relative contribution to the total fluorescence of the species that is not directly detected.

Yet another embodiment of the invention consists of a method of optically sensing the presence of a polyhydroxylate analyte by placing a population of fluorescent sensor moieties in communication with body fluids of a person, wherein the fluorescent sensor moieties reversibly bind a polyhydroxylate analyte such as glucose. In this embodiment of the invention, the fluorescent sensor moieties have a first fluorescence lifetime corresponding to the fluorescent sensing moieties bound to the polyhydroxylate analyte (FSMA) and a second fluorescence lifetime corresponding to the fluorescent sensor moieties not bound to the polyhydroxylate analyte (FSM), and the fluorescence lifetimes of FSMA and FSM relatively contribute to a detectable fluorescent lifetime of the fluorescent sensor moieties in communication with the body fluids of a person. This method preferably consists of the steps of exciting the fluorescent sensor moieties in communication with the body fluids of a person with radiation, detecting a resulting emission beam emanating from the fluorescent sensor moieties in the sample, wherein the emission beam varies with the concentration of the polyhydroxylate analyte in the body fluids of the person and correlating the resulting emission beam to the presence of the polyhydroxylate analyte (such that the concentration of the polyhydroxylate in the body fluids of the person is determined).

In the methods of optically sensing the presence of a polyhydroxylate analyte in a sample, exciting the sample with radiation typically comprises illuminating the sample with one or more of the following optical light sources: an incandescent lamp, an electroluminescent light, an ion laser, a dye laser, an LED, or a laser diode. In one embodiment of this method, the optical light source is pulsed or modulated. In preferred methods of the invention, the fluorescent lifetimes are calculated using a method selected from the group consisting of time-resolved fluorometry and phase-modulation fluorometry.

Yet another embodiment of the invention consists of a polyhydroxylate analyte sensor comprising an arylboronic fluorescent sensor molecule that senses the concentration of the polyhydroxylate analyte with an accuracy of at least +/−10% over a physiologically relevant range of the polyhydroxylate analyte, wherein the accuracy of the arylboronic fluorescent sensor molecule to sense the polyhydroxylate analyte over a physiologically relevant is related to the difference in fluorescence lifetimes of the arylboronic fluorescent sensor molecule in the presence and absence of the polyhydroxylate analyte, and/or the duration of the fluorescence lifetime of the arylboronic fluorescent sensor molecule. In highly preferred embodiments of the invention, the accuracy the polyhydroxylate analyte sensor is approximately +/−5% for polyhydroxylate analyte concentrations of about 20 mg/dL to about 500 mg/dL. With such polyhydroxylate analyte sensors, the arylboronic fluorescent sensor molecule typically has at least two fluorescence lifetimes in the absence of the analyte with at least one lifetime corresponding to a population of arylboronic fluorescent sensor molecules undergoing photo-induced electron transfer. In one preferred embodiment, the arylboronic fluorescent sensor molecule has at least two lifetimes which correspond to a species where the polyhydroxylate analyte is bound to the arylboronic fluorescent sensing molecule and a species where the polyhydtoxylate analyte is not bound to the arylboronic fluorescent sensing molecule.

In preferred embodiments of the polyhydroxylate analyte sensors, the accuracy of a arylboronic sensor molecule is increased by increasing the fluorescence lifetime of the arylboronic fluorescent sensor molecule bound to the polyhydroxylate analyte, decreasing the lifetime of the arylboronic fluorescent sensor molecule not bound to the polyhydroxylate analyte, or increasing, by approximately the same factor, both the fluorescence lifetime of the arylboronic fluorescent sensor molecule bound to the polyhydroxylate analyte and the fluorescence lifetime of the arylboronic fluorescent sensor molecule not bound to polyhydroxylate analyte. In these embodiments, the polyhydroxylate analyte sensor is typically illuminated with one or more of the following optical light sources: an incandescent lamp, an electroluminescent light, a ion laser, a dye laser, an LED, or a laser diode. As noted above, these optical light sources can be pulsed or modulated. In preferred embodiments of the polyhydroxylate analyte sensors of the invention, the sensor further comprises a biocompatible matrix and is provided to a person by implantation, preferably by injection. Alternatively, the sensor is provided to a person by insertion of a fiber optic comprising fluorescent sensor molecules on the inserted terminus of the fiber optic.

Yet another embodiment of the invention consists of a polyhydroxylate analyte sensor system comprising a fluorescent sensor molecule in communication with a fluid comprising polyhydroxylate analyte, (FS), the fluorescent sensor molecule comprising a first fluorescence lifetime corresponding to the fluorescent sensor molecule bound to the polyhydroxylate analyte FSA) and a second fluorescence lifetime corresponding to the fluorescent sensor molecule not bound to the polyhydroxylate analyte, wherein FS reversibly binds to the polyhydroxylate analyte and the fluorescence lifetimes of FSA and FS contribute to a measurable fluorescence lifetime that varies with the presence of the polyhydroxylate analyte in the fluid. This embodiment consists of a light source for exciting the fluorescent sensor molecule and a detector for detecting an emission signal from the fluorescent sensor molecule, wherein a change in emission signal correlates to a change in the average fluorescence lifetime of the fluorescent sensor molecule in communication with the fluid, and wherein the average fluorescence lifetime of the fluorescent sensor molecule in communication with the fluid correlates to the concentration of the polyhydroxylate analyte in the fluid. In preferred embodiments, the methodological steps discussed above and/or the sensors and sensor systems further comprise a correlator that calculates the emission signal from the fluorescent sensor molecule in communication with the fluid with the polyhydroxylate analyte concentrations in the fluid (typically the body fluids of a person). In one embodiment of the invention, the polyhydroxylate analyte sensor system contains a detector which detects emission signals over time intervals to yield a polyhydroxylate analyte (e.g. glucose) profile for the person. In yet another embodiment of the invention, he polyhydroxylate analyte sensor system described above contains a fluorescent sensor molecule locally binds to the person's cells following injection, preferably due to the presence of one or more cell surface binding moieties.

The present invention is further detailed in the following Examples, which are offered by way of illustration and are not intended to limit the invention in any manner. All patent and literature references cited in the present specification are hereby incorporated by reference in their entireties

### EXAMPLES

The detailed protocols given below are not to be construed as necessary to the methods, sensors and sensor systems of the present invention. Sample preparation, instrumentation, materials etc. are given only as examples of how to carry out the invention.

### Example 1

Typical Instrumentation of the Invention

Instrumentation

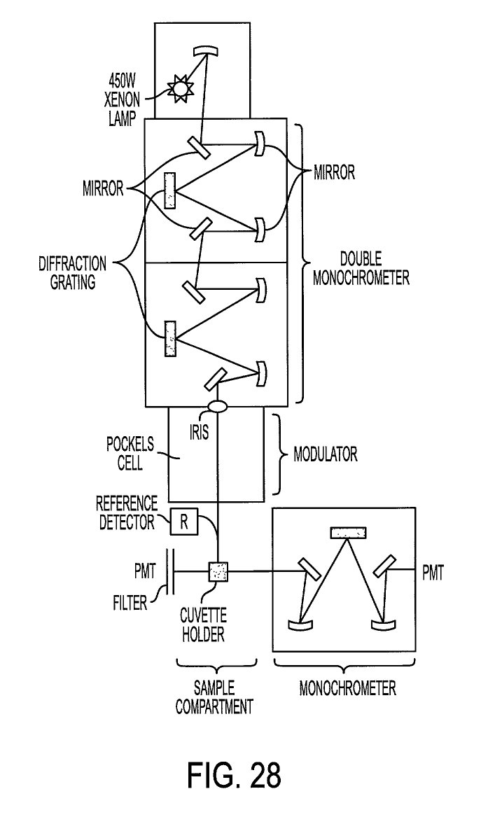

Steady state fluorescence and fluorescence lifetime measurements are performed with the same instrument. A Fluorolog-Tau-3-21 (Jobin Yvon Horiba, formerly SPEX, Instruments S.A., Inc.), fluorescence spectrometer was used with a double monochrometer in the excitation path, a single monochrometer in the emission path, and a Pockels cell to modulate the excitation intensity for lifetime measurements as shown in FIG. 28.

The Xe lamp spectrum ranges from 250 nm to 900 nm. The double monochrometer has two 1200 groove/mm gratings blazed for optimal transmission at 330 nm. A reference photodiode detector, R, measures the intensity of the excitation light just before it enters the sample compartment. The sample compartment holds standard 1 cm×1 cm×3 cm cuvettes and is connected to the temperature bath to regulate the sample temperature. The emission monochrometer has one 1200 groove/mm grating blazed at 500 nm. Hamamatsu (model R928P) photomultiplier tubes (PMTs) are used for photon detection.

Fluorescence excitation spectra were acquired by varying the excitation wavelength while measuring the fluorescence at a single emission wavelength. Emission spectra were taken using a constant excitation wavelength and varying the detected fluorescence wavelength. Single excitation and emission wavelengths were used to optimize the fluorescence output. The fluorescence signal is corrected for lamp fluctuations by dividing the measured signal by the signal from the reference detector. This also eliminates errors made by non-uniform reflections in the excitation monochrometer. Corrections for errors due to non-uniform reflection by the gratings in the emission monochrometer, as well as variations in detector sensitivity as a function of wavelength, were not made because they were negligible for the range of wavelengths used. Excitation and emission wavelengths are listed in Table E.1 below along with the band pass of the slits in the excitation and emission monochrometers. Band pass was chosen so that the fluorescent signal was at a maximum while remaining in the linear range of the detector.

TABLE E.1

| | | | Slit Band Pass |
|---|---|---|---|
| Compound | Excitation (nm) | Emission (nm) | (nm) |
| AB | 369 | 418 | 1.5 |
| COB | 440 | 545 | 3 |
| NIB | 425 | 548 | 3 (Ex); 4 (Em) |

Table E.1 shows the excitation and emission wavelengths used for steady state fluorescence measurements. Slit band pass settings were the same for both excitation and emission scans, except where noted. The total emission intensity was measured by integrating over the entire wavelength range of emission using the integration function in DataMax, the software package used to control the Fluorolog. Since all of the parameters were kept constant for each molecule, the relative intensity of each sample was obtained using the integrated area under the emission spectrum. Phosphorescence was not observed in any of the samples.

### Example 2

Typical Lifetime Measurements of the Invention

Lifetime Measurements

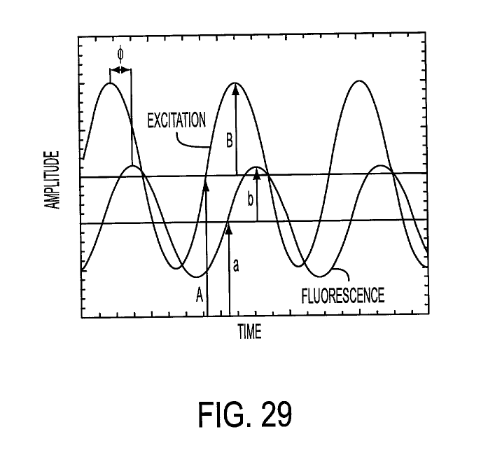

Measurements of fluorescence lifetimes were done in the frequency domain. This is also known as the phase-modulation technique. Instead of using a short pulse of light to excite fluorescence, as is commonly done, the sample is excited by a continuous beam of light with sinusoidally modulated intensity. The resultant fluorescence is also sinusoidally modulated, but reduced in intensity and with a phase lagging that of the incident light. This phase lag, as well as the ratio of demodulation, is a measure of the fluorescence lifetime. FIG. 29 shows the relationship between sinusoidally modulated excitation light of form

I(t)=A+B sin(ωt)

where A and B are constants describing the DC offset and modulation amplitude of the light, and ω=2πf where f is the frequency of modulation in Hz and the resulting fluorescence light is of the form

F(t)=a+b sin(ωt−φ)

where a and b are constants similar to A and B, and φ the phase difference.

When making fluorescence lifetime measurements the light modulator is placed in the path of the excitation light. When the applied voltage is modulated, the resulting intensity of the light passing through the Pockels cell is also modulated. The frequency of modulation can range from 0.1 to 310 MHz. To detect the modulated light, the PMTs (photomultiplier tubes) are also modulated. By modulating the detectors at a frequency slightly (˜12 kHz) different from the frequency of the incident and fluorescent light, a beat frequency is created which contains the desired phase and modulation information. This method of cross-correlation detection simplifies phase determinations since they are performed at much lower frequencies than the excitation modulation rate.

A reference fluorophore with a known lifetime is used to minimize instrumental errors. For AB the reference fluorophore was POPOP. POPOP in methanol has a known lifetime of 1.32 nsec. The lifetime of POPOP was found to remain stable at temperatures ranging from 20° to 40° C. Reference fluorophores must have excitation and emission wavelengths similar to the fluorophore of interest. When such a fluorophore is not available, a scattering solution can be used as a reference. For the long-wavelength fluorescent sensor molecules such as COB and NIB, glycogen was used as the reference compound. Glycogen is a polysaccharide with a large, but very compact structure ideal for scattering light in solution. It does not fluoresce in the wavelength range used in these experiments, and therefore, can be used as a scatterer with a lifetime of zero. Glycogen was also used to verify the 1.32 nsec lifetime of POPOP. A Schott KV399 filter was used to eliminate the excitation light and collect all emission above 399 nm for lifetime measurements.

### Example 3

Typical Sample Preparation of the Invention

Sample Preparation

All of the fluorescent sensor molecule were synthesized as described above. Stock solutions of the fluorescent sensor molecules were prepared in MeOH. The MeOH (99.9%) was obtained from Aldrich. Buffer solutions were made for pH 2 through 13. This phosphate buffered saline (PBS) which includes 0.138 M NaCl and 0.0027 M KCl, was prepared according to directions at 0.01 M and was measured to have a pH value of 7.4 at 25° C. The D-(+)-Glucose (99.5%) was obtained from Sigma (EEC# 50-99-7) and was prepared at concentrations of 300 g/L in water.

Samples for all fluorescence measurements were made in standard 3 mL quartz cuvettes from either Stama Cells or NSG Precision Cells, Inc. Fluorescent sensor molecule concentrations were kept in the micromolar range to avoid excimer formation and self-absorption influencing the lifetime measurements.

A reference fluorophore with a known lifetime is used to minimize instrumental errors. In this regard, glycogen and POPOP were used as reference fluorophores. Glycogen was used with COB and NIB and POPOP was used with AB. Reference fluorophores are chosen for excitation and emission wavelengths similar to the fluorophore of interest. When such a fluorophore is not available, a scattering solution can be used as a reference. Thus, for the longer wavelengths fluorophores, i.e., COB and NIB, glycogen was used as the fluorophore. A Schott KV399 filter was used to eliminate the excitation light and collect all emission above 399 nm for lifetime measurements.

The glycogen was obtained from Sigma (G-8751), type II from oyster, EEC#232-683-8. The POPOP (1,4-bis(5-Phenyl-2-oxazolyl)benzene) was a laser grade fluorophore obtained from Exciton. The ACN (99%) was obtained from Aldrich, EEC#200-835-2, and the TBAP was from Sigma, EEC#217-655-5. Bubbling N₂ gas into solution is a common method for eliminating the free O₂ that can quench the fluorescence through collisions. Unless otherwise stated, degassing of the samples by N₂ prior to taking a measurement was determined to have no significant effect on the fluorescence. All samples were held at 25° C. using a Neslab temperature bath, model RTE-111.

### Example 4

Typical Frequency Domain Equations of the Invention

Frequency Domain Equations

In this example, consideration is given to a light source with a sinusoidally modulated amplitude of the form

I(t)=a+b sin ωt 1

where ω is the frequency of amplitude modulation. For an impulse (δ(t)) excitation the fluorescence decays exponentially in time as

f(t)=f₀e^{-t/τ} 2

where τ is the lifetime of the excited state. Therefore, with sinusoidal excitation the fluorescence intensity is the correlation of Equations 1 and 2.

$$\begin{matrix}F ( t ) = {\int }_{0}^{t} I ( {t}^{′} ) f ( t - {t}^{′} ) ⅆ {t}^{′} \\ = {\int }_{0}^{t} ( a + b sin ω {t}^{′} ) ( {f}_{0} {ⅇ}^{- ( t - {t}^{′} ) / τ} ) ⅆ {t}^{′} \\ = {af}_{0} {\int }_{0}^{t} {ⅇ}^{- ( t - {t}^{′} ) / τ} ⅆ {t}^{′} + {bf}_{0} {\int }_{0}^{t} ( sin ω {t}^{′} ) {ⅇ}^{- ( t - {t}^{′} ) / τ} ⅆ {t}^{′}\end{matrix} \qquad 3$$

Integrating Equation 3 using

$$\int {ⅇ}^{A x} sin ( Bx ) ⅆ x = {ⅇ}^{Ax} \frac{[ A sin ( Bx ) - B cos ( Bx ) ]}{{A}^{2} + {B}^{2}} \qquad 4$$

results in the following equation for F(t).

$$\begin{matrix}F ( t ) = {af}_{0} {{ⅇ}^{- t / τ} [ {τⅇ}^{{t}^{′} / τ} ]}_{0}^{t} + {bf}_{0} {{ⅇ}^{- t / τ} [ \frac{τ {ⅇ}^{{t}^{′} / τ} ( sin ω {t}^{′} - ω τ cos ω {t}^{′} )}{1 + {ω}^{2} {τ}^{2}} ]}_{0}^{t} \\ = {af}_{0} τ - {af}_{0} τ {ⅇ}^{- t / τ} + \frac{{bf}_{0} τ ( sin ω t - ωτ cos ω t )}{1 + {ω}^{2} {τ}^{2}} + \frac{{bf}_{0} {ωτ}^{2} {ⅇ}^{- t / τ}}{1 + {ω}^{2} {τ}^{2}}\end{matrix} \qquad 5$$

Since the measurements are taken over times much greater than the average fluorescent lifetime (t>>τ), the transient terms go to zero.

$$F ( t >> τ ) = {af}_{0} τ + \frac{{bf}_{0} τ ( sin ω t - ωτ cos ω t )}{1 + {ω}^{2} {τ}^{2}} \qquad 6$$

Assuming the fluorescence is of the form

F(t)=A+B sin(ωt−φ) 7

use of the trigonometric relation

sin(ωt−φ)=sin ωt cos φ−cos ωt sin φ 8

allows for a direct comparison between Equations 6 and 7. This yields expressions for the DC and AC amplitudes, A and B.

A=af₀τ 9

$$B = \frac{{b}_{{f}_{0} τ}}{\sqrt{1 + {ω}^{2} {τ}^{2}}} \qquad 10$$

B is chosen with the square root such that

$$cos φ = \frac{1}{\sqrt{1 + {ω}^{2} {τ}^{2}}} and sin φ = \frac{ω τ}{\sqrt{1 + {ω}^{2} {τ}^{2}}} \qquad 11$$

These equations are well behaved in the limit of large ω, with cos φ→0 and sin φ→1, or in other words, φ→90°. Note that if B had been chosen equal to bf₀τ, both cos φ and sin φ go to zero at large ω.

Using the canonical definition for m, the modulation factor, the standard equations for the phase and modulation of a single exponential lifetime can be written using Equations 9 and 10.

$$m ≡ \frac{B / A}{b / a} = \frac{1}{\sqrt{1 + {ω}^{2} {τ}^{2}}} \qquad 12$$

tan φ=ωτ 13

### Example 5

Typical Error Analysis of Frequency Domain Measurements

Error Analysis of Frequency Domain Measurements

Unlike error analysis in the time domain, the error of the fluorescence lifetimes measured in the frequency domain is not a simple function of the number of photons counted over time. The Globals Unlimited (GU) software program from the University of Illinois was used to calculate the error in the fluorescence lifetime measurements. GU employs three different methods for determining the errors. The first method uses the curvature matrix to estimate the error. This method was chosen for these experiments because it was typically the largest of the three errors. The second method fixes all of the variable parameters except one, which it varies until the x value increases by a certain percentage (typically 67%). The third method holds one parameter fixed while varying all others until the χ² value is minimized. This feature is useful for determining whether the fit has reached a global or a local minimum because the χ² values are plotted as a function of each fixed parameter in what is referred to as chi-squared plots (see Example 6 below).

As discussed above, the equation for χ² is given by

$${χ}^{2} = {\sum }_{i = 1}^{n} \frac{{data}_{i} - {fit}_{i}^{2}}{{σ}_{i}^{2} N - m - 1}$$

where σᵢ is the standard deviation for each data point measured, N is the total number of data points, and m is number of fitting parameters. Experimental data points are represented as dataᵢ and values from the exponential fits are represented as fitᵢ. The least-squares fit is obtained by using a method developed by Marquardt and Levenberg. The user inputs an initial guess of the variable parameters (fᵢ and τᵢ) in the exponential equation describing the observed average lifetime,

$$⟨ τ ⟩ = {\sum }_{i} {f}_{i} {τ}_{i}$$

described by the initial parameter vector, P⁰. Iterations (s) are performed varying the parameter improvement vector (δ) until a minimum χ² value is found.

P¹=P⁰+δ⁰

$$\begin{matrix}{P}^{1} = {P}^{0} + {δ}^{0} \\ {P}^{2} = {P}^{1} + {δ}^{1} \\ ⋮ \\ {P}^{s + 1} = {P}^{s} + {δ}^{s}\end{matrix}$$

The vector δ is found by solving the matrix equation

Cδ−B

where C is the curvature matrix

$${C}_{jk} = {\sum }_{q = 1}^{{n}_{e x p}} {\sum }_{i = 1}^{n ( q )} \frac{1}{{σ}_{qi}^{2}} \frac{\partial {fit}_{qi}}{\partial {param}_{j}} \frac{\partial {fit}_{qi}}{\partial {param}_{k}} + λ I$$

and B is given by

where paramⱼ and paramₖ are fitting parameters, λ is a scaling factor, I is the identity matrix, and the other symbols are as in equation B-1. The error matrix is found by inverting C.

E=C⁻¹

The diagonal elements of E are equal to the square of the error for that parameter.

Five data trials (taken consecutively) from AB at pH 7.4 were analyzed using GU, without linking any parameters together. The following error values were obtained from the curvature matrix analysis.

TABLE E5.1
Results of GU analysis on individual trials with
Ab in pH 7.4 methanol and PBS (1:1 by volume)

| | | | | Error in | | Error | | Error | | Error | |
|---|---|---|---|---|---|---|---|---|---|---|---|
| File # | f₁ | f₂ | f₃ | f₁, f₂, f₃ | τ₁ | in τ₁ | τ₂ | in τ₂ | τ₃ | in τ₃ | χ² |
| 1 | 0.526 | 0.424 | 0.050 | 0.021 | 11.559 | 0.261 | 3.498 | 0.264 | 0.875 | 0.347 | 0.863 |
| 2 | 0.536 | 0.423 | 0.041 | 0.025 | 11.571 | 0.303 | 3.262 | 0.310 | 1.019 | 0.490 | 1.000 |
| 3 | 0.589 | 0.392 | 0.019 | 0.011 | 10.755 | 0.119 | 2.897 | 0.099 | 0.265 | 0.358 | 1.675 |
| 4 | 0.523 | 0.407 | 0.070 | 0.043 | 11.514 | 0.45 | 3.593 | 0.551 | 1.137 | 0.393 | 1.008 |
| 5 | 0.545 | 0.404 | 0.051 | 0.024 | 11.243 | 0.287 | 3.408 | 0.265 | 0.736 | 0.243 | 0.835 |

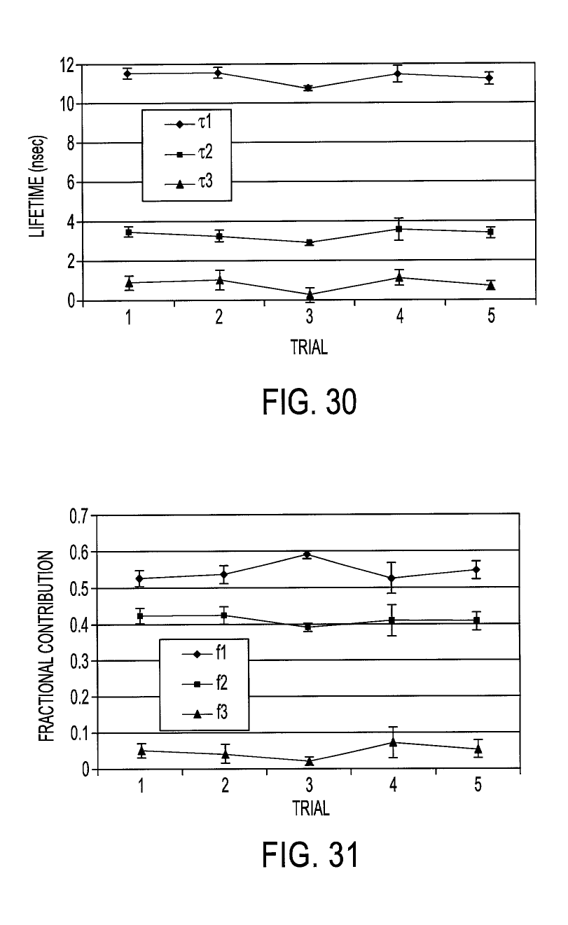

The lifetime values and fractional contributions are plotted with the individual errors in FIG. 30 and FIG. 31.

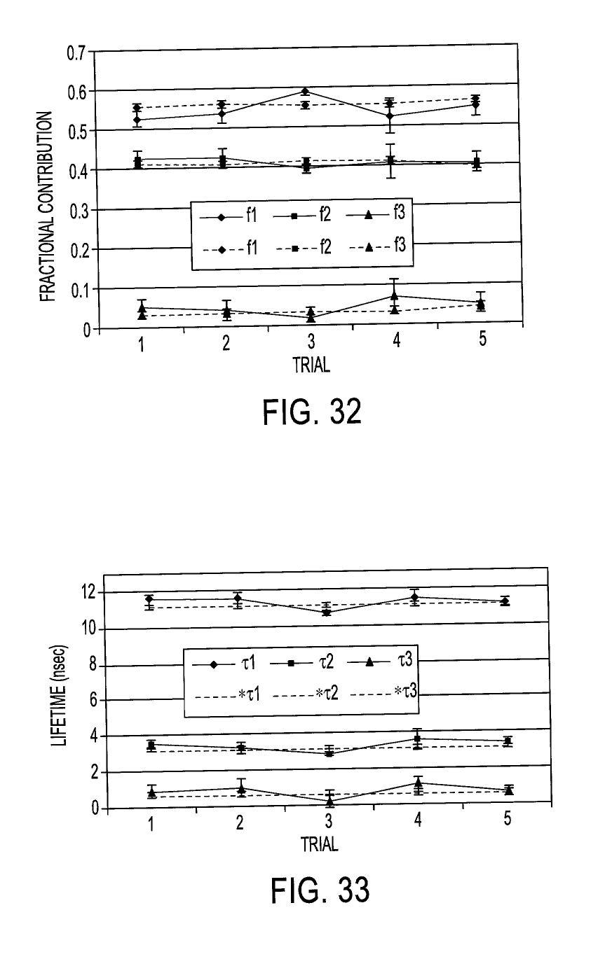

The five trials were performed in succession on a solution in steady state, and therefore the lifetime values can be linked together. This reduces the number of free variables and increases the total number of measurements at each modulation frequency, thereby reducing the error. The calculated error in the fractional contributions is reduced from an average of 0.025 to 0.009 when the five trials are linked together, yet the values remain approximately the same. FIG. 32 show a comparison of fractional contributions and errors determined with (dashed lines) and without (solid lines) linking trials. The lifetime values and corresponding errors are shown in FIG. 33 along with the values and errors found without linking the lifetimes together.

As seen in FIG. 32 and FIG. 33, the effect of linking the lifetime values is essentially to reduce the statistical fluctuations in the fractional contributions. The standard deviation between individual (unlinked) trials was also used to estimate the error in certain cases where the error from Globals Unlimited was smaller than expected, or the number of measurements exceeded the capacity for Globals to analyze all of the data together. In these cases the error was usually slightly larger, and is more representative of the error in the sample stability rather then the error in the measurement.

### Example 6

Typical Data Analyses of the Invention

Examples of Data Analyses

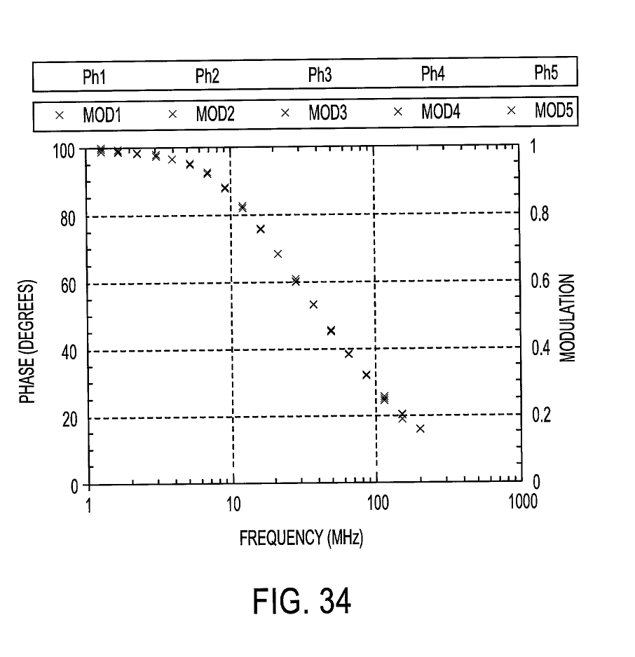

In this example, a step-by-step, detailed analysis of fluorescence lifetime measurements taken on AB in 50% methanol and 50% PBS solution (pH=7.4) are given. Five successive trials were performed on the same sample held at 25° C., these data are shown in FIG. 34. The data shown in FIG. 34 were collected for AB in MeOH:PBS (1:1 by volume).

Globals Unlimited software was used to analyze the data, linking the lifetime values together. The results of the minimization are shown in Table 2A, which display the image seen on the screen of Globals Unlimited after running data analysis using a triple exponential decay function.

In Table 2A, lambda M is the parameter λ described in Example 5, sas is the fractional contribution to the total fluorescence by that lifetime component. Results from each trial are listed from left to right. If only two lifetimes are used to fit the data, the resulting χ² more than doubles, as shown in Table 2B. Table 2B displays the image seen on the screen of Globals Unlimited after running data analysis using a double exponential decay function.

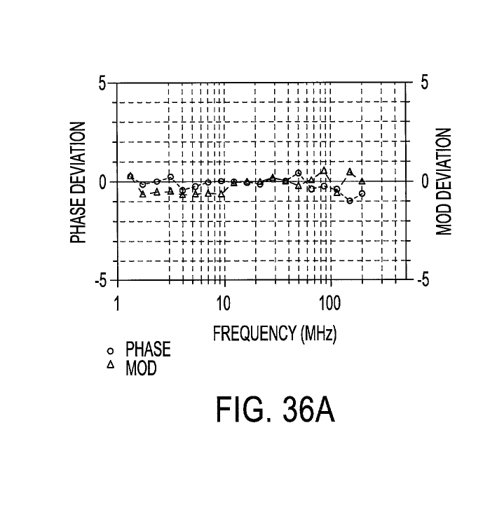

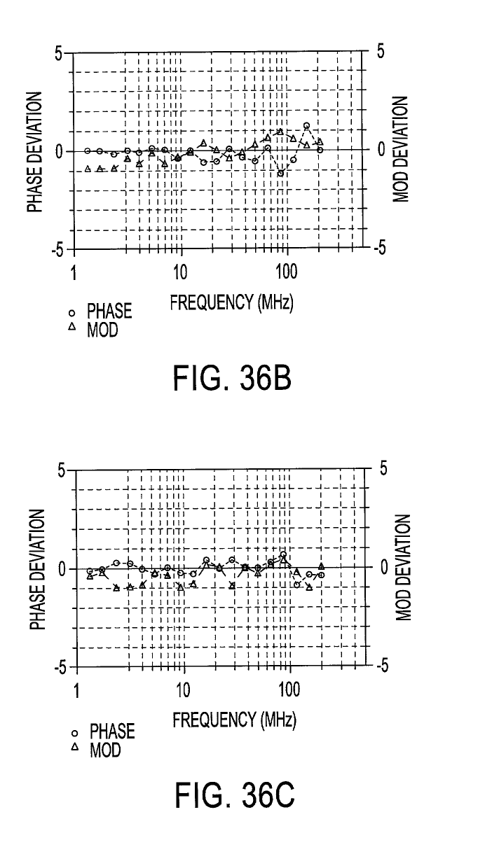

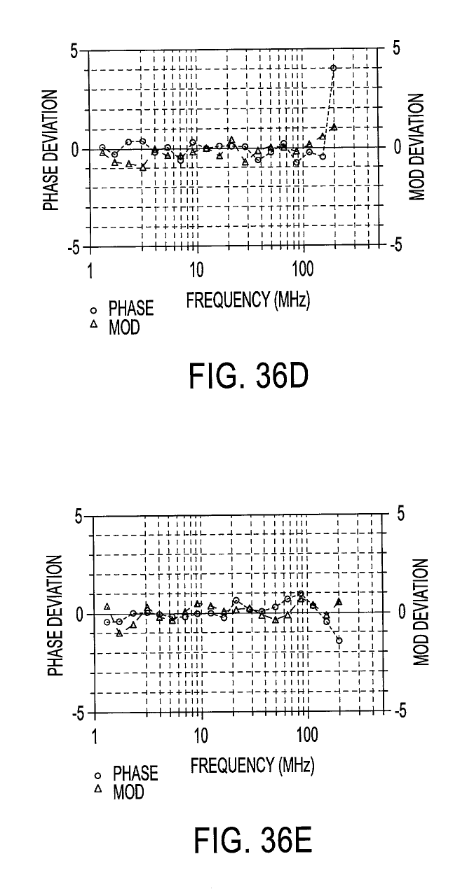

To determine if the analysis is correct, the deviation between the measured values and theoretical values is plotted. A random distribution of errors about zero is desired. A periodic or regular trend in the deviation indicates that either the number of lifetime components is incorrect, or the analysis has found a local minimum. FIGS. 36A-36E are plots showing the deviation found for each trial.

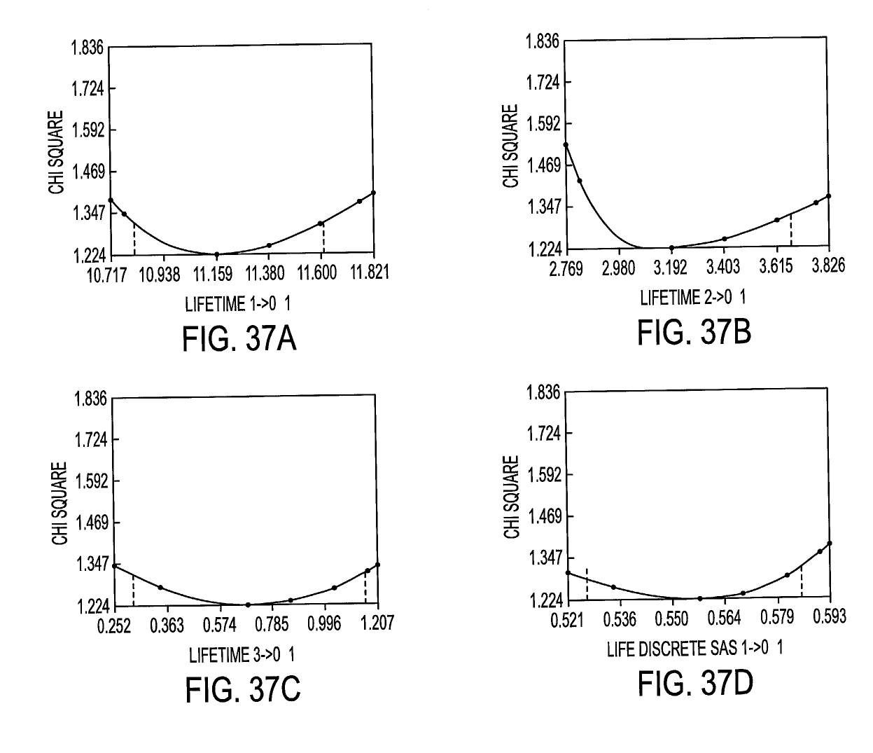

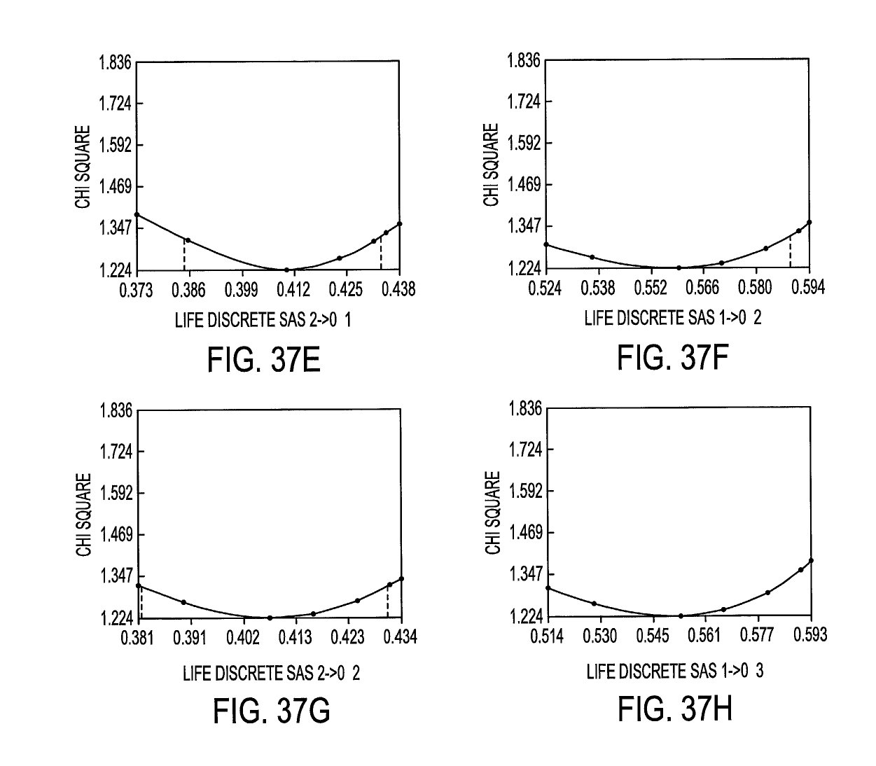

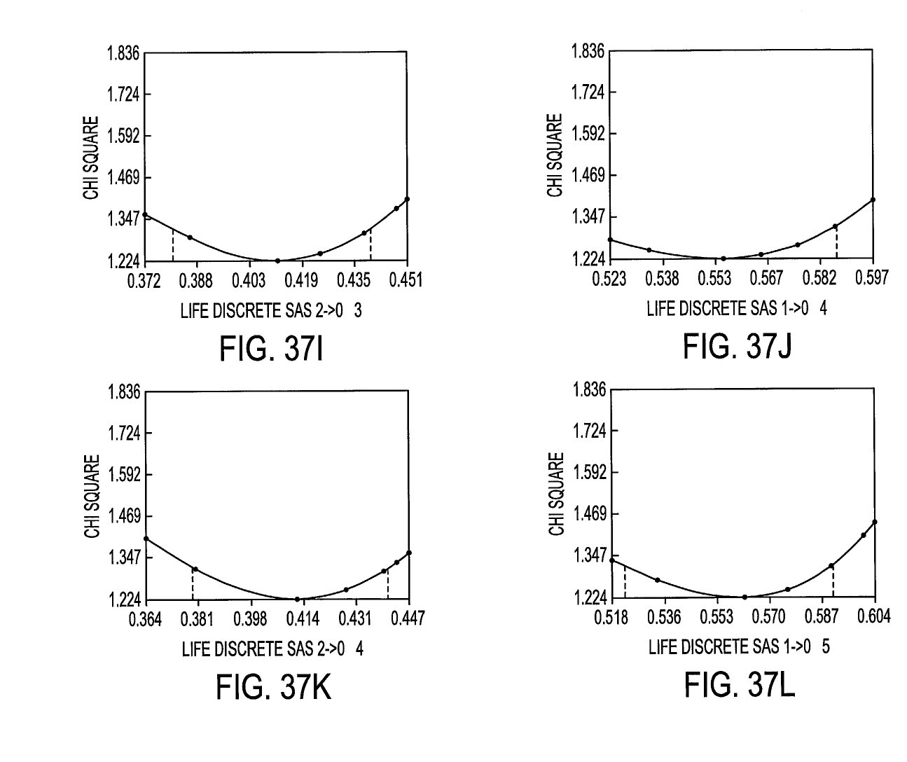

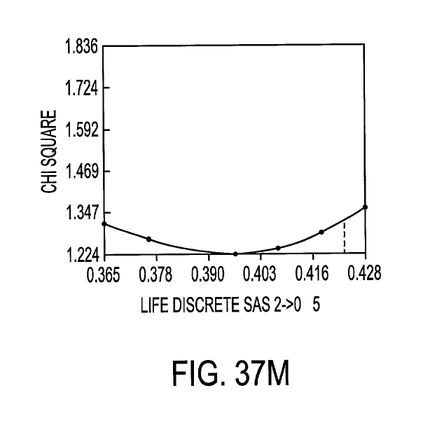

A correlated error analysis was performed in order to see if the minimum found was local or global. The correlated error is found by fixing one parameter at values around the value found with the initial minimization, and the other parameters are varied to minimize χ². This produces chi-squared plots for each variable. If a global minimum is found, the plots should be parabolic in nature. Chi-squared plots for the parameters in this minimization are shown in FIG. 37A-M In FIG. 37A-M, the dashed red lines indicate the point at which the χ² value has increased by 67%. Note that f₁+f₂+f₃=1.

### Example 7

Fluorescence Lifetime Measurements as a Function of pH

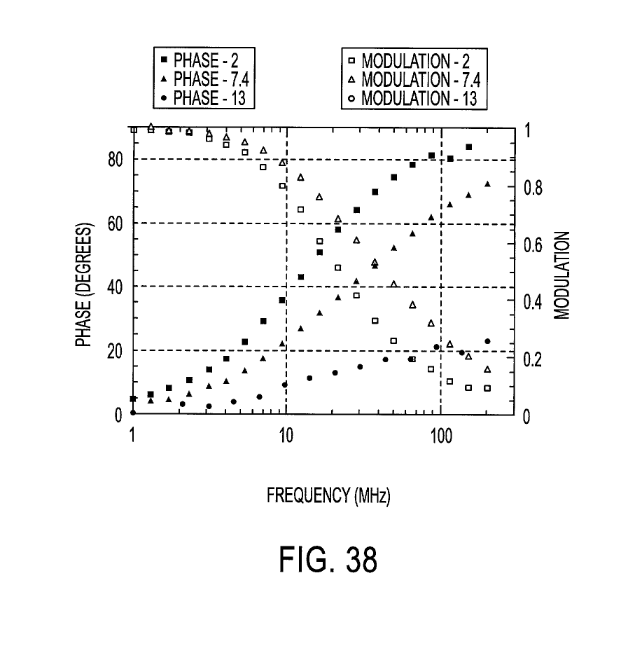

Fluorescence lifetimes of AB were measured in solutions of fifty percent pH buffer and fifty percent methanol. As the pH increases, the average lifetime of AB decreases causing the phase and modulation curves to shift to the right, as shown in FIG. 38. FIG. 38 shows the lifetime measurements of AB in MeOH and pH buffers (1:1 by volume). The curves shift to the right with increasing pH, indicating that the average lifetime is decreasing.

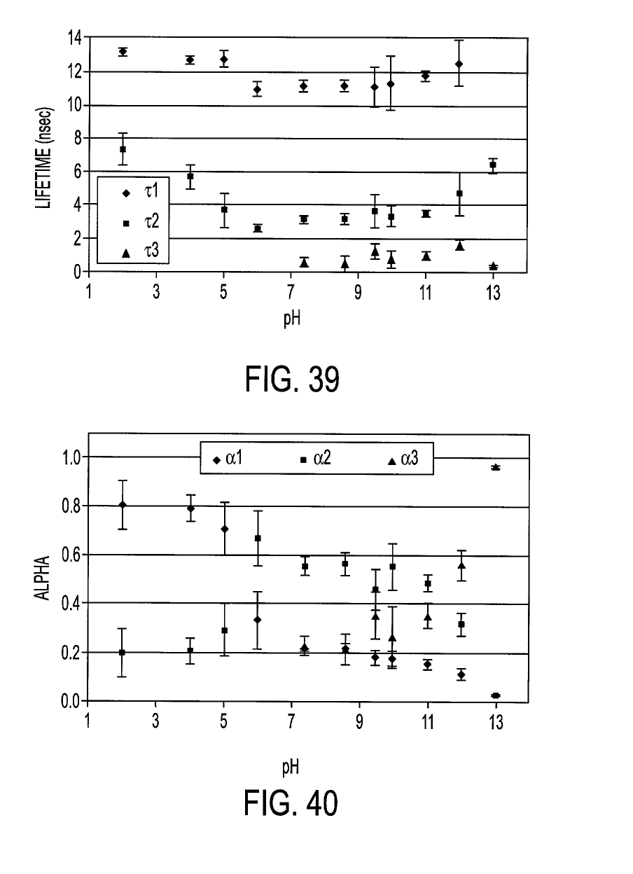

AB has three exponential lifetime components over the pH range, as shown in FIG. 39. The first component (averaging 11.1 nsec over the pH range) is due to the protonation of AB (ABH), as well as some AB molecules where the N→B dative bond prevents PET. These two forms are indistinguishable with fluorescence. The second lifetime component is associated with AB quenched by PET, resulting in a lifetime value averaging 3.2 nsec over the pH range measured. The last component is approximately 0.34 nsec and is not explained in the two component model of AB.

Unlike measurements on related systems, where a third lifetime was attributed to contamination due to the relatively small amount of fluorescence, the third lifetime measured for AB contributes significantly, especially at high pH. Therefore, the pre-exponential factors, as shown in FIG. 40, for the lifetimes above deviate from the expected two component curves.

Below pH 7 α₁ and α₂ resemble curves from a two component model, however, α₁ never reaches unity and α₂ never has a value of less than 0.2, even at low pH. ABH and AB without PET are the species associated with α₁. At pH 4 the maximum value of α₁ is only 0.8, meaning that 20% of the molecules have their fluorescence quenched by PET. However, with a pKa of 5.8, all AB molecules should be protonated at pH values at and below 4. The reason for the two components is unclear, but perhaps the phenyl ring effects the geometry at low pH, allowing the fluorescence to be quenched.

At pH values above 7 the third component, α₃, appears. The increasing value of α₃ as a function of increasing pH suggests that this component could be due to the fluorescence of ABOH. It was previously assumed that ABOH had similar fluorescence properties to AB; both molecules have electrons available to quench the fluorescence through PET. However, it is possible that the extra OH group on the boron changes the geometry in such a way as to increase the efficiency of electron transfer. A molecule with a higher rate of PET would have a shorter fluorescence lifetime. However, because the pKa was determined to be approximately 11.16, the concentration of ABOH from pH 7.4 to 9 should be close to zero. Perhaps the conformational change due to the additional OH group occurs naturally in a small fraction of the molecules in this pH range. The possibility of an ABOH species is not proven, but will be assumed for the sake of argument in the following analysis.

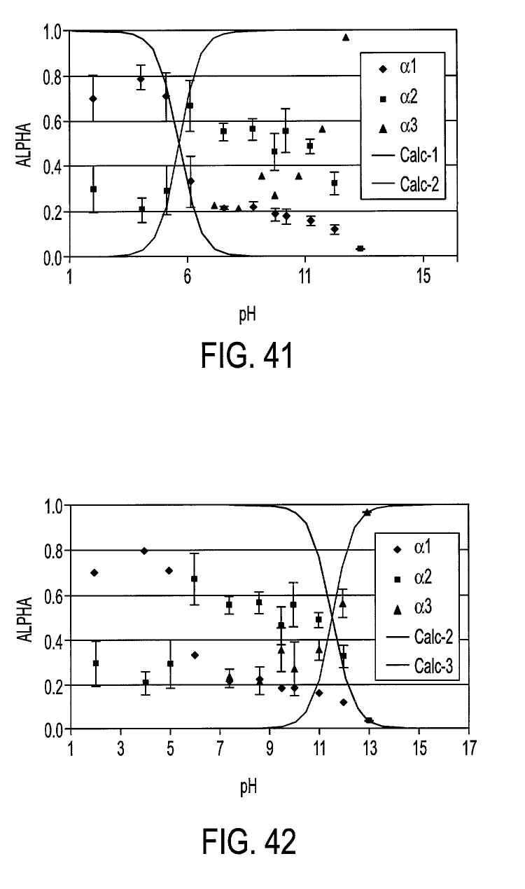

Because three lifetime components exist in combinations of no less than two components, we do not have enough information to use the simple relationship between a and concentration that was used in the two component model. We can, however, look at each pair of components separately to find the approximate pK value, as shown in FIG. 41. For the first pair, α₁ and α₂, the pKₐ is found to be 5.55. This is only slightly lower than the value found using steady state data.

For the second pair of alphas, α₂ and α₃, because we are assuming that α₃ is due to ABOH, the crossing point for the curves will be the approximate pK_{b}, as shown in FIG. 42. In this case, the pK_{b} is 11.57, close to the value measured with steady state data.

The values for α₂ and α₁ between pH 7 and 11 deviate from the two component model. The amount of fluorescence with a long lifetime is higher than expected due to hydrogen bonding alone. This is partially due to the N→B interaction. With this dative bond some of the unprotonated molecules are not quenched by PET and thus fluoresce with a long lifetime and contribute to the population of α₁. This increase in α₁, decreases the amount of molecules (α₂) fluorescing with a shorter lifetime (τ₂). Without the dative bond, the value of α₁ above the pKₐ (5.8) would be expected to fall to zero. If the contribution from α₃ is neglected at pH 7.4 when it first appears and is most likely to be small, the amounts of α₁ and α₂ are 0.28 and 0.72, respectively. This suggests that the probability of electron transfer at pH 7.4 is approximately 72%. The probability of electron transfer is related to the tetrahedral character (THC) of the B→N bond. The THC was shown by Toyota, et al. to be related to the energy barrier to dissociation of the N→B bond. (Toyota, 1992) Therefore, the higher the THC becomes, the smaller the probability of an electron escaping the dative N→B bond and quenching the anthracene fluorescence via PET. This is a direct result of the orbital overlap between the N and the B atoms, and in this case translates into a reduced sensitivity to glucose. Almost one-third of all AB molecules are fluorescing with a lifetime identical to AB when glucose is bound, and fluorescence measurements are unable to distinguish between the two. The other two-thirds of AB molecules show a change in fluorescence lifetime upon binding to glucose although all AB molecules are equally available to bind to a glucose molecule. As discussed earlier, the NOB dative bond is present in all of the AB molecules. The THC is simply a way of characterizing the amount of orbital overlap between the amine and the boron, and thus relates to the possibility of electron transfer. If the THC is lowered, the possibility of PET in a neutral AB molecule should increase and the values of α₁ above the pKₐ would decrease compared to those seen in FIG. 41. This would yield a larger switching fraction and increased sensitivity to glucose by reducing the fluorescence at neutral pH. However, the pKₐ would also shift with a change in THC because it is also a measure of the amine's ability to become protonated. A lower THC would not only allow for more PET, it would increase the ability of the amine to become protonated causing the pKₐ to increase. Too much of an increase in pKₐ, and it would be above the physiological pH of 7.4, possibly rendering AB useless as a fluorescent sensor molecule.

### Example 8

Quenching of Fluorescence Lifetime by Oxygen

The fluorescence lifetimes were also measured in the presence and absence of oxygen. Molecular oxygen is known to quench fluorescence lifetimes. The following experiments were conducted to ascertain if there are detectable lifetimes in the presence of oxygen.

Fluorescence lifetime measurements in 0.1M TBAP/ACN were made on AB. It was determined that degassing of the solution with N₂ has an effect on the lifetime values, as shown in Table E8.1 and Table E8.2. The change in fluorescence lifetimes after bubbling N₂ indicates that without degassing the fluorescence of AB in TBAP/ACN is most likely quenched by oxygen.

TABLE E8.1
Lifetime measurements of AB in ACN (0.1 M TBAP),
no degassing.

| AB in ACN/TBAP, no N₂ | Component 1 | Component 2 |
|---|---|---|
| Lifetime (nsec) | 2.92 | 1.50 |
| Fractional Fluorescence | 0.29 | 0.71 |
| Contribution | | |
| Pre-exponential (alpha) | 0.17 | 0.83 |

TABLE E8.2
Lifetime measurements of AB in ACN (0.1 M TBAP),
degassing with N₂.

| AB in ACN/TBAP, with N₂ | Component 1 | Component 2 |
|---|---|---|
| Lifetime (nsec) | 6.34 | 1.76 |
| Fractional Fluorescence | 0.18 | 0.82 |
| Contribution | | |
| Pre-exponential (alpha) | 0.06 | 0.94 |

By degassing the solution, the lifetimes become longer indicating that the amount of oxygen quenching is reduced (see Table E8.2). After degassing the solution, lifetime measurements detected only 6% of molecules fluorescing with a lifetime of 6.34 nsec.

These experiments show the viability of using the quantification methods of the invention, as well as the polyhydroxylate sensors based on these quantification methods, to detect and measure the presence of polyhydroxylate analytes, particularly glucose, in-vivo. For in-vivo determinations of glucose concentrations, for example, a optical sensor of the present invention is placed in the interstitial fluid of a person. The interstitial fluid has a much lower oxygen content than that of the atmosphere. Atmospheric oxygen is approximately 22% oxygen, whereas the interstitial fluids contain approximately 2-4%. Thus, the observed decrease in fluorescence lifetimes for a prototypical fluorescent sensor molecule of the invention is expected to be much less in-vivo, behaving more like the degassed solutions.

Moreover, possible quenching by molecular oxygen can be further diminished for in-vivo detection and measurements of polyhydroxylate analyte concentrations in particular embodiments of the sensors and sensor systems of the invention. For example, the fluorescent sensors can be further provided with membranes, or polymers, that prohibit, or greatly decrease, oxygen permeability, while maintaining high permeability to polyhydroxylate analytes, such as glucose. Such membranes are exemplified by hydrophilic polymers, such as PHEMA and polyurethane. Thus, the inclusion of an oxygen/glucose discriminating membrane or polymer can further decrease the level of oxygen so as to maximize in-vivo detection, and yield reliable and accurate measurements.

### Example 9

Evaluation of Solvent Effects

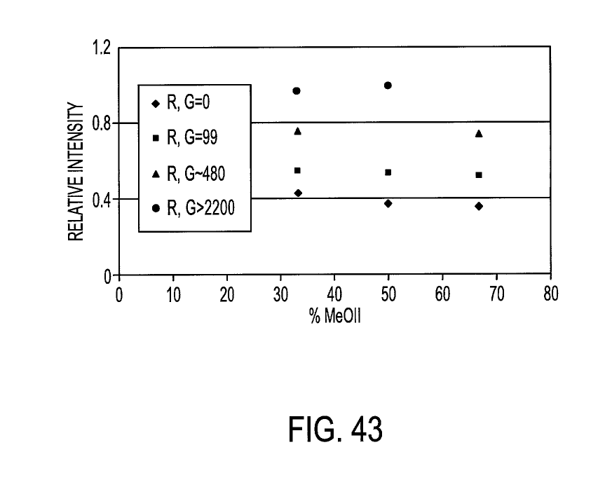

The effect of varying solvents conditions was examined for AB. In FIG. 43, the percentage of methanol was varied in the samples for AB with and without glucose. From inspection of the figure, the methanol content is seen to change the relative intensity of AB with and without glucose. Further, in FIG. 43, the values are relative to the maximum intensity measured for all data sets.

An analysis of the data of AB without glucose, it appears that the an increase in methanol content of the solution decrease the fluorescence intensity slightly. As glucose is added, the increase in intensity is slightly greater for solutions with higher methanol content.

These results show that fluorescence intensity can be manipulated by changing the environmental milieu of the fluorescent sensor molecule. Thus, in the invention, manipulations in the hydrophobicity/hydrophilicity of the polymer matrix, to which fluorescent sensor molecules are covalently bound or entrapped, can be made to yield an environmental milieu that gives the desired fluorescence lifetimes, or fluorescence intensity, changes.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

### TABLES 2A and 2B

Table 2A illustrates the screen of the Globals Unlimited program after running data analysis using a triple exponential decay function.

TABLE 2A
Minimization started at 22 17 26
using Marquardt-Levenberg minimization algorithm

Number of iterations: 5 Global chisquare: 1.231 lamda M = 1.0E-0001

| | | | | | | | |
|---|---|---|---|---|---|---|---|
| 1->0 | life discrete | sas | 0.557V | 0.559V | 0.553V | 0.555V | 0.561V |

| | | | | | | |
|---|---|---|---|---|---|---|
| 1->0 | lifetime | 11.159V | 11.159L | 11.159L | 11.159L | 11.159L |

| | | | | | | | |
|---|---|---|---|---|---|---|---|
| 2->0 | life discrete | sas | 0.410V | 0.407V | 0.411V | 0.412V | 0.397V |

| | | | | | | |
|---|---|---|---|---|---|---|
| 2->0 | lifetime | 3.192V | 3.192L | 3.192L | 3.192L | 3.192L |

| | | | | | | | |
|---|---|---|---|---|---|---|---|
| 3->0 | life discrete | sas | 0.032F | 0.033F | 0.036F | 0.034F | 0.042F |

| | | | | | | |
|---|---|---|---|---|---|---|
| 3->0 | lifetime | 0.680V | 0.680L | 0.680L | 0.680L | 0.680L |

| | | | | | |
|---|---|---|---|---|---|
| Local chi-square values | 0.975 | 1.428 | 1.758 | 0.999 | 0.975 |

exit because chisquare in a minimum within 0.00000010 Convergence reached.
Statistics:

| | | | |
|---|---|---|---|
| Total minimization time = | 0.65 sec. | Calls to function = | 71 |

Table 2B illustrates the screen of the Globals Unlimited program after running data analysis using a double exponential decay function.

TABLE 2B
Minimization started at 22 15 28
using Marquardt-Levenberg minimization algorithm

Number of iterations: 8 Global chisquare: 3.264 lamda M = 1.0E-0006

| | | | | | | | |
|---|---|---|---|---|---|---|---|
| 1->0 | life discrete | sas | 0.621V | 0.629V | 0.623V | 0.624V | 0.622V |

| | | | | | | |
|---|---|---|---|---|---|---|
| 1->0 | lifetime | 10.446V | 10.446L | 10.446L | 10.446L | 10.446L |

| | | | | | | | |
|---|---|---|---|---|---|---|---|
| 2->0 | life discrete | sas | 0.379F | 0.371F | 0.377F | 0.376F | 0.378F |

| | | | | | | |
|---|---|---|---|---|---|---|
| 2->0 | lifetime | 2.531V | 2.531L | 2.531L | 2.531L | 2.531L |

| | | | | | |
|---|---|---|---|---|---|
| Local chi-square values | 2.718 | 1.906 | 2.231 | 1.776 | 7.658 |

exit because chisquare in a minimum within 0.00000010 Convergence reached.
Statistics:

| | | | |
|---|---|---|---|
| Total minimization time = | 0.50 sec. | Calls to function = | 75 |

What is claimed is:

1. A method of using a population of fluorescent sensor molecules to measure the concentration of a polyhydroxylate analyte (A) in a solution, wherein the population of fluorescent sensor molecules are present in species that ate not bound to the polyhydroxylate analyte (FS) and species that are bound to the polyhydtoxylate analyte (AFS), the method comprising:
(a) determining the total fluorescence of the solution;
(b) determining the relative fluorescence contribution that the FS species and the AFS species make to the total fluorescence of the solution;
(c) using the relative fluorescence contribution values of FS and AFS as determined in step (b) to calculate the relative abundances of FS and AFS in the solution; and
(d) correlating the relative abundances of FS and AFS in the solution as calculated in step (c) with the concentration of the polyhydroxylate analyte so that the concentration of the polyhydroxylate analyte in the solution is determined.

2. The method of claim 1, wherein the fluorescent sensor molecule comprises an arylboronic moiety.

3. The method of claim 2, wherein the arylboronic fluorescent sensor molecule comprise a compound of the formula: 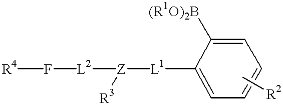
wherein:
F is a fluorophore with selected molecular properties;
R¹ is selected from the group consisting of hydrogen, lower aliphatic and aromatic functional groups;
R² and R⁴ are optional functional groups selected from the group consisting of hydrogen, lower aliphatic and aromatic functional groups and groups that form covalent bonds to a biocompatible matrix;
L¹ and L² are optional linking groups having from zero to four atoms selected from the group consisting of nitrogen, carbon, oxygen, sulfur and phosphorous;
Z is a heteroatom selected from the group consisting of nitrogen, phosphorous, sulfur, and oxygen;
R³ is an optional group selected from the group consisting of hydrogen, lower aliphatic and aromatic functional groups and groups that form covalent bonds to a biocompatible matrix; and
wherein F and Z are involved in a photo-induced electron transfer process that quenches the intrinsic fluorescence of F in the absence of the polyhydroxylate analyte.

4. The method of claim 1, wherein the relative fluorescent contribution of the AFS species and the AFSA species is determined by measuring the fluorescent lifetime of each species via a method selected from the group consisting of phase-modulation fluorometry and time-resolved fluorometry.

5. The method of claim 4, wherein the fluorescent lifetimes are calculated using phase-modulation fluorometry.

6. The method of claim 4, wherein the fluorescent lifetimes are calculated using time-resolved fluorometry.

7. The method of claim 2, wherein the fluorescent sensor molecules comprise an amine moiety with a pKa of less than about 7.4.

8. The method of claim 2, wherein the arylboronic fluorescent sensor molecules comprise an amine moiety with a pKa of about 2.0 to about 7.0.

9. The method of claim 2, wherein the relative contribution of the FS species to the total fluorescence corresponds to the population of arylboronic fluorescent sensor molecules undergoing photo-induced electron transfer.

10. The method of claim 2, wherein the arylboronic fluorescent sensor molecule has an excitation wavelength of greater than about 400 nm.

11. The method of claim 10, wherein the excitation wavelength is between about 400 nm and about 600 nm.

12. The method of claim 1, wherein the polyhydroxylate analyte is glucose.

13. The method of claim 2, wherein the arylboronic fluorescent sensor molecule comprises a COB fluorophore or derivatives thereof.

14. The method of claim 2, wherein the arylboronic fluorescent sensor molecule comprises a NIB fluorophore or derivatives thereof.

15. The method of claim 2, wherein the arylboronic fluorescent sensor molecule comprises a fluorophore comprising a transition-metal complex.

16. A method of optically sensing the presence of a polyhydroxylate analyte in a sample, the method comprising:
(a) placing a fluorescent sensor molecule (FS) in contact with the sample, wherein the fluorescent sensor molecule reversibly binds to the polyhydroxylate analyte,
the fluorescent sensor molecule comprising a first fluorescence lifetime corresponding to the fluorescent sensor molecule bound to the polyhydroxylate analyte (FSA) and a second fluorescence lifetime corresponding to the fluorescent sensor molecule not bound to the polyhydroxylate analyte, and wherein the fluorescence lifetimes of FSA and FS contribute relatively to a detectable fluorescence lifetime for the sample;
(b) exposing a population of the fluorescent sensor molecules to the sample;
(b) exciting the fluorescent sensor molecules in the sample with radiation;
(c) detecting a resulting emission beam emanating from the fluorescent sensor molecules in the sample, wherein the emission beam varies with the concentration of the polyhydroxylate analyte; and
(e) correlating the resulting emission beam to the presence of the polyhydroxylate analyte in the sample, wherein the concentration of the polyhydroxylate in the sample is determined.

17. The method of claim 16, wherein the relative fluorescent contribution of the FSA species and the FS species is a function of a quantum yield for each species.

18. The method of claim 16, wherein the relative fluorescent contribution of the FS species and the FSA species is a function of a decay rate for each species.

19. The method of claim 16, wherein the relative contribution of FS and FSA to the total fluorescence approximately equals unity.

20. The method of claim 16, further comprising detecting the relative contribution of FS or FSA to the total fluorescence and calculating the relative contribution to the total fluorescence of the species that is not directly detected.

21. The method of claim 16, wherein the fluorescent sensor molecule comprises a COB fluorophore or derivatives thereof.

22. The method of claim 16, wherein the fluorescent sensor molecule comprises a NIB fluorophore or derivatives thereof.

23. The method of claim 16, wherein the fluorescent sensor molecule comprises a fluorophore comprising a metal complex.

24. The method of claim 16, wherein the fluorescent sensor molecule has more than one fluorescence lifetime in the absence of the polyhydroxylate analyte.

25. The method of claim 16, wherein at least one lifetime of the fluorescent sensor molecule corresponds to a population of fluorescent sensor molecules undergoing photo-induced electron transfer.

26. The method of claim 25, wherein the photo-induced electron transfer is intramolecular.

27. The method of claim 16, wherein exciting the sample with radiation comprises illuminating the sample with one or more of the following optical light sources: an incandescent lamp, an electroluminescent light, a ion laser, a dye laser, an LED, or a laser diode.

28. The method of claim 27, wherein the optical light source is pulsed or modulated.

29. The method of claim 16, wherein the fluorescent lifetimes are calculated using phase-modulation fluorometry.

30. The method of claim 16, wherein the fluorescent lifetimes are calculated using time-resolved fluorometry.

31. The method of claim 16, wherein the fluorescent sensor molecules comprise a arylboronic moiety which binds polyhydroxylate analyte.

32. The method of claim 16, wherein the fluorescent sensor molecule comprise a compound of the formula: 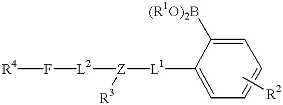
wherein:
F is a fluorophore with selected molecular properties;
Ris selected from the group consisting of hydrogen, lower aliphatic and aromatic functional groups;
R² and R⁴ are optional functional groups selected from the group consisting of hydrogen, lower aliphatic and aromatic functional groups and groups that form covalent bonds to a biocompatible matrix;
L¹ and L² are optional linking groups having from zero to four atoms selected from the group consisting of nitrogen, carbon, oxygen, sulfur and phosphorous;
Z is a heteroatom selected from the group consisting of nitrogen, phosphorous, sulfur, and oxygen;
R³ is an optional group selected from the group consisting of hydrogen, lower aliphatic and aromatic functional groups and groups that form covalent bonds to a biocompatible matrix; and
wherein F and Z are involved in a photo-induced electron transfer process that quenches the intrinsic fluorescence of F in the absence of the polyhydroxylate analyte.

33. The method of claim 32, wherein the polyhydroxylate analyte is glucose.

34. The method of claim 32, wherein Z comprises an amine with a pKa of less than about 7.4.

35. The method of claim 32, wherein Z comprises an amine with a pKa of about 2.0 to about 7.0.
